(19) United States
(12) Patent Application Publication
(10) Pub. No.: US 2026/0120939 A1
(43) Pub. Date: Apr. 30, 2026

(54) TRANSFORMER CHIP AND SIGNAL TRANSMISSION DEVICE

(71) Applicant: ROHM CO., LTD., Kyoto-shi (JP)

(72) Inventors: Junichi SEKITO, Kyoto-shi (JP); Yosuke YAMANAKA, Kyoto-shi (JP)

(21) Appl. No.: 19/430,970

(22) Filed: Dec. 23, 2025

Related U.S. Application Data
(63) Continuation of application No. PCT/JP2024/022678, filed on Jun. 21, 2024.

(30) Foreign Application Priority Data
Jul. 3, 2023 (JP) 2023-109342

(51) Int. Cl. H01F 27/28; H01F 27/29

(52) U.S. Cl. CPC H01F 27/2804; H01F 27/292; H01F 2027/2809

(57) ABSTRACT

A transformer chip includes a first isolation transformer including a first front coil and a second front coil that are spaced apart from each other in a first direction orthogonal to a thickness-wise direction, and a first back coil and a second back coil arranged opposite to the first front coil and the second front coil; a second isolation transformer including a third front coil and a fourth front coil that are arranged opposite to a third back coil and a fourth back coil; first dummy wiring arranged at opposite sides of the first isolation transformer in a second direction orthogonal to the first direction and the thickness-wise direction; and second dummy wiring arranged at opposite sides of the second isolation transformer in the second direction and electrically insulated from the first dummy wiring. The first dummy wiring and the second dummy wiring are aligned in the first direction.

### CROSS REFERENCE TO RELATED APPLICATIONS

This application is a continuation under 35 U.S.C. § 120 of PCT/JP2024/022678, filed on Jun. 21, 2024, which is incorporated herein by reference, which claims priority to Japanese Patent Application No. 2023-109342, filed on Jul. 3, 2023. The present application likewise claims priority under 35 U.S.C. § 119 to Japanese Application No. 2023-109342, filed Jul. 3, 2023, the entire content of which is also incorporated herein by reference.

### BACKGROUND

The following description relates to a transformer chip and a signal transmission device.

A typical signal transmission device configured to transmit a pulse signal while electrically isolating an input and an output is used for various applications, such as a power supply device and a motor drive device. An example of such a signal transmission device includes an isolated gate driver configured to apply a gate voltage to a gate of a switching element, such as a transistor. JP2018-78169A discloses an example of a transformer chip used for an isolated gate driver. The transformer chip includes a stack of insulating layers in which an upper coil and a lower coil face each other in a thickness-wise direction of the stack structure.

### BRIEF DESCRIPTION OF THE DRAWINGS

FIG. 1 is a schematic circuit diagram illustrating the configuration of a signal transmission device in accordance with an embodiment.

FIG. 2 is a schematic plan view illustrating the internal structure of the signal transmission device shown in FIG. 1.

FIG. 3 is a schematic cross-sectional view illustrating the internal configuration of the signal transmission device shown in FIG. 2.

FIG. 4 is a schematic plan view of a transformer chip shown in FIG. 2.

FIG. 5 is a schematic plan view of the transformer chip shown in FIG. 4.

FIG. 6 is a schematic cross-sectional view of the transformer chip taken along line F6-F6 shown in FIG. 3.

FIG. 7 is a schematic cross-sectional view of the transformer chip taken along line F7-F7 shown in FIG. 3.

FIG. 8 is a schematic cross-sectional view of the transformer chip taken along line F8-F8 shown in FIG. 4.

FIG. 9 is a schematic plan view illustrating dummy wiring of the transformer chip.

FIG. 10 is a schematic plan view enlarging part of the transformer chip shown in FIG. 9.

FIG. 11 is a schematic plan view enlarging another part of the transformer chip shown in FIG. 9.

FIG. 12 is a schematic plan view enlarging a first front coil and a second front coil of the transformer chip shown in FIG. 7.

FIG. 13 is a schematic plan view enlarging the first front coil shown in FIG. 12.

FIG. 14 is a schematic cross-sectional view enlarging the second front coil shown in FIG. 12.

FIG. 15 is a schematic plan view enlarging a fifth front coil and a sixth front coil of the transformer chip shown in FIG. 7.

FIG. 16 is a schematic plan view enlarging the fifth front coil shown in FIG. 15.

FIG. 17 is a schematic plan view enlarging the sixth front coil shown in FIG. 15.

FIG. 18 is a schematic plan view illustrating a transformer chip of a comparative example.

FIG. 19 is a schematic plan view illustrating a transformer chip of a modified example.

FIG. 20 is a schematic plan view illustrating a transformer chip of a modified example.

FIG. 21 is a schematic plan view enlarging a first front coil and a second front coil of the transformer chip shown in FIG. 20.

FIG. 22 is a schematic plan view illustrating a transformer chip of a modified example.

FIG. 23 is a schematic circuit diagram illustrating the configuration of a signal transmission device of a modified example.

FIG. 24 is a schematic plan view illustrating the internal configuration of the signal transmission device shown in FIG. 23.

FIG. 25 is a schematic plan view illustrating the internal configuration of a signal transmission device of a modified example.

FIG. 26 is a schematic plan view illustrating the internal configuration of a signal transmission device of a modified example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms and are not limited to the examples described. However, the examples described are thorough and complete, and convey the full scope of the disclosure to one of ordinary skill in the art.

Some embodiments of a transformer chip and a signal transmission device according to the present disclosure will be described below with reference to the drawings. Elements in the drawings are illustrated for simplicity and clarity and have not necessarily been drawn to scale. To facilitate understanding, hatching lines may not be shown in the cross-sectional drawings. The accompanying drawings merely illustrate exemplary embodiments of the present disclosure and are not intended to limit the present disclosure. Terms such as “first”, “second”, and “third” in this disclosure are used to distinguish subjects and are not used for ordinal purposes.

This detailed description includes exemplary embodiments of devices, systems, and methods in accordance with the present disclosure. Further, this detailed description is illustrative and is not intended to limit embodiments of the present disclosure or application and use of the embodiments.

In this specification, the phrase “at least one of” means “one or more” of the options. In an example, the phrase “at least one of” means “only one of the options” or “both of the options” if the number of options is two. In another example, the phrase “at least one of” means “only one of the options” or “any combination of two or more of the options” if the number of options is three or more.

In this specification, phrases such as “the length of A is equal to the length of B” and “A and B are equal in length” encompass a relationship in which a difference between the length of A and the length of B is, for example, 10% of the length of A or less.

### Embodiment

### Overall Configuration of Signal Transmission Device

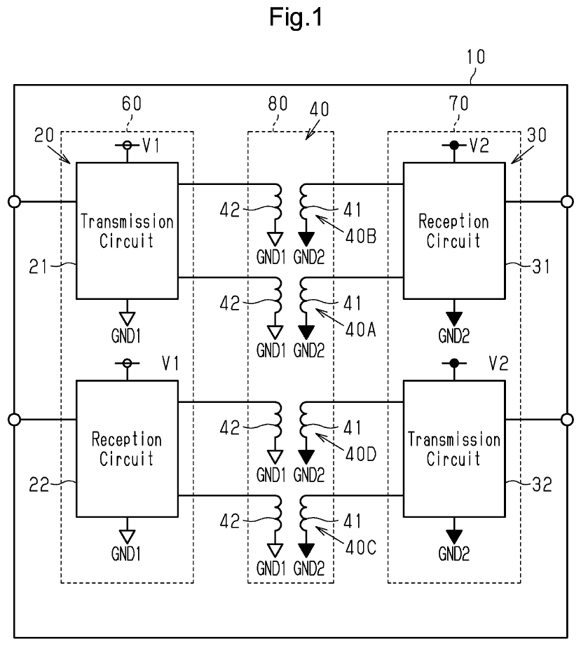

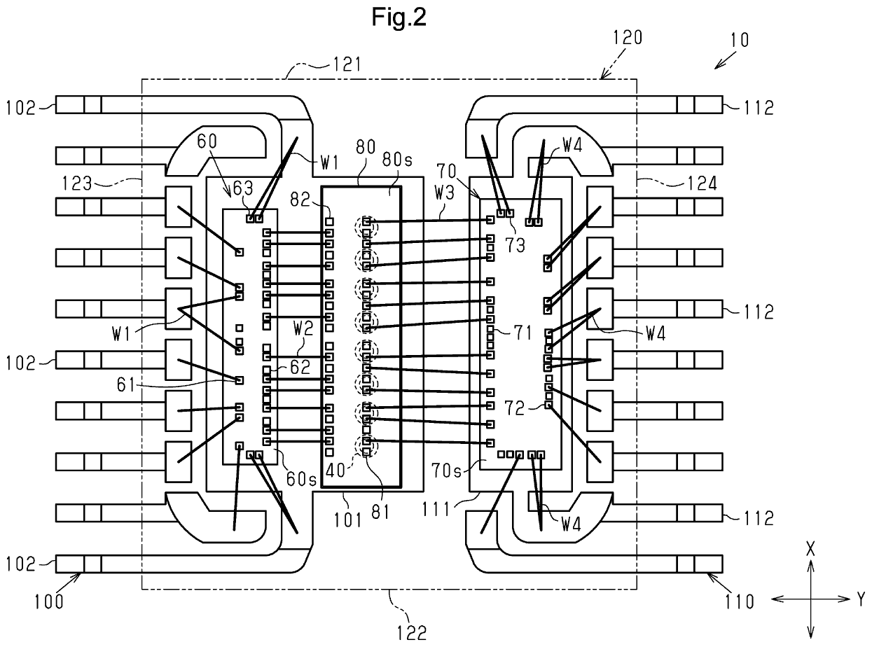

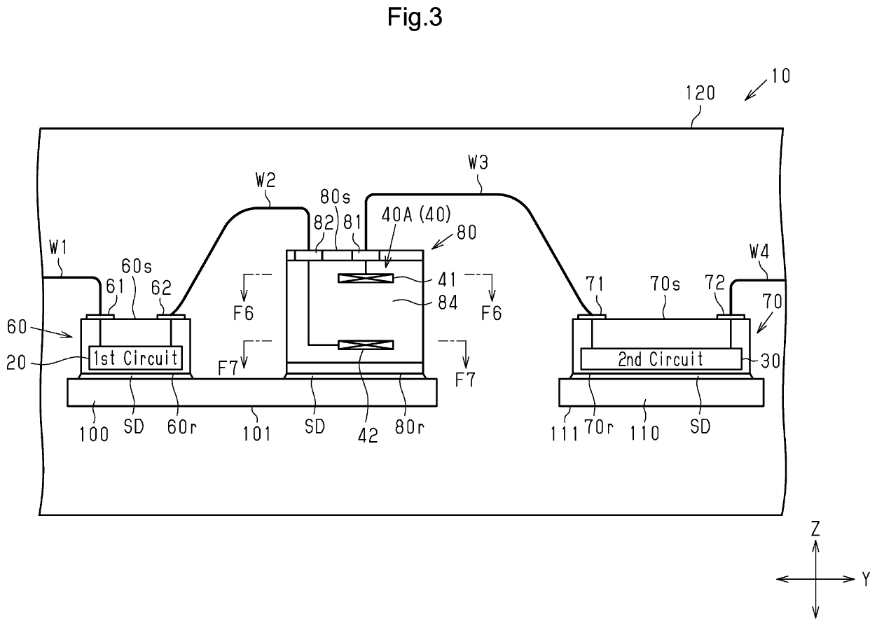

The overall configuration of a signal transmission device 10 in accordance with an embodiment will now be described with reference to FIGS. 1 to 3. FIG. 1 schematically illustrates the circuitry of the signal transmission device 10 in accordance with the embodiment. FIG. 2 schematically illustrates an example of the internal configuration (planar structure) of the signal transmission device 10. FIG. 3 schematically illustrates an example of part of the internal configuration (cross-sectional structure) of the signal transmission device 10. In FIG. 3, hatching lines are not shown to facilitate understanding of the drawing.

As shown in FIG. 1, the signal transmission device 10 includes a first circuit chip 60, a second circuit chip 70, and a transformer chip 80. The transformer chip 80 is connected between the first circuit chip 60 and the second circuit chip 70. The transformer chip 80 electrically isolates the first circuit chip 60 and the second circuit chip 70.

The first circuit chip 60 includes a first circuit 20 configured to be operated with a first voltage V1. In an example, the first circuit 20 includes a transmission circuit 21 and a reception circuit 22. The second circuit chip 70 includes a second circuit 30 configured to be operated with a second voltage V2. In an example, the second circuit 30 includes a reception circuit 31 and a transmission circuit 32. The first voltage V1 and the second voltage V2 may be the same as, or differ from, each other. In an example, the second voltage V2 is equal to the first voltage V1. The signal transmission device 10 may be referred to as a digital isolator.

The transformer chip 80 includes a plurality of transformers 40. The transformers 40 include a first transformer 40A and a second transformer 40B that are connected to the transmission circuit 21 of the first circuit 20, and a third transformer 40C and a fourth transformer 40D that are connected to the reception circuit 22 of the first circuit 20. The first transformer 40A and the second transformer 40B are electrically connected between the transmission circuit 21 of the first circuit chip 60 and the reception circuit 31 of the second circuit chip 70. The third transformer 40C and the fourth transformer 40D are electrically connected between the reception circuit 22 of the first circuit chip 60 and the transmission circuit 32 of the second circuit chip 70.

The first to fourth transformers 40A to 40D each include a first coil 41 and a second coil 42. The first coils 41 of the first transformer 40A and the second transformer 40B are electrically connected to the reception circuit 31 of the second circuit chip 70. The second coils 42 of the first transformer 40A and the second transformer 40B are electrically connected to the transmission circuit 21 of the first circuit chip 60. The first coils 41 of the third transformer 40C and the fourth transformer 40D are electrically connected to the transmission circuit 32 of the second circuit chip 70. The second coils 42 of the third transformer 40C and the fourth transformer 40D are electrically connected to the reception circuit 22 of the first circuit chip 60.

In response to an input signal, the transmission circuit 21 of the first circuit chip 60 drives the second coil 42 of at least one of the first transformer 40A and the second transformer 40B in a pulsed manner. In response to a signal excited by the second coil 41 of at least one of the first transformer 40A and the second transformer 40B, the reception circuit 31 of the second circuit chip 70 outputs an output signal.

In response to an input signal, the transmission circuit 32 of the second circuit chip 70 drives the first coil 41 of at least one of the third transformer 40C and the fourth transformer 40D in a pulsed manner. In response to a signal excited by the second coil 42 of at least one of the third transformer 40C and the fourth transformer 40D, the reception circuit 22 of the first circuit chip 60 outputs an output signal.

### Internal Configuration of Signal Transmission Device

FIG. 2 shows an example of a schematic plan view illustrating the internal configuration of the signal transmission device 10. The circuitry of the signal transmission device 10 is simplified in FIG. 1, and thus the number of external terminals of the signal transmission device 10 in FIG. 2 is greater than the number of external terminals of the signal transmission device 10 in FIG. 1. The number of external terminals of the signal transmission device 10 indicates the number of external electrodes that allow for connection of the signal transmission device 10 to an electronic component located outside the signal transmission device 10. Also, in the signal transmission device 10 shown in FIG. 2, the number of signal wires (wires W1 to W4, described later) configured to transmit signals from the first circuit 20 to the second circuit 30 is greater than the number of signal wires in the signal transmission device 10 shown in FIG. 1.

FIG. 3 shows an example of a schematic cross-sectional view illustrating the internal configuration of the signal transmission device 10. In FIG. 3, the cross-sectional structures of the chips 60, 70, and 80 are simplified, and thus the transformer chip 80 described later has a cross-sectional structure differing from the cross-sectional structure of the transformer chip 80 shown in FIG. 3. The transformer chip 80 in FIG. 3 shows the cross-sectional structure of the first transformer 40A.

As shown in FIG. 2, the signal transmission device 10 is a semiconductor device including multiple semiconductor chips, namely, the first circuit chip 60, the second circuit chip 70, and the transformer chip 80, that are packaged together.

The signal transmission device 10 employs a small outline (SO) package type, specifically, a small outline package (SOP) in the present embodiment. The package type of the signal transmission device 10 may be changed. The package type is not limited to SOP, and may be a quad flat no-lead package (QFN), a dual flat package (DFP), a dual in-line package (DIP), a quad flat package (QFP), a single in-line package (SIP), a small outline J-leaded package (SOJ), or any other similar package type.

The first circuit chip 60 is mounted on a first lead frame 100. The second circuit chip 70 is mounted on a second lead frame 110. In the example shown in FIG. 2, the transformer chip 80 is mounted on the first lead frame 100. That is, the first circuit chip 60 and the transformer chip 80 are both mounted on the first lead frame 100. The chips 60, 70, and 80 and part of the lead frames 100 and 110 are encapsulated by an encapsulation resin 120. In FIG. 2, the encapsulation resin 120 is indicated by double-dashed lines to facilitate illustration of the internal configuration of the signal transmission device 10.

The encapsulation resin 120 is formed from an electrically insulative resin material. Such a resin material includes, for example, a black epoxy resin. The encapsulation resin 120 has a shape of a rectangular plate having a thickness-wise direction parallel to Z-direction. The encapsulation resin 120 includes four resin side surfaces 121 to 124. More specifically, the encapsulation resin 120 includes resin side surfaces 121 and 122 serving as two end surfaces of the encapsulation resin 120 in X-direction, and resin side surfaces 123 and 124 serving as two end surfaces of the encapsulation resin 120 in Y-direction. The X-direction and the Y-direction are orthogonal to the Z-direction. The X-direction and the Y-direction are orthogonal to each other as viewed in the Z-direction. The encapsulation resin 120 is rectangular as viewed in the Z-direction, with the long sides extending in the Y-direction and short sides extending in the X-direction. The X-direction corresponds to “first direction”, and the Y-direction corresponds to “second direction”. In the description hereafter, the term “plan view” refers to a view taken in the Z-direction.

The first lead frame 100 and the second lead frame 110 are conductors formed from a material containing, for example, copper (Cu), iron (Fe), aluminum (Al), or the like. The lead frames 100 and 110 extend from the inside of the encapsulation resin 120 to the outside.

The first lead frame 100 includes a first die pad 101 and first leads 102. The first die pad 101 is arranged inside the encapsulation resin 120. The first leads 102 extend from the inside of the encapsulation resin 120 to the outside. The first leads 102 serve as external terminals configured to electrically connect the signal transmission device 10 to an external electronic device.

In the present embodiment, the first circuit chip 60 and the transformer chip 80 are both mounted on the first die pad 101. In plan view, the first die pad 101 is arranged so that the center of the first die pad 101 in the Y-direction is located closer to the resin side surface 123 than the center of the encapsulation resin 120 in the Y-direction is. In the present embodiment, the first die pad 101 is not exposed from the encapsulation resin 120. The first die pad 101 is rectangular in plan view, with long sides extending in the X-direction and short sides extending in the Y-direction.

The first leads 102 are aligned with and spaced apart from each other in the X-direction. Two outermost first leads 102 in the X-direction are integrated with the first die pad 101. Each of the first leads 102 partially projects out of the encapsulation resin 120 from the resin side surface 123.

The second lead frame 110 includes a second die pad 111 and second leads 112. The second die pad 111 is arranged inside the encapsulation resin 120. The second leads 112 extend from the inside of the encapsulation resin 120 to the outside. The second leads 112 serve as external terminals configured to electrically connect the signal transmission device 10 to an external electronic device.

The second circuit chip 70 is mounted on the second die pad 111. In plan view, the second die pad 111 is located closer to the resin side surface 124 than the first die pad 101 is in the Y-direction. In the present embodiment, the second die pad 111 is not exposed from the encapsulation resin 120. The second die pad 111 is rectangular in plan view, with long sides extending in the X-direction and short sides extending in the Y-direction.

The first die pad 101 and the second die pad 111 are aligned with and spaced apart from each other in the Y-direction. Accordingly, the Y-direction may be referred to as the arrangement direction of the two die pads 101 and 111. The dimensions of the first die pad 101 and the second die pad 111 in the Y-direction are determined by the size, quantity, or the like of semiconductor chips that are mounted. In the present embodiment, the first circuit chip 60 and the transformer chip 80 are mounted on the first die pad 101, and the second circuit chip 70 is mounted on the second die pad 111. Therefore, the first die pad 101 is larger than the second die pad 111 in the Y-direction.

The second leads 112 are aligned with and spaced apart from each other in the X-direction. Two of the second leads 112 are integrated with the second die pad 111. Each of the second leads 112 partially projects out of the encapsulation resin 120 from the resin side surface 124.

In the present embodiment, the second leads 112 and the first leads 102 are equal in quantity. As shown in FIG. 2, the first leads 102 and the second leads 112 are each aligned in a direction (X-direction) orthogonal to the direction (Y-direction) in which the first die pad 101 and the second die pad 111 are arranged next to each other. The quantity of second leads 112 and the quantity of first leads 102 may be changed.

In the present embodiment, the first die pad 101 is supported by the two first leads 102 integrated with the first die pad 101. The second die pad 111 is supported by the two second leads 112 integrated with the second die pad 111. Thus, the die pads 101 and 111 are not provided with suspension leads exposed from the resin side surfaces 121 and 122. This allows the isolation distance (creepage distance) to be increased between the first lead frame 100 and the second lead frame 110.

The first circuit chip 60, the second circuit chip 70, and the transformer chip 80 are aligned with and spaced apart from each other in the Y-direction. The first circuit chip 60, the transformer chip 80, and the second circuit chip 70 are arranged in this order from the first leads 102 toward the second leads 112 in the Y-direction. Accordingly, the transformer chip 80 is located between the first circuit chip 60 and the second circuit chip 70 in the Y-direction.

In plan view, the first circuit chip 60 has a rectangular shape with short sides and long sides. The first circuit chip 60 is mounted on the first die pad 101, so that the long sides extend in the X-direction and the short sides extend in the Y-direction in plan view. As shown in FIG. 3, the first circuit chip 60 includes a chip main surface 60s and a chip back surface 60r facing away from each other in the Z-direction. The chip back surface 60r of the first circuit chip 60 is bonded to the first die pad 101 by a conductive bonding material SD. The conductive bonding material SD includes solder, silver (Ag) paste, or the like. The first circuit chip 60 includes the first circuit 20.

As shown in FIG. 2, the chip main surface 60s of the first circuit chip 60 includes first electrode pads 61, second electrode pads 62, and third electrode pads 63. The electrode pads 61 to 63 are electrically connected to the first circuit 20.

The first electrode pads 61 are arranged in the chip main surface 60s and are located closer to the first leads 102 than the center of the chip main surface 60s in the Y-direction is. The first electrode pads 61 are aligned in the X-direction. The second electrode pads 62 are arranged in one of two opposite ends of the chip main surface 60s in the Y-direction that is located closer to the transformer chip 80. The second electrode pads 62 are aligned in the X-direction. The third electrode pads 63 are arranged in each of two opposite ends of the chip main surface 60s in the X-direction.

In plan view, the second circuit chip 70 has a rectangular shape with short sides and long sides. The second circuit chip 70 is mounted on the second die pad 111, so that the long sides extend in the X-direction and the short sides extend in the Y-direction in plan view. As shown in FIG. 3, the second circuit chip 70 includes a chip main surface 70s and a chip back surface 70r facing away from each other in the Z-direction. The chip back surface 70r of the second circuit chip 70 is bonded to the second die pad 111 by the conductive bonding material SD. The second circuit chip 70 includes the second circuit 30.

As shown in FIG. 2, the chip main surface 70s of the second circuit chip 70 includes first electrode pads 71, second electrode pads 72, and third electrode pads 73. The electrode pads 71 to 73 are electrically connected to the second circuit 30.

The first electrode pads 71 are arranged in one of two opposite ends of the chip main surface 70s in the Y-direction that is located closer to the transformer chip 80. The first electrode pads 71 are aligned in the X-direction. The second electrode pads 72 are arranged in the other one of the two opposite ends of the chip main surface 70s in the Y-direction that is farther from the transformer chip 80. In other words, the second electrode pads 72 are arranged in one of the two opposite ends of the chip main surface 70s in the Y-direction that is located closer to the second leads 112. The second electrode pads 72 are aligned in the X-direction. The third electrode pads 73 are arranged in each of two opposite ends of the chip main surface 70s in the X-direction.

The transformer chip 80 includes multiple transformers 40, namely, the first to fourth transformers 40A to 40D (refer to FIG. 1). In plan view, the transformer chip 80 has a rectangular shape with short sides and long sides. In the present embodiment, the transformer chip 80 is mounted on the first die pad 101, so that the long sides extend in the X-direction and the short sides extend in the Y-direction in plan view. As shown in FIG. 3, the transformer chip 80 includes a chip main surface 80s and a chip back surface 80r facing away from each other in the Z-direction. The chip back surface 80r of the transformer chip 80 is bonded to the first die pad 101 by the conductive bonding material SD.

The chip main surface 80s of the transformer chip 80 includes first electrode pads 81 and second electrode pads 82. The first electrode pads 81 are electrically connected to the first coils 41 of the first to fourth transformers 40A to 40D (refer to FIG. 1), and the second electrode pads 82 are electrically connected to the second coils 42 of the first to fourth transformers 40A to 40D (refer to FIG. 1). The first electrode pads 81 and the second electrode pads 82 both include one or more materials selected from titanium (Ti), titanium nitride (TiN), gold (Au), Ag, Cu, Al, and tungsten (W).

As shown in FIG. 2, for example, the second electrode pads 82 are arranged in one of two opposite ends of the chip main surface 80s in the Y-direction that is located closer to the first circuit chip 60. The second electrode pads 82 are aligned in the X-direction. For example, the first electrode pads 81 are arranged in the central part of the chip main surface 80s in the Y-direction. The first electrode pads 81 are aligned in the X-direction.

Since the lead frames 100 and 110 are located closest to each other at the first die pad 101 and the second die pad 111, the first die pad 101 and the second die pad 111 need to be distanced to allow the signal transmission device 10 to have a predetermined dielectric strength. Therefore, the transformer chip 80 is located closer to the first circuit chip 60 than to the second circuit chip 70. That is, the distance between the second circuit chip 70 and the transformer chip 80 is greater than the distance between the first circuit chip 60 and the transformer chip 80 in plan view.

Wires W1 to W4 are connected to the first circuit chip 60, the transformer chip 80, and the second circuit chip 70. The wires W1 to W4 are bonding wires formed by a wire bonder. The wires W1 to W4 are formed from a conductor containing, for example, Au, Al, Cu, or the like.

The first circuit chip 60 is electrically connected to the first lead frame 100 by the wires W1. More specifically, the first electrode pads 61 and the third electrode pads 63 of the first circuit chip 60 are connected to the first leads 102 by the wires W1. Therefore, the first circuit 20 (refer to FIG. 1) is electrically connected to the first leads 102. The third electrode pads 63 of the first circuit chip 60 are connected by the wires W1 to the two of the first leads 102 that are integrated with the first die pad 101. In the present embodiment, the two first leads 102 integrated with the first die pad 101 serve as ground terminals, and the first circuit 20 is electrically connected to the first die pad 101 through the wires W1. Accordingly, the first die pad 101 has the same potential as ground GND1 of the first circuit 20.

The second circuit chip 70 is electrically connected to the second leads 112 of the second lead frame 110 by the wires W4. More specifically, the second electrode pads 72 and the third electrode pads 73 of the second circuit chip 70 are connected to the second leads 112 by the wires W4. Therefore, the second circuit 30 (refer to FIG. 1) is electrically connected to the second leads 112. In the present embodiment, the two second leads 112 integrated with the second die pad 111 serve as ground terminals, and the second circuit 30 is electrically connected to the second die pad 111 through the wires W4. Accordingly, the second die pad 111 have the same potential as ground GND2 of the second circuit 30.

The transformer chip 80 is connected to the first circuit chip 60 by the wires W2 and is connected to the second circuit chip 70 by the wires W3. More specifically, the second electrode pads 82 of the transformer chip 80 are connected to the second electrode pads 62 of the first circuit chip 60 by the wires W2. Therefore, the second coils 42 of the first to fourth transformers 40A to 40D are electrically connected to the first circuit 20. The first electrode pads 81 of the transformer chip 80 are connected to the first electrode pads 71 of the second circuit chip 70 by the wires W3. Therefore, the first coils 41 of the first to fourth transformers 40A to 40D are electrically connected to the second circuit 30.

The second coils 42 of the first to fourth transformers 40A to 40D are electrically connected to the ground GND1 of the first circuit 20 through the wires W2, the first circuit chip 60, and the like. The first coils 41 of the first to fourth transformers 40A to 40D are electrically connected to the ground GND2 of the second circuit 30 through the wires W3, the second circuit chip 70, and the like.

FIGS. 1 to 3 show an exemplary configuration of the signal transmission device 10, and thus the circuitry included in the first circuit chip 60 and the second circuit chip 70 may be changed. In an example, the first circuit 20 may include the transmission circuit 21 and does not have to include the reception circuit 22. The second circuit 30 may include the reception circuit 31 and does not have to include the transmission circuit 32. The first circuit 20 may include a circuit other than the transmission circuit 21 and the reception circuit 22. The second circuit 30 may include a circuit other than the reception circuit 31 and the transmission circuit 32. The first circuit 20 may include, for example, an analog-digital conversion circuit. In this case, the signal transmission device 10 is used as an isolated A/D converter.

In an example, the second circuit 30 may include a driver circuit configured to drive a gate of a switching element. This driver circuit may be connected to an external terminal (e.g., second leads 112 shown in FIG. 2) of the signal transmission device 10. In this case, the signal transmission device 10 is used as an isolated gate driver configured to drive a switching element. The switching element may include a power semiconductor element, such as a Si metal-oxide-semiconductor field-effect transistor (Si-MOSFET), a SiC-MOSFET, or an insulated-gate bipolar transistor (IGBT). The driver circuit typically includes a half-bridge circuit in which a low-side switching element and a high-side switching element are connected in a totem-pole configuration.

When used as an isolated gate driver, the signal transmission device 10 is configured to apply a drive voltage signal to a control terminal of a switching element. In this case, the transmission circuit 21 of the first circuit 20 is configured to convert, for example, a control signal received from a controller into a pulse signal. When the reception circuit 31 receives the signal through the first transformer 40A and the second transformer 40B, the driver circuit of the second circuit 30 transmits a drive voltage signal to the control terminal of the switching element. For example, the transmission circuit 32 of the second circuit 30 and the reception circuit 22 of the first circuit 20 may be used to transmit a detection signal of a temperature sensor arranged in the vicinity of a motor to the controller.

In the signal transmission device 10 used as an isolated gate driver as described above, a power supply voltage of the first circuit 20, which is configured to receive a signal from the controller, is 5 V, 3.3 V, or the like, based on the ground potential. In contrast, the second circuit 30 connected to a high-side switching element transiently receives a voltage (e.g., 600 V or higher) that is equivalent to a voltage applied to a drain of the high-side switching element. Thus, there is a need for the signal transmission device 10 to have a dielectric strength between the first circuit 20 and the second circuit 30, more specifically, between the first coils 41 and the second coils 42 of the first transformer 40A and the second transformer 40B. The dielectric breakdown voltage in this case is in a range of 2500 Vrms to 7500 Vrms, inclusive. In an example, the dielectric breakdown voltage of the signal transmission device 10 is approximately 5000 Vrms. The dielectric breakdown voltage of the signal transmission device 10 is not limited to any specific numerical value.

### Detailed Configuration of Transformer Chip

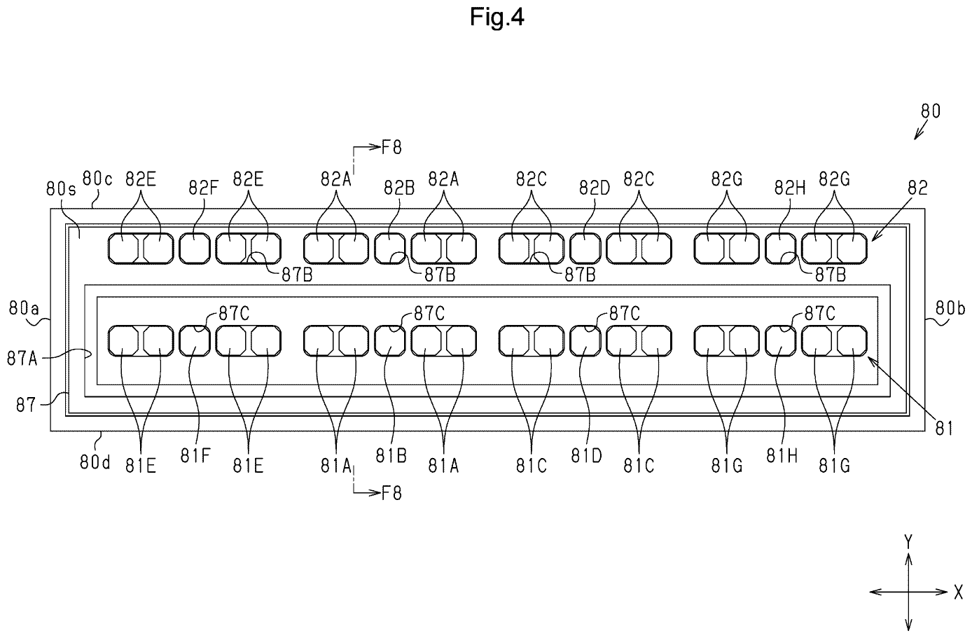

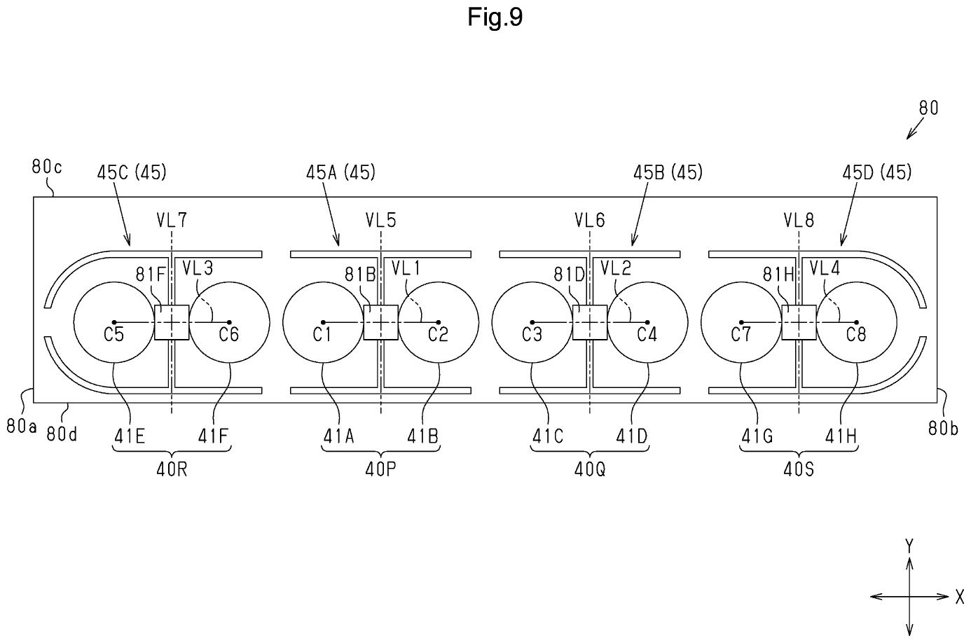

An exemplary configuration of the transformer chip 80 will now be described with reference to FIGS. 4 to 17. In the description hereafter, the direction extending from the chip back surface 80r toward the chip main surface 80s of the transformer chip 80 shown in FIG. 9 will be referred to as the upward direction, and the direction extending from the chip main surface 80s toward the chip back surface 80r will be referred to as the downward direction.

### Overall Arrangement of Transformers and Electrodes

The overall arrangement of the first to fourth transformers 40A to 40D, the first electrode pads 81, and the second electrode pads 82 will be described below with reference to FIGS. 4 to 7.

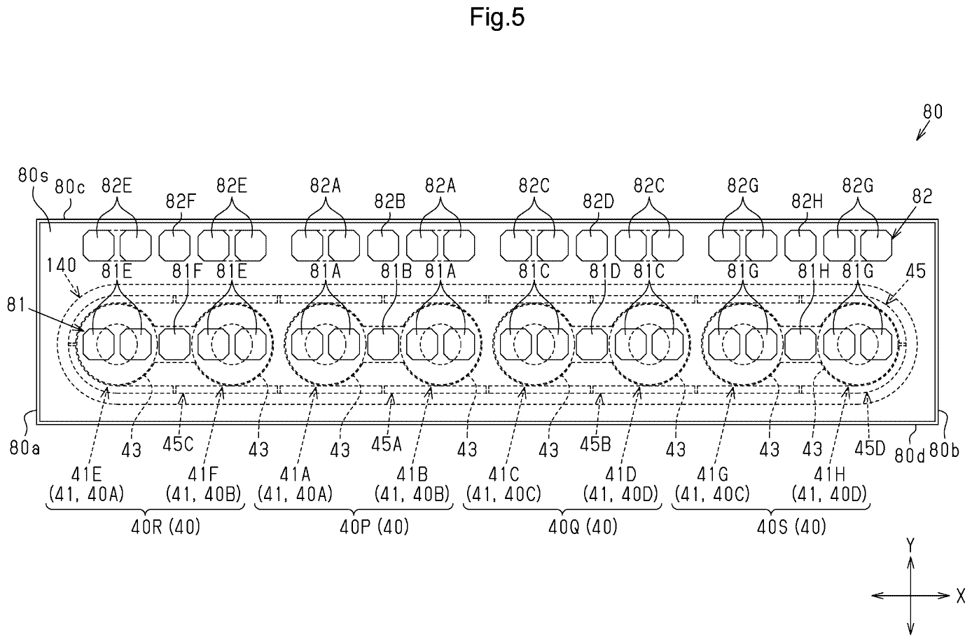

FIG. 4 is a schematic plan view illustrating the external appearance of the transformer chip 80. FIG. 5 is a schematic plan view of the transformer chip 80 illustrating the positional relationship between the first to fourth transformers 40A to 40D and the first electrode pads 81 and the second electrode pads 82 of the transformer chip 80. In FIG. 5, a passivation film 86 is omitted, and the first to fourth transformers 40A to 40D, dummy wiring 45, and floating dummy wiring 140 are each indicated by broken lines.

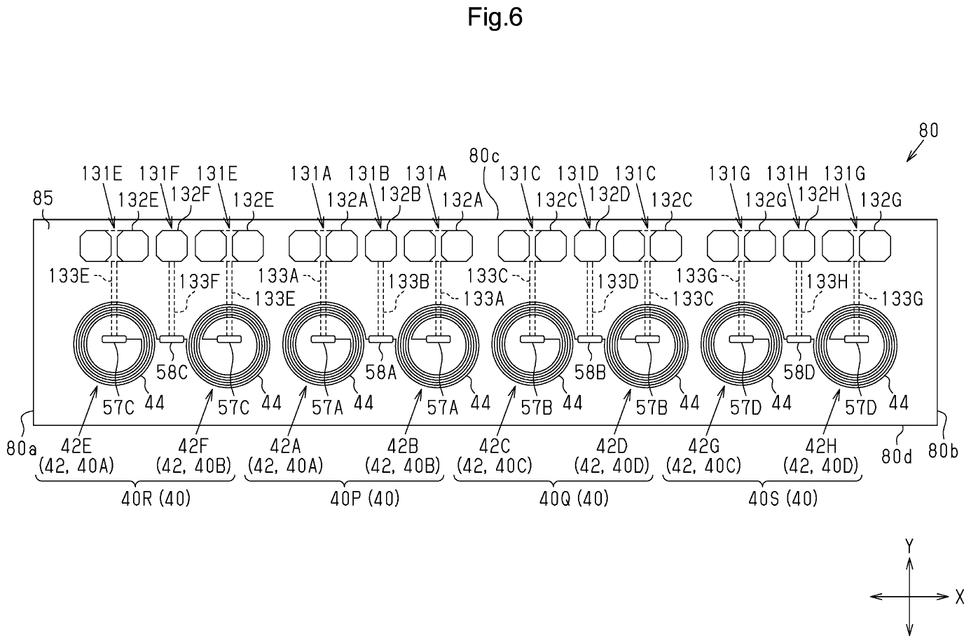

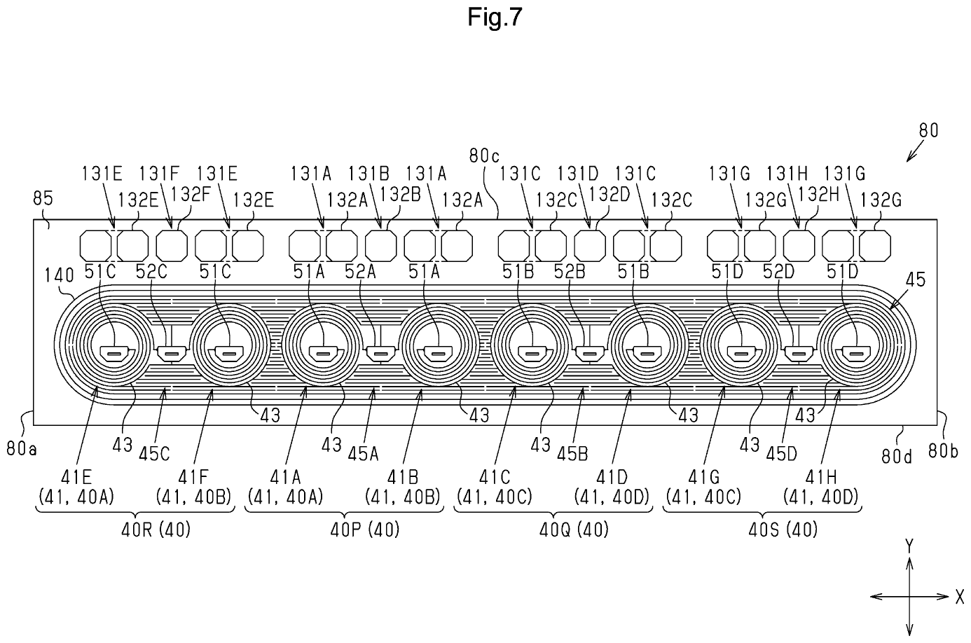

FIG. 6 shows a schematic cross-sectional structure of the transformer chip 80 taken along an XY plane at a position in the Z-direction where the second coils 42 of the first to fourth transformers 40A to 40D are located. FIG. 6 shows the connection relationship of the second coils 42. FIG. 7 shows a schematic cross-sectional structure of the transformer chip 80 taken along an XY plane at a position in the Z-direction where the first coils 41 of the first to fourth transformers 40A to 40D are located. FIG. 7 shows the connection relationship of the first coils 41. In FIGS. 6 and 7, hatching lines are not shown to facilitate understanding of the drawings.

As shown in FIG. 5, the transformer chip 80 includes two pairs of first transformer 40A and second transformer 40B, and two pairs of third transformer 40C and fourth transformer 40D. In other words, the transformer chip 80 is a semiconductor chip in which two pairs of first transformer 40A and second transformer 40B and two pairs of third transformer 40C and fourth transformer 40D are incorporated. That is, the transformer chip 80 is separate from the first circuit chip 60 and the second circuit chip 70 (refer to FIG. 2).

The transformer chip 80 includes chip side surfaces 80a to 80d. The chip side surfaces 80a and 80b serve as two end surfaces of the transformer chip 80 in the X-direction, and the chip side surfaces 80c and 80d serve as two end surfaces of the transformer chip 80 in the Y-direction. That is, in plan view, the chip side surfaces 80a and 80b define the short sides of the transformer chip 80, and the chip side surfaces 80c and 80d define the long sides of the transformer chip 80.

The two sets of the first to fourth transformers 40A to 40D are located closer to the chip side surface 80d than the center of the transformer chip 80 in the Y-direction is. The two sets of the first to fourth transformers 40A to 40D are located at the same position in the Y-direction and are aligned with and spaced apart from each other in the X-direction. The two sets of the first to fourth transformers 40A to 40D are aligned so that a pair of first transformer 40A and second transformer 40B, another pair of first transformer 40A and second transformer 40B, a pair of third transformer 40C and fourth transformer 40D, and another pair of third transformer 40C and fourth transformer 40D are arranged in this order from the chip side surface 80a toward the chip side surface 80b. In each pair of first transformer 40A and second transformer 40B, the first transformer 40A is located closer to the chip side surface 80a than the second transformer 40B is. In each pair of third transformer 40C and fourth transformer 40D, the third transformer 40C is located closer to the chip side surface 80a than the fourth transformer 40D is. As a result, the two sets of the first to fourth transformers 40A to 40D are aligned so that the first transformer 40A, the second transformer 40B, the first transformer 40A, the second transformer 40B, the third transformer 40C, the fourth transformer 40D, the third transformer 40C, and the fourth transformer 40D are arranged in this order from the chip side surface 80a toward the chip side surface 80b. As shown in FIGS. 6 and 7, the first to fourth transformers 40A to 40D have the same configuration.

In the description hereafter, a pair of first transformer 40A and second transformer 40B will be referred to as “first isolation transformer 40P”, and a pair of third transformer 40C and fourth transformer 40D will be referred to as “second isolation transformer 40Q”. Further, another pair of first transformer 40A and second transformer 40B will be referred to as “third isolation transformer 40R”, and another pair of third transformer 40C and fourth transformer 40D will be referred to as “fourth isolation transformer 40S”. Accordingly, the transformer chip 80 of the present embodiment includes the first isolation transformer 40P, the second isolation transformer 40Q, the third isolation transformer 40R, and the fourth isolation transformer 40S. The third isolation transformer 40R and the fourth isolation transformer 40S are separately disposed at opposite sides of the first isolation transformer 40P and the second isolation transformer 40Q in the X-direction. In other words, the first isolation transformer 40P and the second isolation transformer 40Q are arranged between the third isolation transformer 40R and the fourth isolation transformer 40S in the X-direction.

The first electrode pads 81 include first to eighth pads 81A to 81H.

The first pad 81A and the second pad 81B are electrically connected to the first transformer 40A and the second transformer 40B of the first isolation transformer 40P. The first pad 81A is located at a position that overlaps the first transformer 40A and the second transformer 40B of the first isolation transformer 40P in plan view. The first pad 81A provided for the first transformer 40A and the second transformer 40B includes multiple first pads 81A. Specifically, the first pads 81A include first pads 81A electrically connected to the first transformer 40A, and first pads 81A electrically connected to the second transformer 40B. The second pad 81B is located outside the first transformer 40A and the second transformer 40B. In an example, the second pad 81B is located between the first transformer 40A and the second transformer 40B in the X-direction. The second pad 81B is electrically connected to both the first transformer 40A and the second transformer 40B. In other words, the second pad 81B serves as a common pad of the first transformer 40A and the second transformer 40B. The second pad 81B is an example of “first outer pad”.

The third pad 81C and the fourth pad 81D are electrically connected to the third transformer 40C and the fourth transformer 40D of the second isolation transformer 40Q. The third pad 81C is located at a position that overlaps the third transformer 40C and the fourth transformer 40D of the second isolation transformer 40Q in plan view. The third pad 81C provided for the third transformer 40C and the fourth transformer 40D includes multiple third pads 81C. Specifically, the third pads 81C include third pads 81C electrically connected to the third transformer 40C, and third pads 81C electrically connected to the fourth transformer 40D. The fourth pad 81D is located outside the third transformer 40C and the fourth transformer 40D. In an example, the fourth pad 81D is located between the third transformer 40C and the fourth transformer 40D in the X-direction. The fourth pad 81D is electrically connected to both the third transformer 40C and the fourth transformer 40D. In other words, the fourth pad 81D serves as a common pad of the third transformer 40C and the fourth transformer 40D. The fourth pad 81D is an example of “second outer pad”.

The fifth pad 81E and the sixth pad 81F are electrically connected to the first transformer 40A and the second transformer 40B of the third isolation transformer 40R. The fifth pad 81E is located at a position that overlaps the first transformer 40A and the second transformer 40B of the third isolation transformer 40R in plan view. The fifth pad 81E provided for the first transformer 40A and the second transformer 40B includes multiple fifth pads 81E. Specifically, the fifth pads 81E include fifth pads 81E electrically connected to the first transformer 40A, and fifth pads 81E electrically connected to the second transformer 40B. The sixth pad 81F is located outside the first transformer 40A and the second transformer 40B. In an example, the sixth pad 81F is located between the first transformer 40A and the second transformer 40B in the X-direction. The sixth pad 81F is electrically connected to both the first transformer 40A and the second transformer 40B. In other words, the sixth pad 81F serves as a common pad of the first transformer 40A and the second transformer 40B.

The seventh pad 81G and the eighth pad 81H are electrically connected to the third transformer 40C and the fourth transformer 40D of the fourth isolation transformer 40S. The seventh pad 81G is located at a position that overlaps the third transformer 40C and the fourth transformer 40D of the fourth isolation transformer 40S in plan view. The seventh pad 81G provided for the third transformer 40C and the fourth transformer 40D includes multiple seventh pads 81G. Specifically, the seventh pads 81G include seventh pads 81G electrically connected to the third transformer 40C, and seventh pads 81G electrically connected to the fourth transformer 40D. The eighth pad 81H is located outside the third transformer 40C and the fourth transformer 40D. In an example, the eighth pad 81H is located between the third transformer 40C and the fourth transformer 40D in the X-direction. The eighth pad 81H is electrically connected to both the third transformer 40C and the fourth transformer 40D. In other words, the eighth pad 81H serves as a common pad of the third transformer 40C and the fourth transformer 40D.

In plan view, the second electrode pads 82 are located closer to the chip side surface 80c than the first to fourth transformers 40A to 40D are. In an example, the second electrode pads 82 are arranged in one of two opposite ends of the transformer chip 80 in the Y-direction that is located closer to the chip side surface 80c. In other words, in plan view, the second electrode pads 82 are located closer to the first lead 102 (refer to FIG. 2) than the two sets of the first to fourth transformers 40A to 40D are. The second electrode pads 82 are located at the same position as the two sets of the first to fourth transformers 40A to 40D in the X-direction.

The second electrode pads 82 include first to eighth pads 82A to 82H. The first pad 82A corresponds to the first pad 81A of the first electrode pad 81. The second pad 82B corresponds to the second pad 81B of the first electrode pad 81. The third pad 82C corresponds to the third pad 81C of the first electrode pad 81. The fourth pad 82D corresponds to the fourth pad 81D of the first electrode pad 81. The fifth pad 82E corresponds to the fifth pad 81E of the first electrode pad 81. The sixth pad 82F corresponds to the sixth pad 81F of the first electrode pad 81. The seventh pad 82G corresponds to the seventh pad 81G of the first electrode pad 81. The eighth pad 82H corresponds to the eighth pad 81H of the first electrode pad 81. In an example, the first pad 82A and the second pad 82B are electrically connected to the first transformer 40A and the second transformer 40B of the first isolation transformer 40P. The third pad 82C and the fourth pad 82D are electrically connected to the third transformer 40C and the fourth transformer 40D of the second isolation transformer 40Q. The fifth pad 82E and the sixth pad 82F are electrically connected to the first transformer 40A and the second transformer 40B of the third isolation transformer 40R. The seventh pad 82G and the eighth pad 82H are electrically connected to the third transformer 40C and the fourth transformer 40D of the fourth isolation transformer 40S.

The first pad 82A provided for the first transformer 40A and the second transformer 40B of the first isolation transformer 40P includes multiple first pads 82A. Specifically, the first pads 82A include first pads 82A electrically connected to the first transformer 40A, and first pads 82A electrically connected to the second transformer 40B. The second pad 82B is electrically connected to both the first transformer 40A and the second transformer 40B. In other words, the second pad 82B serves as a common pad of the first transformer 40A and the second transformer 40B.

The third pad 82C provided for the third transformer 40C and the fourth transformer 40D of the second isolation transformer 40Q includes multiple third pads 82C. Specifically, the third pads 82C include third pads 82C electrically connected to the third transformer 40C, and third pads 82C electrically connected to the fourth transformer 40D. The fourth pad 82D is electrically connected to both the third transformer 40C and the fourth transformer 40D. In other words, the fourth pad 82D serves as a common pad of the third transformer 40C and the fourth transformer 40D.

The fifth pad 82E provided for the first transformer 40A and the second transformer 40B of the third isolation transformer 40R includes multiple fifth pads 82E. Specifically, the fifth pads 82E include fifth pads 82E electrically connected to the first transformer 40A, and fifth pads 82E electrically connected to the second transformer 40B. The sixth pad 82F is electrically connected to both the first transformer 40A and the second transformer 40B. In other words, the sixth pad 82F serves as a common pad of the first transformer 40A and the second transformer 40B.

The seventh pad 82G provided for the third transformer 40C and the fourth transformer 40D of the fourth isolation transformer 40S includes multiple seventh pads 82G. Specifically, the seventh pads 82G include seventh pads 82G electrically connected to the third transformer 40C, and seventh pads 82G electrically connected to the fourth transformer 40D. The eighth pad 82H is electrically connected to both the third transformer 40C and the fourth transformer 40D. In other words, the eighth pad 82H serves as a common pad of the third transformer 40C and the fourth transformer 40D.

### Cross-Sectional Structure of Transformer Chip

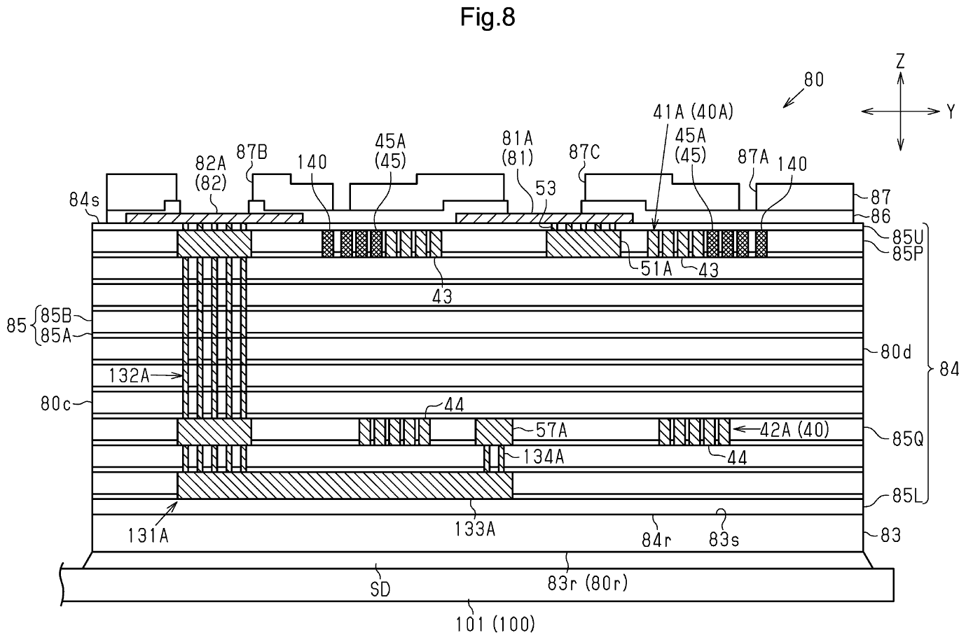

FIG. 8 is a schematic cross-sectional view of the transformer chip 80 mainly showing the cross-sectional structure of the transformer 40A. The cross-sectional structure of the transformer chip 80 will now be described with reference to FIGS. 4 and 8.

As shown in FIG. 8, the transformer chip 80 includes a substrate 83 and an insulating layer 84 formed on the substrate 83.

The substrate 83 is includes, for example, a semiconductor substrate. In the present embodiment, the substrate 83 is formed from a material containing silicon (Si). Examples of a Si substrate used as the substrate 83 may include a semiconductor substrate formed from a single-crystal intrinsic semiconductor material, a p-type semiconductor substrate containing an acceptor impurity, an n-type semiconductor substrate containing a donor impurity, and the like.

The substrate 83 may be a substrate of a wide-bandgap semiconductor or a compound semiconductor. The wide-bandgap semiconductor is a semiconductor substrate having a bandgap of 2.0 eV or greater. The wide-bandgap semiconductor may contain silicon carbide (SiC), gallium nitride (GaN), gallium oxide (Ga₂O₃), or the like. The compound semiconductor may be a III-V compound semiconductor. The compound semiconductor may contain at least one of aluminum nitride (AlN), indium nitride (InN), GaN, and gallium arsenide (GaAs). Instead of a semiconductor substrate, the substrate 83 may be an insulator substrate formed from a material containing glass.

The substrate 83 includes a substrate main surface 83s and a substrate back surface 83r facing away from each other in the Z-direction. The substrate main surface 83s faces the same direction as the chip main surface 80s of the transformer chip 80, and the substrate back surface 83r faces the same direction as the chip back surface 80r of the transformer chip 80. In an example, the substrate back surface 83r defines the chip back surface 80r of the transformer chip 80.

The insulating layer 84 includes multiple insulating films 85 stacked on the substrate main surface 83s of the substrate 83 in the Z-direction. Accordingly, the Z-direction may be referred to as the thickness-wise direction of the insulating layer 84. Also, the Z-direction may be referred to as the stacking direction of the insulating films 85. The insulating layer 84 is formed on the substrate main surface 83s of the substrate 83. The insulating layer 84 includes an upper surface 84s and a lower surface 84r facing away from the upper surface 84s. The lower surface 84r is in contact with the substrate main surface 83s. The upper surface 84s is an example of “front surface of insulating layer”, and the lower surface 84r is an example of “back surface of insulating layer”.

The insulating films 85 each include a first insulating film 85A and a second insulating film 85B formed on the first insulating film 85A. The first insulating film 85A is a thin layer, such as an etching stopper layer. The first insulating film 85A is formed from a material containing silicon nitride (SiN), SiC, silicon carbon nitride (SiCN), or the like. In the present embodiment, the first insulating film 85A is formed from a material containing SiN. The second insulating film 85B is, for example, an interlayer insulating film. The second insulating film 85B is formed from a material containing, for example, silicon oxide (SiO). In the present embodiment, the second insulating film 85B is formed from SiO₂. The second insulating film 85B is thicker than the first insulating film 85A. The thickness of the first insulating film 85A may be, for example, greater than or equal to 100 nm and less than 1000 nm. The thickness of the second insulating film 85B may be in a range of 1000 nm to 3000 nm, inclusive. In the present embodiment, the thickness of the first insulating film 85A is, for example, approximately 300 nm, and the thickness of the second insulating film 85B is, for example, approximately 2000 nm.

The insulating films 85 include a lowermost insulating film 85L and an uppermost insulating film 85U each formed by the second insulating film 85B. The lowermost insulating film 85L is in contact with the substrate main surface 83s of the substrate 83. In an example, the lowermost insulating film 85L and the uppermost insulating film 85U are both thinner than the other insulating films 85. The lowermost insulating film 85L and the uppermost insulating film 85U each have a thickness that is greater than or equal to the thickness of the first insulating film 85A and is less than or equal to the thickness of the second insulating film 85B.

The thickness of the lowermost insulating film 85L and the thickness of the uppermost insulating film 85U may be changed. In an example, the thickness of the lowermost insulating film 85L and the thickness of the uppermost insulating film 85U may each be greater than the thickness of the second insulating film 85B. In another example, the thickness of the lowermost insulating film 85L and the thickness of the uppermost insulating film 85U may each be greater than the thickness of the insulating film 85, which includes the first insulating film 85A and the second insulating film 85B.

The transformer chip 80 includes the passivation film 86. The passivation film 86 is formed on the upper surface 84s of the insulating layer 84. The passivation film 86 is configured to protect the insulating layer 84 and may be referred to as a surface protection film of the transformer chip 80. The passivation film 86 is formed from a material containing, for example, any one of SiO, SiN, and SiCN. The passivation film 86 includes an upper surface that defines the chip main surface 80s of the transformer chip 80.

The electrode pads 81 and 82 are covered by the passivation film 86. The passivation film 86 includes openings that expose parts of the electrode pads 81 and 82. Accordingly, the second electrode pads 82 each include an exposed surface used for connection with the wire W2 (refer to FIG. 2). Also, the first electrode pads 81 each include an exposed surface used for connection with the wire W3 (refer to FIG. 2).

The transformer chip 80 includes a resin layer 87 formed on the passivation film 86. The resin layer 87 is formed from a material containing, for example, polyimide (PI). The resin layer 87 is isolated into an inner resin layer and an outer resin layer by an isolation trench 87A. As shown in FIG. 4, the isolation trench 87A has a shape of a rectangular frame in plan view. Although not shown in the drawings, the isolation trench 87A is formed to surround the two sets of the first to fourth transformers 40A to 40D in plan view. In other words, the isolation trench 87A is formed to surround the first to fourth isolation transformers 40P, 40Q, 40R, and 40S in plan view. The resin layer 87 includes first resin openings 87B that expos the second electrode pads 82, and second resin openings 87C that expose the first electrode pads 81. The exposed surfaces of the second electrode pads 82 are exposed to the outside of the transformer chip 80 through the first resin openings 87B and the openings of the passivation film 86 (refer to FIG. 8). The exposed surfaces of the first electrode pads 81 are exposed to the outside of the transformer chip 80 through the second resin openings 87C and the openings of the passivation film 86.

### Second Coils

The configuration of the second coils 42 and the connection structure between the second coils 42 and the second electrode pads 82 will now be described with reference to FIGS. 5, 6, and 8.

As shown in FIG. 6, the second coils 42 of the two sets of the first to fourth transformers 40A to 40D include first to eighth back coils 42A to 42H. More specifically, the second coil 42 of the first transformer 40A of the first isolation transformer 40P is the first back coil 42A, and the second coil 42 of the second transformer 40B of the first isolation transformer 40P is the second back coil 42B. The second coil 42 of the third transformer 40C of the second isolation transformer 40Q is the third back coil 42C, and the second coil 42 of the fourth transformer 40D of the second isolation transformer 40Q is the fourth back coil 42D. The second coil 42 of the first transformer 40A of the third isolation transformer 40R is the fifth back coil 42E, the second coil 42 of the second transformer 40B of the third isolation transformer 40R is the sixth back coil 42F. The second coil 42 of the third transformer 40C of the fourth isolation transformer 40S is the seventh back coil 42G, and the second coil 42 of the fourth transformer 40D of the fourth isolation transformer 40S is the eighth back coil 42H.

The first to eighth back coils 42A to 42H are each formed by second coil wiring 44. The second coil wiring 44 is spiral in plan view. The second coil wiring 44 contains one or more materials selected from Ti, TiN, Au, Ag, Cu, Al, and W.

In the example shown in FIG. 6, the first to eighth back coils 42A to 42H are ring-shaped. Two adjacent ones of the first to eighth back coils 42A to 42H in the X-direction are wound in opposite directions. Specifically, the second back coil 42B is formed by winding the second coil wiring 44 in a direction opposite to that of the first back coil 42A in plan view. The fourth back coil 42D is formed by winding the second coil wiring 44 in a direction opposite to that of the third back coil 42C in plan view. The sixth back coil 42F is formed by winding the second coil wiring 44 in a direction opposite to that of the fifth back coil 42E in plan view. The eighth back coil 42H is formed by winding the second coil wiring 44 in a direction opposite to that of the seventh back coil 42G in plan view. The first to eighth back coils 42A to 42H include equal number of turns of the second coil wiring 44.

An inner end wire 57A is arranged inside the second coil wiring 44 of each of the first back coil 42A and the second back coil 42B, and an outer end wire 58A is arranged outside the second coil wiring 44 of the first back coil 42A and the second back coil 42B. One end of the second coil wiring 44 of each of the first back coil 42A and the second back coil 42B is electrically connected to the corresponding inner end wire 57A, and the other ends of the second coil wiring 44 are electrically connected to the outer end wire 58A. The outer end wire 58A serves as a common end wire of the first back coil 42A and the second back coil 42B.

An inner end wire 57B is arranged inside the second coil wiring 44 of each of the third back coil 42C and the fourth back coil 42D, and an outer end wire 58B is arranged outside the second coil wiring 44 of the third back coil 42C and the fourth back coil 42D. One end of the second coil wiring 44 of each of the third back coil 42C and the fourth back coil 42D is electrically connected to the corresponding inner end wire 57B, and the other ends of the second coil wiring 44 are electrically connected to the outer end wire 58B. The outer end wire 58B serves as a common end wire of the third back coil 42C and the fourth back coil 42D.

An inner end wire 57C is arranged inside the second coil wiring 44 of each of the fifth back coil 42E and the sixth back coil 42F, and an outer end wire 58C is arranged outside the second coil wiring 44 of the fifth back coil 42E and the sixth back coil 42F. One end of the second coil wiring 44 of each of the fifth back coil 42E and the sixth back coil 42F is electrically connected to the corresponding inner end wire 57C, and the other ends of the second coil wiring 44 are electrically connected to the outer end wire 58C. The outer end wire 58C serves as a common end wire of the fifth back coil 42E and the sixth back coil 42F.

An inner end wire 57D is arranged inside the second coil wiring 44 of each of the seventh back coil 42G and the eighth back coil 42H, and an outer end wire 58D is arranged outside the second coil wiring 44 of the seventh back coil 42G and the eighth back coil 42H. One end of the second coil wiring 44 of each of the seventh back coil 42G and the eighth back coil 42H is electrically connected to the corresponding inner end wire 57D, and the other ends of the second coil wiring 44 are electrically connected to the outer end wire 58D. The outer end wire 58D serves as a common end wire of the seventh back coil 42G and the eighth back coil 42H. The inner end wires 57A to 57D and the outer end wires 58A to 58D include a material containing one or more materials selected from Ti, TiN, Au, Ag, Cu, Al, and W.

One end of the second coil wiring 44 corresponds to the inner end of the second coil wiring 44, which is spiral in plan view. The other end of the second coil wiring 44 corresponds to the outer end of the second coil wiring 44, which is spiral in plan view. The configuration of the outer end wires 58A to 58D may be changed. The outer end wire 58A may be provided for each of the first back coil 42A and the second back coil 42B. The outer end wire 58B may be provided for each of the third back coil 42C and the fourth back coil 42D. The outer end wire 58C may be provided for each of the fifth back coil 42E and the sixth back coil 42F. The outer end wire 58D may be provided for each of the seventh back coil 42G and the eighth back coil 42H.

As shown in FIGS. 5 and 6, the inner end wire 57A is electrically connected to the first pad 82A by an interconnect 131A. The inner end wire 57B is electrically connected to the third pad 82C by an interconnect 131C. The inner end wire 57C is electrically connected to the fifth pad 82E by an interconnect 131E. The inner end wire 57D is electrically connected to the seventh pad 82G by an interconnect 131G. The interconnects 131A, 131C, 131E, and 131G include a material containing one or more materials selected from Ti, TiN, Au, Ag, Cu, Al, and W. The interconnects 131C, 131E, and 131G have the same configuration as the interconnect 131A. Hence, the configuration of the interconnect 131A will be described below, and detailed description on the configurations of the interconnects 131C, 131E, and 131G will be omitted.

As shown in FIG. 8, the interconnect 131A includes a first interconnect part 132A extending through the insulating films 85 in the Z-direction, and a second interconnect part 133A extending in the Y-direction.

The first interconnect part 132A is located at a position that overlaps the first pad 82A in plan view. The first interconnect part 132A is connected to the first pad 82A. The first interconnect part 132A extends through the insulating films 85 from the insulating film 85 that is located immediately below the uppermost insulating film 85U to the insulating film 85 that is located two layers above the lowermost insulating film 85L. The first interconnect part 132A includes flat interconnect pieces and vias. Two interconnect pieces are respectively arranged at positions where the coils 41 and 42 are located in the insulating films 85P and 85Q. The vias extend between the two wiring pieces in the Z-direction, between the upper interconnect piece and the first pad 82A, and between the lower interconnect piece and the second interconnect part 133A.

The second interconnect part 133A is located closer to the substrate 83 than the first interconnect part 132A is. The second interconnect part 133A is located closer to the substrate 83 than the first back coil 42A is. In an example, the second interconnect part 133A is arranged in the insulating film 85 that is located immediately above the lowermost insulating film 85L. A first end of the second interconnect part 133A in the Y-direction that is located relatively close to the chip side surface 80c of the transformer chip 80 overlaps the first interconnect part 132A in plan view. The second interconnect part 133A is connected to the first interconnect part 132A. A second end of the second interconnect part 133A located at a side opposite to the first end overlaps the first back coil 42A in plan view. More specifically, in plan view, the second end is located at a position that overlaps the inner end wire 57A, which is connected to the first back coil 42A. The interconnect 131A includes vias 134A that connect the second interconnect part 133A and the inner end wire 57A. As shown in FIG. 6, the interconnects 131C, 131E, and 131G respectively include first interconnect parts 132C, 132E, and 132G, second interconnect parts 133C, 133E, and 133G, and vias (not shown), in the same manner as the interconnect 131A.

As shown in FIGS. 5 and 6, the outer end wire 58A is electrically connected to the second pad 82B by an interconnect 131B. The outer end wire 58B is electrically connected to the fourth pad 82D by an interconnect 131D. The outer end wire 58C is electrically connected to the sixth pad 82F by an interconnect 131F. The outer end wire 58D is electrically connected to the eighth pad 82H by an interconnect 131H. The interconnects 131B, 131D, 131F, and 131H include a material containing one or more materials selected from Ti, TiN, Au, Ag, Cu, Al, and W. The interconnects 131B, 131D, 131F, and 131H have the same configuration as the interconnect 131A. Hence, the configurations of the interconnects 131B, 131D, 131F, and 131H will not be described in detail. In the same manner as the interconnect 131A, the interconnects 131B, 131D, 131F, and 131H respectively include first interconnect parts 132B, 132D, 132F, and 132H, second interconnect parts 133B, 133D, 133F, and 133H, and vias (not shown). In addition, in the present embodiment, the interconnects 131B, 131D, 131F, and 131H include substrate vias (not shown) respectively connecting the second interconnect parts 133B, 133D, 133F, and 133H to the substrate 83. That is, the interconnects 131B, 131D, 131F, and 131H are electrically connected to the substrate 83.

### First Coils

The configuration of the first coils 41 and the connection structure between the first coils 41 and the first electrode pads 81 will now be described with reference to FIGS. 5, 7, and 8.

As shown in FIG. 7, the first coils 41 of the two sets of the first to fourth transformers 40A to 40D include first to eighth front coils 41A to 41H. More specifically, the first coil 41 of the first transformer 40A of the first isolation transformer 40P is the first front coil 41A, and the first coil 41 of the second transformer 40B of the first isolation transformer 40P is the second front coil 41B. The first coil 41 of the third transformer 40C of the second isolation transformer 40Q is the third front coil 41C, and the first coil 41 of the fourth transformer 40D of the second isolation transformer 40Q is the fourth front coil 41D. The first coil 41 of the first transformer 40A of the third isolation transformer 40R is the fifth front coil 41E, and the first coil 41 of the second transformer 40B of the third isolation transformer 40R is the sixth front coil 41F. The first coil 41 of the third transformer 40C of the fourth isolation transformer 40S is the seventh front coil 41G, and the first coil 41 of the fourth transformer 40D of the fourth isolation transformer 40S is the eighth front coil 41H.

The first to eighth front coils 41A to 48A are each formed by first coil wiring 43. The first coil wiring 43 is spiral in plan view. The second coil 42 contains one or more materials selected from Ti, TiN, Au, Ag, Cu, Al, and W.

In the example shown in FIG. 7, the first to eighth front coils 41A to 41H are ring-shaped. Two adjacent ones of the first to eighth front coils 41A to 41H in the X-direction are wound in opposite directions. Specifically, the second front coil 41B is formed by winding the first coil wiring 43 in a direction opposite to that of the first front coil 41A in plan view. The fourth front coil 41D is formed by winding the first coil wiring 43 in a direction opposite to that of the third front coil 41C in plan view. The sixth front coil 41F is formed by winding the first coil wiring 43 in a direction opposite to that of the fifth front coil 41E in plan view. The eighth front coil 41H is formed by winding the first coil wiring 43 in a direction opposite to that of the seventh front coil 41G in plan view. The first to eighth front coils 41A to 41H include equal number of turns of the first coil wiring 43. In an example, in plan view, the first coil wiring 43 is wound in the same direction as the second coil wiring 44 shown in FIG. 6. The number of turns of the first coil wiring 43 in the first to eighth front coils 41A to 41H is equal to the number of turns of the second coil wiring 44 in the first to eighth back coils 42A to 42H.

As shown in FIG. 5, the first pads 81A are located at a position that overlaps the first front coil 41A and the second front coil 41B in plan view. The second pad 81B is located between the first front coil 41A and the second front coil 41B in plan view. In other words, the second pad 81B is arranged outside the first coil wiring 43 of the first front coil 41A and the second front coil 41B. One end of the first coil wiring 43 of each of the first front coil 41A and the second front coil 41B is electrically connected to the corresponding first pad 81A. The other end of the first coil wiring 43 of each of the first front coil 41A and the second front coil 41B is electrically connected to the second pad 81B. Accordingly, the second pad 81B serves as a common pad of the first front coil 41A and the second front coil 41B.

The third pads 81C are located at a position that overlaps the third front coil 41C and the fourth front coil 41D in plan view. The fourth pad 81D is located between the third front coil 41C and the fourth front coil 41D in plan view. In other words, the fourth pad 81D is arranged outside the first coil wiring 43 of the third front coil 41C and the fourth front coil 41D. One end of the first coil wiring 43 of each of the third front coil 41C and the fourth front coil 41D is electrically connected to the corresponding third pad 81C. The other end of the first coil wiring 43 of each of the third front coil 41C and the fourth front coil 41D is electrically connected to the fourth pad 81D. Accordingly, the fourth pad 81D serves as a common pad of the third front coil 41C and the fourth front coil 41D.

The fifth pads 81E are located at a position that overlaps the fifth front coil 41E and the sixth front coil 41F in plan view. The sixth pad 81F is located between the fifth front coil 41E and the sixth front coil 41F in plan view. In other words, the sixth pad 81F is arranged outside the first coil wiring 43 of the fifth front coil 41E and the sixth front coil 41F. One end of the first coil wiring 43 of each of the fifth front coil 41E and the sixth front coil 41F is electrically connected to the corresponding fifth pad 81E. The other end of the first coil wiring 43 of each of the fifth front coil 41E and the sixth front coil 41F is electrically connected to the sixth pad 81F. Accordingly, the sixth pad 81F serves as a common pad of the fifth front coil 41E and the sixth front coil 41F.

The seventh pads 81G are located at a position that overlaps the seventh front coil 41G and the eighth front coil 41H in plan view. The eighth pad 81H is located between the seventh front coil 41G and the eighth front coil 41H in plan view. In other words, the eighth pad 81H is arranged outside the first coil wiring 43 of the seventh front coil 41G and the eighth front coil 41H. One end of the first coil wiring 43 of each of the seventh front coil 41G and the eighth front coil 41H is electrically connected to the corresponding seventh pad 81G. The other end of the first coil wiring 43 of each of the seventh front coil 41G and the eighth front coil 41H is electrically connected to the eighth pad 81H. Accordingly, the eighth pad 81H serves as a common pad of the seventh front coil 41G and the eighth front coil 41H.

The configurations of the second pad 81B, the fourth pad 81D, the sixth pad 81F, and the eighth pad 81H may be changed. In an example, the second pad 81B may be provided for each of the first front coil 41A and the second front coil 41B. In an example, the fourth pads 81D may be provided for each of the third front coil 41C and the fourth front coil 41D. In an example, the sixth pad 81F may be provided for each of the fifth front coil 41E and the sixth front coil 41F. In an example, the eighth pad 81H may be provided for each of the seventh front coil 41G and the eighth front coil 41H.

As shown in FIG. 7, an inner end wire 51A is arranged inside the first coil wiring 43 of each of the first front coil 41A and the second front coil 41B, and an outer end wire 52A is arranged outside the first coil wiring 43 of the first front coil 41A and the second front coil 41B. One end of the first coil wiring 43 of each of the first front coil 41A and the second front coil 41B is electrically connected to the corresponding inner end wire 51A, and the other ends of the first coil wiring 43 are electrically connected to the outer end wire 52A. The outer end wire 52A serves as a common end wire of the first front coil 41A and the second front coil 41B.

An inner end wire 51B is arranged inside the first coil wiring 43 of each of the third front coil 41C and the fourth front coil 41D, and an outer end wire 52B is arranged outside the first coil wiring 43 of the third front coil 41C and the fourth front coil 41D. One end of the first coil wiring 43 of each of the third front coil 41C and the fourth front coil 41D is electrically connected to the corresponding inner end wire 51B, and the other ends of the first coil wiring 43 are electrically connected to the outer end wire 52B. The outer end wire 52B serves as a common end wire of the third front coil 41C and the fourth front coil 41D.

An inner end wire 51C is arranged inside the first coil wiring 43 of each of the fifth front coil 41E and the sixth front coil 41F, and an outer end wire 52C is arranged outside the first coil wiring 43 of the fifth front coil 41E and the sixth front coil 41F. One end of the first coil wiring 43 of each of the fifth front coil 41E and the sixth front coil 41F is electrically connected to the corresponding inner end wire 51C, and the other ends of the first coil wiring 43 are electrically connected to the outer end wire 52C. The outer end wire 52C serves as a common end wire of the fifth front coil 41E and the sixth front coil 41F.

An inner end wire 51D is arranged inside the first coil wiring 43 of each of the seventh front coil 41G and the eighth front coil 41H, and an outer end wire 52D is arranged outside the first coil wiring 43 of the seventh front coil 41G and the eighth front coil 41H. One end of the first coil wiring 43 of each of the seventh front coil 41G and the eighth front coil 41H is electrically connected to the corresponding inner end wire 51D, and the other ends of the first coil wiring 43 are electrically connected to the outer end wire 52D. The outer end wire 52D serves as a common end wire of the seventh front coil 41G and the eighth front coil 41H. The inner end wires 51A to 51D and the outer end wires 52A to 52D includes a material containing one or more materials selected from Ti, TiN, Au, Ag, Cu, Al, and W.

One end of the first coil wiring 43 corresponds to the inner end of the first coil wiring 43, which is spiral in plan view. The other end of the first coil wiring 43 corresponds to the outer end of the first coil wiring 43, which is spiral in plan view. The configurations of the outer end wires 52A to 52D may be changed. The outer end wire 52A may be provided for each of the first front coil 41A and the second front coil 41B. The outer end wire 52B may be provided for each of the third front coil 41C and the fourth front coil 41D. The outer end wire 52C may be provided for each of the fifth front coil 41E and the sixth front coil 41F. The outer end wire 52D may be provided for each of the seventh front coil 41G and the eighth front coil 41H.

As shown in FIG. 8, the inner end wire 51A is located at a position that overlaps the first pad 81A in plan view. The inner end wire 51A is electrically connected to the first pad 81A by vias 53. The vias 53 extend through the uppermost insulating film 85U. Although not shown in the drawings, the connection structure between the inner end wire 51B and the third pad 81C, the connection structure between the inner end wire 51C and the fifth pad 81E, and the connection structure between the inner end wire 51D and the seventh pad 81G are the same as the connection structure between the inner end wire 51A and the first pad 81A. Although not shown in the drawings, the connection structure between the outer end wire 52A and the second pad 81B, the connection structure between the outer end wire 52B and the fourth pad 81D, the connection structure between the outer end wire 52C and the sixth pad 81F, and the connection structure between the outer end wire 52D and the eighth pad 81H are also the same as the connection structure between the inner end wire 51A and the first pad 81A.

As shown in FIG. 7, the transformer chip 80 includes dummy wiring 45 formed around the first to eighth front coils 41A to 41H. The dummy wiring 45 is a wiring pattern formed so that no current flows through the first coil wiring 43 of the first to eighth front coils 41A to 41H. The dummy wiring 45 is located at the same position as the first to eighth front coils 41A to 41H in the Z-direction. The dummy wiring 45 contains one or more materials selected from Ti, TiN, Au, Ag, Cu, Al, and W. The configuration of the dummy wiring 45 will be described in detail later.

The transformer chip 80 further includes floating dummy wiring 140 that surrounds the first to eighth front coils 41A to 41H and the dummy wiring 45 in plan view. The floating dummy wiring 140 is insulated from the dummy wiring 45. The floating dummy wiring 140 is located at the same position as the first to eighth front coils 41A to 41H and the dummy wiring 45 in the Z-direction. The floating dummy wiring 140 is also insulated from the first to eighth front coils 41A to 41H. That is, the floating dummy wiring 140 is electrically independent from both the first to eighth front coils 41A to 41H and the dummy wiring 45. The floating dummy wiring 140 is configured to restrict an increase in intensity of the electric field around the first to eighth front coils 41A to 41H. In an example, the floating dummy wiring 140 has a shape of a closed loop that surrounds the first to eighth front coils 41A to 41H and the dummy wiring 45. The floating dummy wiring 140 contains one or more materials selected from Ti, TiN, Au, Ag, Cu, Al, and W. The shape of the floating dummy wiring 140 may be changed. In an example, the floating dummy wiring 140 may have a shape of an open loop that surrounds the first to eighth front coils 41A to 41H and the dummy wiring 45.

### Positional Relationship of Front Coils and Back Coils

The positional relationship of the first to eighth front coils 41A to 41H and the first to eighth back coils 42A to 42H will now be described with reference to FIG. 8. FIG. 8 shows the positional relationship between the first front coil 41A and the first back coil 42A. The second to eighth front coils 41B to 41H and the second to eighth back coils 42B to 42H have the same positional relationship as that of the first front coil 41A and the first back coil 42A. Hence, the positional relationship of the first front coil 41A and the first back coil 42A will be described, and those of the second to eighth front coils 41B to 41H and the second to eighth back coils 42B to 42H will not be described.

As shown in FIG. 8, the first back coil 42A and the first front coil 41A face each other in the Z-direction with one or more insulating films 85 located in between. In the present embodiment, the first back coil 42A and the first front coil 41A face each other in the Z-direction with multiple insulating films 85 located in between. The first front coil 41A is farther from the substrate 83 than the first back coil 42A is in the Z-direction. The first front coil 41A is located upward from the first back coil 42A. In other words, the first back coil 42A is located closer to the substrate 83 than the first front coil 41A is. The first back coil 42A is located closer to the lower surface 84r than the center of the insulating layer 84 in the Z-direction is. The first back coil 42A is separated from the lowermost insulating film 85L and is located closer to the upper surface 84s than the lowermost insulating film 85L is. The first front coil 41A is located closer to the upper surface 84s than the center of the insulating layer 84 in the Z-direction is. The first front coil 41A is located closer to the lower surface 84r than the uppermost insulating film 85U is. In an example, the first front coil 41A is located at a position adjacent to the uppermost insulating film 85U in the Z-direction. In the present embodiment, the distance between the first back coil 42A and the first front coil 41A in the Z-direction is greater than the distance between the first back coil 42A and the substrate main surface 83s of the substrate 83.

The first back coil 42A is configured to be a conductive layer embedded in a single insulating film 85. More specifically, a coil groove (second coil groove) extending through both the first insulating film 85A and the second insulating film 85B in the Z-direction is formed in the insulating film 85Q in which the first back coil 42A is embedded. The conductive layer forming the first back coil 42A is embedded in the coil groove of the insulating film 85Q. The insulating films 85 that are adjacent to the insulating film 85Q in the Z-direction cover the insulating film 85Q in which the first back coil 42A is embedded. In this manner, the first back coil 42A is embedded in the insulating layer 84.

The first front coil 41A is configured to be a conductive layer embedded in a single insulating film 85. More specifically, a coil groove (first coil groove) extending through both the first insulating film 85A and the second insulating film 85B in the Z-direction is formed in the insulating film 85P in which the first front coil 41A is embedded. The conductive layer forming the first front coil 41A is embedded in the coil groove of the insulating film 85P. The insulating film 85 (85U) that is adjacent to the insulating film 85P in the Z-direction covers the insulating film 85P in which the first front coil 41A is embedded. In this manner, the first front coil 41A is embedded in the insulating layer 84.

### Configuration of Dummy Wiring

The configuration of the dummy wiring 45 will now be described with reference to FIGS. 9 to 17.

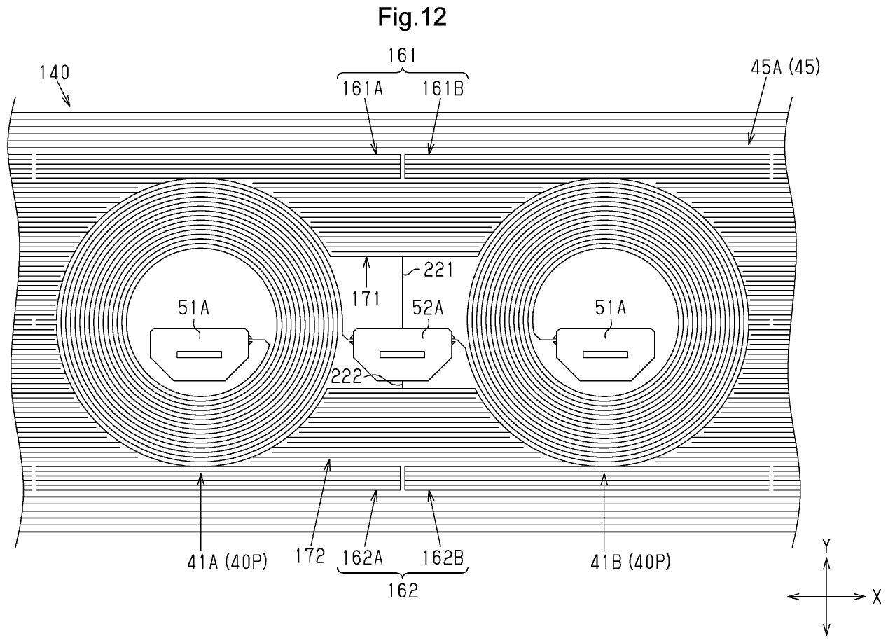

FIGS. 9 to 11 show planar structures schematically illustrating the first to eighth front coils 41A to 41H and the dummy wiring 45. FIGS. 12 to 17 show planar structures illustrating details of the first to eighth front coils 41A to 41H and the dummy wiring 45.

### Overall Configuration of Dummy Wiring

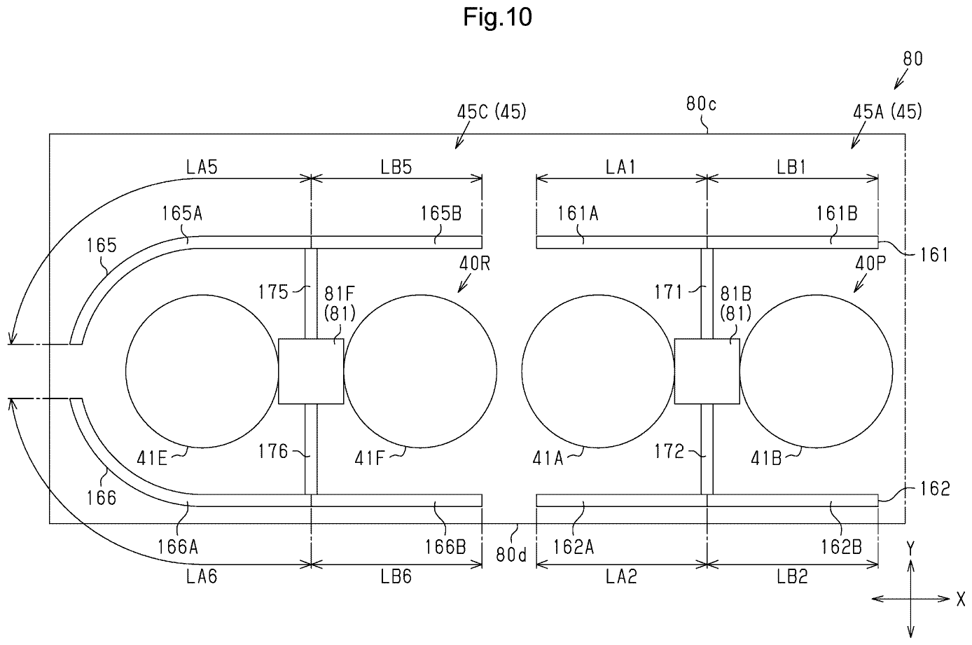

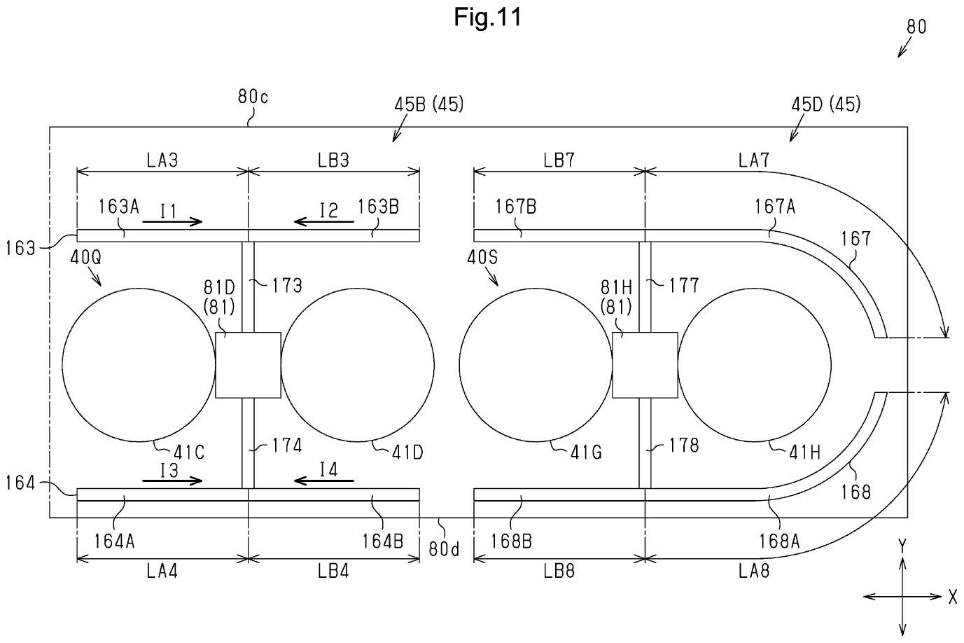

The overall configuration of the dummy wiring 45 will be described below with reference to FIGS. 9 to 11. FIG. 9 schematically illustrates the relationship between the first to fourth transformers 40A to 40D and the dummy wiring 45. FIG. 10 schematically illustrates the relationship of the first isolation transformer 40P, the third isolation transformer 40R, and the dummy wiring 45. FIG. 11 schematically illustrates the relationship of the second isolation transformer 40Q, the fourth isolation transformer 40S, and the dummy wiring 45. In FIG. 9, the dummy wiring 45 is illustrated as a single wiring line in order to facilitate understanding of the drawing.

As shown in FIG. 9, the dummy wiring 45 is provided for each pair of transformers 40A and 40B (first isolation transformers 40P and 40R) and each pair of transformers 40C and 40D (second isolation transformers 40Q and 40S). More specifically, the dummy wiring 45 includes first to fourth dummy wiring 45A to 45D. The first dummy wiring 45A is formed around the first front coil 41A and the second front coil 41B of the first isolation transformer 40P. The second dummy wiring 45B is arranged around the third front coil 41C and the fourth front coil 41D corresponding to the second isolation transformer 40Q. The third dummy wiring 45C is arranged around the fifth front coil 41E and the sixth front coil 41F corresponding to the third isolation transformer 40R. The fourth dummy wiring 45D is arranged around the seventh front coil 41G and the eighth front coil 41H corresponding to the fourth isolation transformer 40S. The first to fourth dummy wiring 45A to 45D are insulated from each other. The first to fourth dummy wiring 45A to 45D are arranged side by side in the X-direction. The first to fourth dummy wiring 45A to 45D are separated from each other. In the schematic diagram of the dummy wiring 45 shown in FIG. 9, the first to fourth dummy wiring 45A to 45D are spaced apart from each other in the X-direction. However, the actual first to fourth dummy wiring 45A to 45D are not entirely spaced apart from each other. As will be described later with reference to FIGS. 12 to 17, the first dummy wiring 45A and the second dummy wiring 45B partially overlap each other as viewed in the Y-direction. The first dummy wiring 45A and the third dummy wiring 45C partially overlap with each other as viewed in the Y-direction. The second dummy wiring 45B and the fourth dummy wiring 45D partially overlap with each other as viewed in the Y-direction.

In the present embodiment, the third dummy wiring 45C and the fourth dummy wiring 45D are arranged at two opposite ends of the transformer chip 80 in the X-direction and have the same configuration. The first dummy wiring 45A and the second dummy wiring 45B are arranged at a central part of the transformer chip 80 in the X-direction and have the same configuration.

The first dummy wiring 45A includes a portion symmetric with respect to an imaginary line VL1 that connects a center C1 of the first front coil 41A and a center C2 of the second front coil 41B. Further, the first dummy wiring 45A includes a portion symmetric with respect to an imaginary line VL5 that extends in the Y-direction through a midpoint between the center C1 of the first front coil 41A and the center C2 of the second front coil 41B in the X-direction.

The second dummy wiring 45B includes a portion symmetric with respect to an imaginary line VL2 that connects a center C3 of the third front coil 41C and a center C4 of the fourth front coil 41D. Further, the second dummy wiring 45B includes a portion symmetric with respect to an imaginary line VL6 that extends in the Y-direction through a midpoint between the center C3 of the third front coil 41C and the center C4 of the fourth front coil 41D in the X-direction.

The third dummy wiring 45C includes a portion symmetric with respect to an imaginary line VL3 that connects a center C5 of the fifth front coil 41E and a center C6 of the sixth front coil 41F. Further, the third dummy wiring 45C includes a portion symmetric with respect to an imaginary line VL7 that extends in the Y-direction through a midpoint between the center C5 of the fifth front coil 41E and the center C6 of the sixth front coil 41F in the X-direction. The third dummy wiring 45C also includes a portion that is not symmetric with respect to the imaginary line VL7.

The fourth dummy wiring 45D includes a portion symmetric with respect to an imaginary line VL4 that connects a center C7 of the seventh front coil 41G and a center C8 of the eighth front coil 41H. Further, the fourth dummy wiring 45D includes a portion symmetric with respect to an imaginary line VL8 that extends in the Y-direction through a midpoint between the center C7 of the seventh front coil 41G and the center C8 of the eighth front coil 41H in the X-direction. The fourth dummy wiring 45D also includes a portion that is not symmetric with respect to the imaginary line VL8.

As shown in FIG. 10, the first dummy wiring 45A includes a first wiring part 161, a second wiring part 162, a first pad connector 171, and a second pad connector 172.

The first wiring part 161 is located at a side of the first front coil 41A and the second front coil 41B in the Y-direction. The first wiring part 161 extends linearly in the X-direction. This side of the first front coil 41A and the second front coil 41B in the Y-direction refers to a side of the first front coil 41A and the second front coil 41B that is located relatively close to the chip side surface 80c.

The first wiring part 161 includes two first sub-wiring parts 161A and 161B that are aligned in the X-direction. Lengths LA1 and LB1 of the two first sub-wiring parts 161A and 161B are equal in the X-direction. In other words, the two first sub-wiring parts 161A and 161B are formed by dividing the first wiring part 161 at the central position in the X-direction.

The second wiring part 162 is located at another side of the first front coil 41A and the second front coil 41B in the Y-direction. The second wiring part 162 extends linearly in the X-direction. This side of the first front coil 41A and the second front coil 41B in the Y-direction refers to a side of the first front coil 41A and the second front coil 41B that is located relatively close to the chip side surface 80d.

The second wiring part 162 includes two second sub-wiring parts 162A and 162B that are aligned in the X-direction. Lengths LA2 and LB2 of the two second sub-wiring parts 162A and 162B are equal in the X-direction. In other words, the two second sub-wiring parts 162A and 162B are formed by dividing the second wiring part 162 at the central position in the X-direction. In an example, the lengths LA1 and LA2 of the two first sub-wiring parts 161A and 161B in the X-direction are equal to the lengths LA2 and LB2 of the two second sub-wiring parts 162A and 162B in the X-direction.

The first pad connector 171 electrically connects the two first sub-wiring parts 161A and 161B to the second pad 81B of the first electrode pad 81. The second pad connector 172 electrically connects the two second sub-wiring parts 162A and 162B to the second pad 81B of the first electrode pad 81. Thus, the first dummy wiring 45A is electrically connected to the second pad 81B. In other words, the first dummy wiring 45A is electrically connected to the first front coil 41A and the second front coil 41B. That is, the first dummy wiring 45A has the same potential as second ends of the first front coil 41A and the second front coil 41B (ground GND2).

As shown in FIG. 11, the second dummy wiring 45B includes a third wiring part 163, a fourth wiring part 164, a third pad connector 173, and a fourth pad connector 174.

The third wiring part 163 is located at a side of the third front coil 41C and the fourth front coil 41D in the Y-direction. The third wiring part 163 extends linearly in the X-direction. This side of the third front coil 41C and the fourth front coil 41D in the Y-direction refers to a side of the third front coil 41C and the fourth front coil 41D that is located relatively close to the chip side surface 80c.

The third wiring part 163 includes two third sub-wiring parts 163A and 163B that are aligned in the X-direction. Lengths LA3 and LB3 of the two third sub-wiring parts 163A and 163B are equal in the X-direction. In other words, the two third sub-wiring parts 163A and 163B are formed by dividing the third wiring part 163 at the central position in the X-direction.

The fourth wiring part 164 is located at another side of the third front coil 41C and the fourth front coil 41D in the Y-direction. The fourth wiring part 164 extends linearly in the X-direction. This side of the third front coil 41C and the fourth front coil 41D in the Y-direction refers to a side of the third front coil 41C and the fourth front coil 41D that is located relatively close to the chip side surface 80d.

The fourth wiring part 164 includes two fourth sub-wiring parts 164A and 164B that are aligned in the X-direction. Lengths LA4 and LB4 of the two fourth sub-wiring parts 164A and 164B are equal in the X-direction. That is, the two fourth sub-wiring part 164A and 164B are formed by dividing the fourth wiring part 164 at the central position in the X-direction. In an example, the lengths LA3 and LA3 of the two third sub-wiring parts 163A and 163B in the X-direction are equal to the lengths LA4 and LB4 of the two fourth sub-wiring parts 164A and 164B in the X-direction.

The third pad connector 173 electrically connects the two third sub-wiring parts 163A and 163B to the fourth pad 81D of the first electrode pad 81. The fourth pad connector 174 electrically connects the two fourth sub-wiring parts 164A and 164B to the fourth pad 81D of the first electrode pad 81. Thus, the second dummy wiring 45B is electrically connected to the fourth pad 81D. In other words, the second dummy wiring 45B is electrically connected to the third front coil 41C and the fourth front coil 41D. That is, the second dummy wiring 45B has the same potential as second ends of the third front coil 41C and the fourth front coil 41D (ground GND2).

As shown in FIG. 10, the third dummy wiring 45C includes a fifth wiring part 165, a sixth wiring part 166, a fifth pad connector 175, and a sixth pad connector 176.

The fifth wiring part 165 is located at a side of the fifth front coil 41E and the sixth front coil 41F in the Y-direction. The fifth wiring part 165 includes a straight section extending linearly in the X-direction, and a curved section surrounding part of the fifth front coil 41E in plan view. This side of the fifth front coil 41E and the sixth front coil 41F in the Y-direction refers to a side of the fifth front coil 41E and the sixth front coil 41F that is located relatively close to the chip side surface 80c.

The fifth wiring part 165 includes two fifth sub-wiring parts 165A and 165B that are aligned in the X-direction. The fifth sub-wiring part 165A includes the straight section extending linearly in the X-direction, and the curved section surrounding part of the fifth front coil 41E in plan view. The fifth sub-wiring part 165B extends linearly in the X-direction. Length LA5 of the fifth sub-wiring part 165A is greater than length LB5 of the fifth sub-wiring part 165B in the X-direction.

The sixth wiring part 166 is located at another side of the fifth front coil 41E and the sixth front coil 41F in the Y-direction. The sixth wiring part 166 includes a straight section extending linearly in the X-direction, and a curved section surrounding part of the fifth front coil 41E in plan view. As viewed in the Y-direction, this curved section is located at a position that overlaps the curved section of the fifth wiring part 165. This side of the fifth front coil 41E and the sixth front coil 41F in the Y-direction refers to a side of the fifth front coil 41E and the sixth front coil 41F that is located relatively close to the chip side surface 80d.

The sixth wiring part 166 includes two sixth sub-wiring parts 166A and 166B that are aligned in the X-direction. The sixth sub-wiring part 166A includes the straight section extending linearly in the X-direction, and the curved section surrounding part of the fifth front coil 41E in plan view. The sixth sub-wiring part 166B extends linearly in the X-direction. Length LA6 of the sixth sub-wiring part 166A is greater than length LB6 of the sixth sub-wiring part 166B in the X-direction. In an example, the length LB6 of the sixth sub-wiring part 166B is equal to the length LB5 of the fifth sub-wiring part 165B. In an example, the length LA6 of the sixth sub-wiring part 166A is equal to the length LA5 of the fifth sub-wiring part 165A.

The fifth pad connector 175 electrically connects the two fifth sub-wiring parts 165A and 165B to the sixth pad 81F of the first electrode pad 81. The sixth pad connector 176 electrically connects the two sixth sub-wiring parts 166A and 166B with the sixth pad 81F of the first electrode pad 81. Thus, the third dummy wiring 45C is electrically connected to the sixth pad 81F. In other words, the third dummy wiring 45C is electrically connected to the fifth front coil 41E and the sixth front coil 41F. That is, the third dummy wiring 45C has the same potential as second ends of the fifth front coil 41E and the sixth front coil 41F (ground GND2).

As shown in FIG. 11, the fourth dummy wiring 45D includes a seventh wiring part 167, an eighth wiring part 168, a seventh pad connector 177, and an eighth pad connector 178.

The seventh wiring part 167 is located at a side of the seventh front coil 41G and the eighth front coil 41H in the Y-direction. The seventh wiring part 167 includes a straight section extending linearly in the X-direction, and a curved section surrounding part of the eighth front coil 41H in plan view. This side of the seventh front coil 41G and the eighth front coil 41H in the Y-direction refers to a side of the seventh front coil 41G and the eighth front coil 41H that is located relatively close to the chip side surface 80c.

The seventh wiring part 167 includes two seventh sub-wiring parts 167A and 167B that are aligned in the X-direction. The seventh sub-wiring part 167A includes the straight section extending linearly in the X-direction, and the curved section surrounding part of the eighth front coil 41H in plan view. The seventh sub-wiring part 167B extends linearly in the X-direction. Length LA7 of the seventh sub-wiring part 167A is greater than length LB7 of the seventh sub-wiring part 167B in the X-direction.

The eighth wiring part 168 is located at another side of the seventh front coil 41G and the eighth front coil 41H in the Y-direction. The eighth wiring part 168 includes a straight section extending linearly in the X-direction, and a curved section surrounding part of the eighth front coil 41H in plan view. As viewed in the Y-direction, this curved section is located at a position that overlaps the curved section of the seventh wiring part 167. This side of the seventh front coil 41G and the eighth front coil 41H in the Y-direction refers to a side of the seventh front coil 41G and the eighth front coil 41H that is located relatively close to the chip side surface 80d.

The eighth wiring part 168 includes two eighth sub-wiring parts 168A and 168B that are aligned in the X-direction. The eighth sub-wiring part 168A includes the straight section extending linearly in the X-direction, and the curved section surrounding part of the eighth front coil 41H in plan view. The eighth sub-wiring part 168B extends linearly in the X-direction. Length LA8 of the eighth sub-wiring part 168A is greater than length LB8 of the eighth sub-wiring part 168B in the X-direction. In an example, the length LB8 of the eighth sub-wiring part 168B is equal to the length LB7 of the seventh sub-wiring part 167B. In an example, the length LA8 of the eighth sub-wiring part 168A is equal to the length LA7 of the seventh sub-wiring part 167A.

The seventh pad connector 177 electrically connects the two seventh sub-wiring parts 167A and 167B to the eighth pad 81H of the first electrode pad 81. The eighth pad connector 178 electrically connects the two eighth sub-wiring parts 168A and 168B to the eighth pad 81H of the first electrode pad 81. Thus, the fourth dummy wiring 45D is electrically connected to the eighth pad 81H. In other words, the fourth dummy wiring 45D is electrically connected to the seventh front coil 41G and the eighth front coil 41H. That is, the fourth dummy wiring 45D has the same potential as second ends of the seventh front coil 41G and the eighth front coil 41H (ground GND2).

### Detailed Configuration of Dummy Wiring

Detailed configurations of the first to fourth dummy wiring 45A to 45D will now be described with reference to FIGS. 12 to 17. The second dummy wiring 45B has the same configuration as the first dummy wiring 45A, and thus such a configuration will not be described in detail. The fourth dummy wiring 45D has the same configuration as the third dummy wiring 45C, and thus such a configuration will not be described in detail.

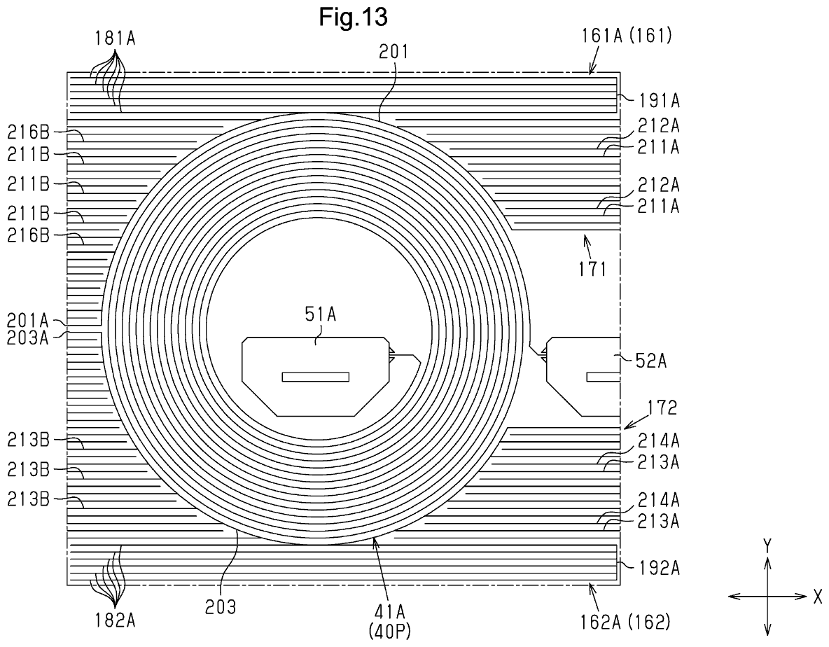

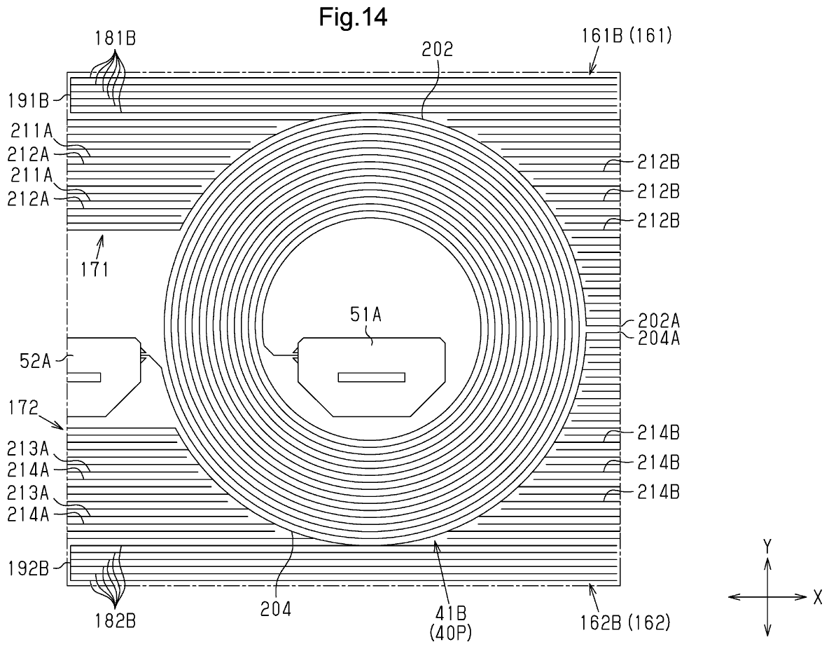

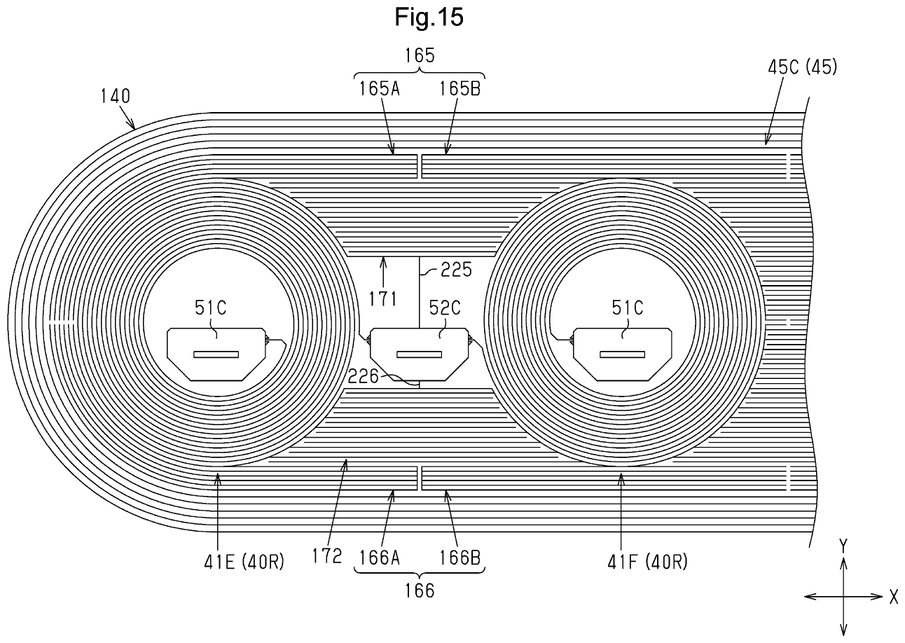

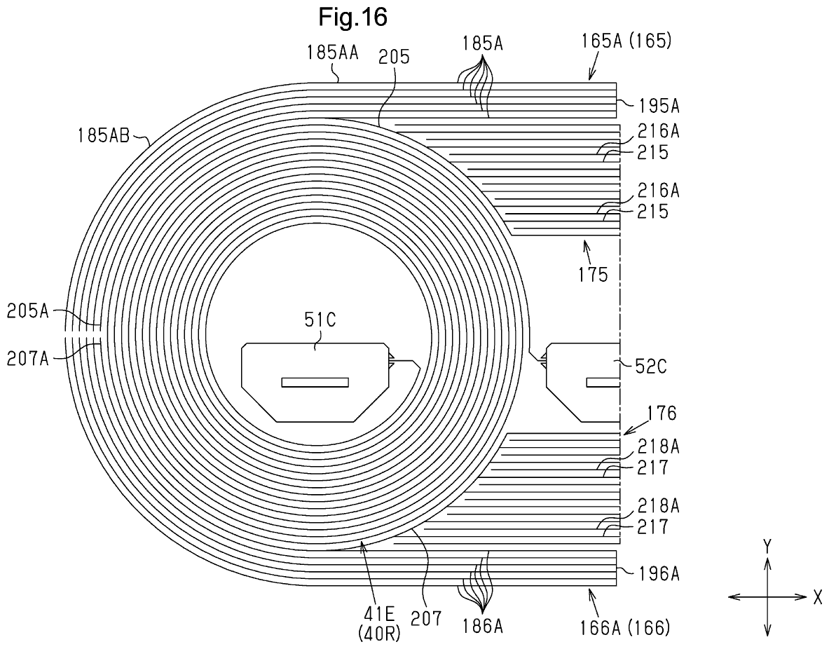

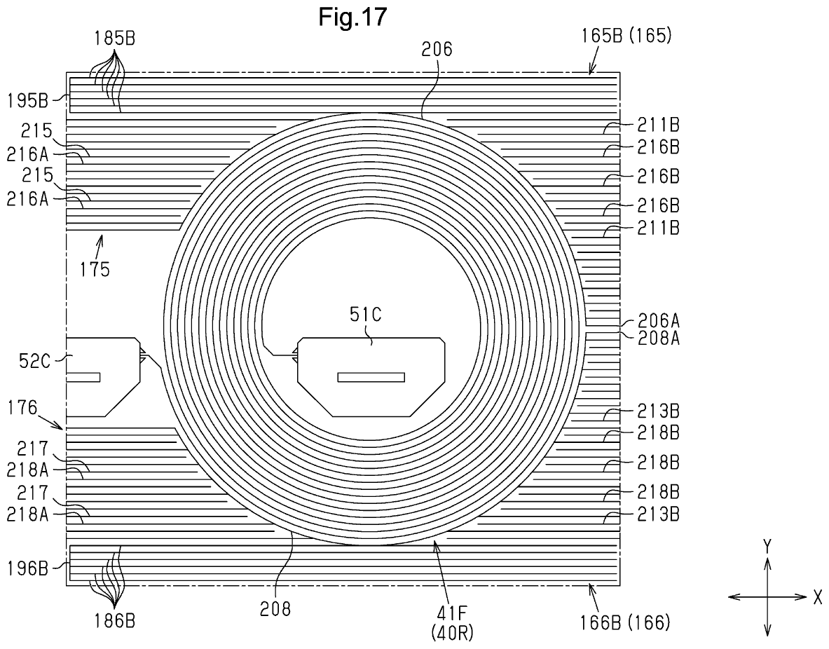

FIG. 12 shows a schematic planar structure enlarging the first isolation transformer 40P and the first dummy wiring 45A. FIG. 13 shows a schematic planar structure enlarging the first front coil 41A of the first isolation transformer 40P shown in FIG. 12. FIG. 14 shows a schematic planar structure enlarging the second front coil 41B of the first isolation transformer 40P shown in FIG. 12. FIG. 15 shows a schematic planar structure enlarging the third isolation transformer 40R and the third dummy wiring 45C. FIG. 16 shows a schematic planar structure enlarging the fifth front coil 41E of the third isolation transformer 40R shown in FIG. 15. FIG. 17 shows a schematic planar structure enlarging the sixth front coil 41F of the third isolation transformer 40R shown in FIG. 15.

### First Dummy Wiring

As shown in FIGS. 12 to 14, the first dummy wiring 45A is formed to surround the first front coil 41A and the second front coil 41B of the first isolation transformer 40P. However, the region between the first front coil 41A and the second front coil 41B in the X-direction includes a central part in the Y-direction where the first dummy wiring 45A is not formed.

The first wiring part 161 and the second wiring part 162 of the first dummy wiring 45A are located at two opposite sides of the first front coil 41A and the second front coil 41B in the Y-direction and are adjacent to the front coil 41A and 41B in the Y-direction.

The two first sub-wiring parts 161A and 161B of the first wiring part 161 are arranged adjacent to each other in the X-direction. As shown in FIGS. 13 and 14, the first sub-wiring part 161A includes first wiring layers 181A layered in the Y-direction, and a first wiring connection layer 191A connecting the first wiring layers 181A. The first sub-wiring part 161B includes first wiring layers 181B layered in the Y-direction, and a first wiring connection layer 191B connecting the first wiring layers 181B.

As shown in FIG. 13, each of the first wiring layers 181A of the first sub-wiring part 161A is located at a position that overlaps the first front coil 41A as viewed in the Y-direction. The first wiring layers 181A extend in the X-direction. The first wiring connection layer 191A of the first sub-wiring part 161A is arranged at one of two opposite ends of the first wiring layers 181A in the X-direction that is located relatively close to the first sub-wiring part 161B (refer to FIG. 14). The first wiring connection layer 191A extends in the Y-direction. Thus, the first wiring connection layer 191A connects the first wiring layers 181A in a central portion of the first wiring part 161 in the X-direction. In an example, another one of the two opposite ends of the first wiring layers 181A in the X-direction that is farther from the first sub-wiring part 161B is located at a side of the first front coil 41A opposite to the second front coil 41B in the X-direction. That is, the first sub-wiring part 161A is arranged to overlap the entire first front coil 41A as viewed in the Y-direction.

As shown in FIG. 14, each of the first wiring layers 181B of the first sub-wiring part 161B is located at a position that overlaps the second front coil 41B as viewed in the Y-direction. The first wiring layers 181B extend in the X-direction. The first wiring connection layer 191B of the first sub-wiring part 161B is arranged at one of two opposite ends of the first wiring layers 181B in the X-direction that is located relatively close to the first sub-wiring part 161A (refer to FIG. 13). The first wiring connection layer 191B extends in the Y-direction. Thus, the first wiring connection layer 191B connects the first wiring layers 181B in a central portion of the first wiring part 161 in the X-direction. In this manner, the two first wiring connection layers 191A and 191B are adjacent to each other in the X-direction. Accordingly, the two first sub-wiring parts 161A and 161B extend in opposite directions from the two first wiring connection layers 191A and 191B that are adjacent to each other in the X-direction. Specifically, the first wiring layers 181A of the first sub-wiring part 161A extend from the first wiring connection layer 191A in a direction extending away from the first sub-wiring part 161B. The first wiring layers 181B of the first sub-wiring part 161B extend from the first wiring connection layer 191B in a direction extending away from the first sub-wiring part 161A.

In an example, another one of the two opposite ends of the first wiring layer 181B in the X-direction that is farther from the first sub-wiring part 161A is located at a side of the second front coil 41B opposite to the first front coil 41A (refer to FIG. 13) in the X-direction. That is, the first sub-wiring part 161B is arranged to overlap the entire second front coil 41B as viewed in the Y-direction.

As shown in FIG. 12, two second sub-wiring parts 162A and 162B of the second wiring part 162 are arranged adjacent to each other in the X-direction. As shown in FIGS. 13 and 14, the second sub-wiring part 162A includes second wiring layers 182A layered in the Y-direction, and a second wiring connection layer 192A connecting the second wiring layers 182A. The second sub-wiring part 162B includes second wiring layers 182B layered in the Y-direction, and a second wiring connection layer 192B connecting the second wiring layers 182A. The second sub-wiring part 162A has the same configuration as the first sub-wiring part 161A, and the second sub-wiring part 162B has the same configuration as the first sub-wiring part 161B. Hence, the configurations of the second sub-wiring parts 162A and 162B will not be described in detail. The second wiring connection layer 192A connects the second wiring layers 182A in a central portion of the second wiring part 162 in the X-direction. The second wiring connection layer 192B connects the second wiring layers 182B in a central portion of the second wiring part 162 in the X-direction. The second wiring connection layers 192A and 192B are adjacent to each other in the X-direction. Accordingly, the two second sub-wiring parts 162A and 162B extend in opposite directions from the two second wiring connection layers 192A and 192B that are adjacent to each other in the X-direction.

The first pad connector 171 of the first wiring part 161 includes a first connection base 201, a second connection base 202, first straight portions 211A and 211B, and second straight portions 212A and 212B.

As shown in FIG. 13, the first connection base 201 extends to surround at least a portion of the first front coil 41A located toward the second pad 81B (first outer pad). In an example, the first connection base 201 is formed to surround a portion of the first front coil 41A located relatively close to the first wiring part 161 as viewed in plan view. In an example, the first connection base 201 extends to a side of the first front coil 41A opposite to the second pad 81B (first outer pad) in the X-direction.

The first connection base 201 is integrated with one of the first wiring layers 181A of the first sub-wiring part 161A that is located closest to the first coil 41. Therefore, the first wiring layers 181A are electrically connected to the first connection base 201.

As shown in FIG. 14, the second connection base 202 extends to surround at least a portion of the second front coil 41B located toward the second pad 81B (first outer pad). In an example, the second connection base 202 is formed to surround a portion of the second front coil 41B located relatively close to the first wiring part 161 in plan view. In an example, the second connection base 202 extends to a side of the second front coil 41B opposite to the second pad 81B (first outer pad) in the X-direction. In an example, the second connection base 202 and the first connection base 201 shown in FIG. 13 are symmetric with respect to the imaginary line VL5 (refer to FIG. 9).

The second connection base 202 is integrated with one of the first wiring layers 181B of the first sub-wiring part 161B that is located closest to the second front coil 41B. Therefore, the first wiring layers 181B are electrically connected to the second connection base 202. Also, an end of the second connection base 202 that is located closest to the second pad 81B (first outer pad) in the Y-direction is integrated with the first connection base 201. The integrated first connection base 201 and second connection base 202 are connected to the outer end wire 52A by a first interconnect 221 (refer to FIG. 12). The first interconnect 221 extends in the Y-direction.

As shown in FIG. 13, the first straight portions 211A are connected to the first connection base 201 and are arranged side by side in the Y-direction. Each of the first straight portions 211A extends linearly in the X-direction. Each of the first straight portions 211A extends from the first connection base 201 toward the second front coil 41B. Each of the first straight portions 211A extends to a position adjacent to the second connection base 202 in the X-direction.

The first straight portions 211B are connected to the first connection base 201 and are arranged side by side in the Y-direction. The first straight portions 211B are separated from the first straight portions 211A and are located at a side of the first straight portions 211A opposite to the second front coil 41B in the X-direction. The first straight portions 211B extend linearly in the X-direction. Each of the first straight portions 211B extends from the first connection base 201 in a direction opposite to the second front coil 41B.

As shown in FIG. 14, the second straight portions 212A are connected to the second connection base 202 and are arranged side by side in the Y-direction. Each of the second straight portions 212A extends linearly in the X-direction. Each of the second straight portions 212A extends from the second connection base 202 toward the first front coil 41A. Each of the second straight portions 212A extends to a position adjacent to the first connection base 201 in the X-direction. The first straight portions 211A and the second straight portions 212A are arranged to overlap each other as viewed in the Y-direction. The first straight portions 211A and the second straight portions 212A are alternately arranged in the Y-direction.

The second straight portions 212B are connected to the second connection base 202 and are arranged side by side in the Y-direction. The second straight portions 212B are separated from the second straight portions 212A and are located at a side of the second straight portions 212A opposite to the first front coil 41A in the X-direction. The second straight portions 212B extend linearly in the X-direction. Each of the second straight portions 212B extends from the second connection base 202 in a direction opposite to the second front coil 41B.

As shown in FIGS. 13 and 14, the second pad connector 172 of the second wiring part 162 includes a third connection base 203, a fourth connection base 204, third straight portions 213A and 213B, and fourth straight portions 214A and 214B.

As shown in FIG. 13, the third connection base 203 extends to surround at least a portion of the first front coil 41A located toward the second pad 81B (first outer pad). In an example, the third connection base 203 is formed to surround a portion of the first front coil 41A located relatively close to the second wiring part 162 in plan view. In an example, the third connection base 203 extends to a side of the first front coil 41A opposite to the second pad 81B (first outer pad) in the X-direction.

The third connection base 203 is integrated with one of the second wiring layers 182A of the second sub-wiring part 162A that is located closest to the first coil 41. Therefore, the second wiring layers 182A are electrically connected to the third connection base 203.

A distal end 203A of the third connection base 203 is located at a position adjacent to a distal end 201A of the first connection base 201 in the Y-direction. In other words, the distal end 201A of the first connection base 201 and the distal end 203A of the third connection base 203 are adjacent to each other in the Y-direction.

As shown in FIG. 14, the fourth connection base 204 extends to surround at least a portion of the second front coil 41B located toward the second pad 81B (first outer pad). In an example, the fourth connection base 204 is formed to surround a portion of the second front coil 41B located relatively close to the second wiring part 162 in plan view. In an example, the fourth connection base 204 extends to a side of the second front coil 41B opposite to the second pad 81B (first outer pad) in the X-direction. In an example, the fourth connection base 204 and the third connection base 203 shown in FIG. 13 are symmetric with respect to the imaginary line VL5 (refer to FIG. 9).

The fourth connection base 204 is integrated with one of the second wiring layers 182B of the second sub-wiring part 162B that is located closest to the second front coil 41B. Therefore, the second wiring layers 182B are electrically connected to the fourth connection base 204. Also, an end of the fourth connection base 204 that is located closest to the second pad 81B (first outer pad) in the Y-direction is integrated with the third connection base 203. The integrated third connection base 203 and fourth connection base 204 are connected to the first pad 81A by a second interconnect 222 (refer to FIG. 12). The second interconnect 222 extends in the Y-direction. The second interconnect 222 is shorter than the first interconnect 221 in the Y-direction.

A distal end 204A of the fourth connection base 204 is located at a position adjacent to a distal end 202A of the second connection base 202 in the Y-direction. In other words, the distal end 202A of the second connection base 202 and the distal end 204A of the fourth connection base 204 are adjacent to each other in the Y-direction.

As shown in FIG. 13, the third straight portions 213A are connected to the third connection base 203 and are arranged side by side in the Y-direction. Each of the third straight portions 213A extends linearly in the X-direction. Each of the third straight portions 213A extends from the third connection base 203 toward the second front coil 41B (refer to FIG. 14). Each of the third straight portions 213A extends to a position adjacent to the fourth connection base 204 in the X-direction.

The third straight portions 213B are connected to the third connection base 203 and are arranged side by side in the Y-direction. The third straight portions 213B are separated from the third straight portions 213A and are located at a side of the third straight portions 213A opposite to the second front coil 41B in the X-direction. The third straight portions 213B extend linearly in the X-direction. Each of the third straight portions 213B extends from the third connection base 203 in a direction opposite to the second front coil 41B. The third straight portions 213B and the first straight portions 211B are arranged to overlap each other as viewed in the Y-direction. The third straight portions 213B are located closer to the second sub-wiring part 162A than the first straight portions 211B are in the Y-direction.

As shown in FIG. 14, the fourth straight portions 214A are connected to the fourth connection base 204 and are arranged side by side in the Y-direction. Each of the fourth straight portions 214A extends linearly in the X-direction. Each of the fourth straight portions 214A extends from the fourth connection base 204 toward the first front coil 41A. Each of the fourth straight portions 214A extends to a position adjacent to the third connection base 203 in the X-direction. The third straight portions 213A and the fourth straight portions 214A are arranged to overlap each other as viewed in the Y-direction. The third straight portions 213A and the fourth straight portions 214A are alternately arranged in the Y-direction.

The fourth straight portions 214B are connected to the fourth connection base 204 and are arranged side by side in the Y-direction. The fourth straight portions 214B are separated from the third straight portions 213A and are located at a side of the third straight portions 213A opposite to the first front coil 41A in the X-direction. The fourth straight portions 214B extend linearly in the X-direction. Each of the fourth straight portions 214B extends from the fourth connection base 204 in a direction opposite to the first front coil 41A. The fourth straight portions 214B and the second straight portions 212B are arranged to overlap each other as viewed in the Y-direction. The fourth straight portions 214B are located closer to the second sub-wiring part 162B than the second straight portions 212B are in the Y-direction.

### Second Dummy Wiring

Since the second dummy wiring 45B has the same configuration as the first dummy wiring 45A, the two third sub-wiring parts 163A and 163B have the same configuration as the two first sub-wiring parts 161A and 161B. Therefore, although not shown in the drawings, the third sub-wiring parts 163A and 163B each include third wiring layers layered in the Y-direction, and a third wiring connection layer connecting the third wiring layers. The third wiring connection layer connects the third wiring layers in a central portion of the third wiring part 163 in the X-direction. The two third wiring connection layers are adjacent to each other in the X-direction. The two third sub-wiring parts 163A and 163B extend in opposite directions from the two third wiring connection layers that are adjacent to each other.

Further, the two fourth sub-wiring parts 164A and 164B have the same configuration as the two second sub-wiring parts 162A and 162B. Therefore, although not shown in the drawings, the fourth sub-wiring parts 164A and 164B each include fourth wiring layers layered in the Y-direction, and a fourth wiring connection layer connecting the fourth wiring layers. The fourth wiring connection layer connects the fourth wiring layers in a central portion of the fourth wiring part 164 in the X-direction. The two fourth wiring connection layers are adjacent to each other in the X-direction. The two fourth sub-wiring parts 164A and 164B extend in opposite directions from the two fourth wiring connection layers that are adjacent to each other.

Furthermore, the third pad connector 173 have the same configuration as the first pad connector 171. Therefore, although not shown in the drawings, the third pad connector 173 includes a ninth connection base extending to surround at least a side of the third front coil 41C located relatively close to the fourth pad 81D, and a tenth connection base extending to surround at least a side of the fourth front coil 41D located relatively close to the fourth pad 81D. The ninth connection base is formed to surround a portion of the third front coil 41C located relatively close to the third wiring part 163 in plan view. The tenth connection base is formed to surround a portion of the fourth front coil 41D located relatively close to the third wiring part 163 in plan view.

The third pad connector 173 includes ninth straight portions connected to the ninth connection base, and tenth straight portions connected to the tenth connection base. The ninth straight portions are arranged side by side in the Y-direction. Each of the ninth straight portions extends linearly in the X-direction. The tenth straight portions are arranged side by side in the Y-direction. Each of the tenth straight portions extends linearly in the X-direction. The ninth straight portions and the tenth straight portions are alternately arranged in the Y-direction.

The fourth pad connector 174 has the same configuration as the second pad connector 172. Therefore, although not shown in the drawings, the fourth pad connector 174 includes an eleventh connection base extending to surround at least a side of the third front coil 41C located relatively close to the fourth pad 81D, and a twelfth connection base extending to surround at least a side of the fourth front coil 41D located relatively close to the fourth pad 81D. The eleventh connection base is formed to surround a portion of the third front coil 41C located relatively close to the fourth wiring part 164 in plan view. The twelfth connection base is formed to surround a portion of the fourth front coil 41D located relatively close to the fourth wiring part 164 in plan view. A distal end of the ninth connection base and a distal end of the eleventh connection base are adjacent to each other in the Y-direction. A distal end of the tenth connection base and a distal end of the twelfth connection base are adjacent to each other in the Y-direction.

The fourth pad connector 174 includes eleventh straight portions connected to the eleventh connection base, and twelfth straight portions connected to the twelfth connection base. The eleventh straight portions are arranged side by side in the Y-direction. Each of the eleventh straight portions extends linearly in the X-direction. The twelfth straight portions are arranged side by side in the Y-direction. Each of the twelfth straight portions extends linearly in the X-direction. The eleventh straight portions and the twelfth straight portions are alternately arranged in the Y-direction.

### Third Dummy Wiring

As shown in FIG. 15, the third dummy wiring 45C is formed to surround the fifth front coil 41E and the sixth front coil 41F. However, the region between the fifth front coil 41E and the sixth front coil 41F in the X-direction includes a central part in the Y-direction where the third dummy wiring 45C is not formed.

The fifth wiring part 165 and the sixth wiring part 166 of the third dummy wiring 45C are located at two opposite sides of the fifth front coil 41E and the sixth front coil 41F and are adjacent to the fifth front coil 41E and the sixth front coil 41F in the Y-direction.

The two fifth sub-wiring parts 165A and 165B of the fifth wiring part 165 are arranged adjacent to each other in the X-direction. As shown in FIGS. 16 and 17, the fifth sub-wiring part 165A includes fifth wiring layers 185A layered in the Y-direction, and a fifth wiring connection layer 195A connecting the fifth wiring layers 185A. The fifth sub-wiring part 165B includes fifth wiring layers 185B layered in the Y-direction, and a fifth wiring connection layer 195B connecting the fifth wiring layers 185B.

As shown in FIG. 16, each of the fifth wiring layers 185A of the fifth sub-wiring part 165A is located at a position that overlaps the fifth front coil 41E as viewed in the Y-direction. The fifth wiring layers 185A each include a straight segment 185AA extending linearly in the X-direction, and a curved segment 185AB surrounding the first coil 41 in plan view. In the present embodiment, the straight segment 185AA is integrated with the curved segment 185AB. The fifth wiring connection layer 195A of the fifth sub-wiring part 165A is arranged at one of two opposite ends of the straight segments 185AA of the fifth wiring layers 185A in the X-direction that is located relatively close to the fifth sub-wiring part 165B (refer to FIG. 17). The fifth wiring connection layer 195A extends in the Y-direction. In an example, one of two opposite ends of the curved segments 185AB of the fifth wiring layers 185A that is farther from the straight segments 185AA is located at a side of the fifth front coil 41E opposite to the outer end wire 52C in the X-direction. That is, the fifth sub-wiring part 165A is arranged to overlap the entire fifth front coil 41E as viewed in the Y-direction.

As shown in FIG. 17, each of the fifth wiring layers 185B of the fifth sub-wiring part 165B is located at a position that overlaps the sixth front coil 41F as viewed in the Y-direction. Each of the fifth wiring layers 185B extends in the X-direction. The fifth wiring connection layer 195B of the fifth sub-wiring part 165B is arranged at one of two opposite ends of the fifth wiring layers 185B in the X-direction that is located relatively close to the fifth sub-wiring part 165A (refer to FIG. 16). The fifth wiring connection layer 195B extends in the Y-direction. The two fifth wiring connection layers 195A and 195B are adjacent to each other in the X-direction. Accordingly, the two fifth sub-wiring parts 165A and 165B extend in opposite directions from the two fifth wiring connection layers 195A and 195B that are adjacent to each other in the X-direction. Specifically, the fifth wiring layers 185A of the fifth sub-wiring part 165A extend from the fifth wiring connection layer 195A in a direction extending away from the fifth sub-wiring part 165B. The fifth wiring layers 185B of the fifth sub-wiring part 165B extend from the fifth wiring connection layer 195B in a direction extending away from the fifth sub-wiring part 165A.

In an example, another one of the two opposite ends of the fifth wiring layers 185B in the X-direction that is farther from the fifth sub-wiring part 165A is located at a side of the sixth front coil 41F opposite to the outer end wire 52C in the X-direction. That is, the fifth sub-wiring part 165B is arranged to overlap the entire sixth front coil 41F as viewed in the Y-direction.

As shown in FIG. 15, the two sixth sub-wiring parts 166A and 166B of the sixth wiring part 166 are arranged adjacent to each other in the X-direction. As shown in FIGS. 16 and 17, the sixth sub-wiring part 166A includes sixth wiring layers 186A layered in the Y-direction, and a sixth wiring connection layer 196A connecting the sixth wiring layers 186A. The sixth sub-wiring part 166B includes sixth wiring layers 186B layered in the Y-direction, and a sixth wiring connection layer 196B connecting the sixth wiring layers 186A. The sixth sub-wiring part 166A has the same configuration as the fifth sub-wiring part 165A, and the sixth sub-wiring part 166B has the same configuration as the fifth sub-wiring part 165B. Hence, the configurations of the sixth sub-wiring parts 166A and 166B will not be described in detail. The sixth wiring connection layers 196A and 196B are adjacent to each other in the X-direction. Accordingly, the two sixth sub-wiring parts 166A and 166B extend in opposite directions from the two sixth wiring connection layers 196A and 196B that are adjacent to each other in the X-direction. Further, as shown in FIG. 16, a distal end of the fifth wiring layer 185A is located at a position adjacent to a distal end of the sixth wiring layer 186A in the Y-direction.

As shown in FIGS. 16 and 17, the fifth pad connector 175 of the fifth wiring part 165 includes a fifth connection base 205, a sixth connection base 206, fifth straight portions 215, and sixth straight portions 216A and 216B.

As shown in FIG. 16, the fifth connection base 205 extends to surround at least a side of the fifth front coil 41E located relatively close to the sixth pad 81F (outer end wire 52C). In an example, the fifth connection base 205 is formed to surround a portion of the fifth front coil 41E located relatively close to the fifth wiring part 165 in plan view.

The fifth connection base 205 is integrated with one of the fifth wiring layers 185A of the fifth sub-wiring part 165A that is located closest to the fifth front coil 41E. Therefore, the fifth wiring layers 185A are electrically connected to the fifth connection base 205.

As shown in FIG. 17, the sixth connection base 206 extends to surround at least a side of the sixth front coil 41F located relatively close to the sixth pad 81F (outer end wire 52C). In an example, the sixth connection base 206 is formed to surround a portion of the sixth front coil 41F located relatively close to the sixth wiring part 166 in plan view. In an example, the sixth connection base 206 and the fifth connection base 205 shown in FIG. 16 are symmetric with respect to the imaginary line VL7 (refer to FIG. 9).

The sixth connection base 206 is integrated with one of the fifth wiring layers 185B of the fifth sub-wiring part 165B that is located closest to the sixth front coil 41F. Therefore, the fifth wiring layers 185B are electrically connected to the sixth connection base 206. Also, an end of the sixth connection base 206 that is located closest to the sixth pad 81F in the Y-direction is integrated with the fifth connection base 205. The integrated fifth connection base 205 and sixth connection base 206 are connected to the sixth pad 81F (outer end wire 52C) by a fifth interconnect 225 (refer to FIG. 15). The fifth interconnect 225 extends in the Y-direction.

As shown in FIG. 16, the fifth straight portions 215 are connected to the fifth connection base 205 and are arranged side by side in the Y-direction. Each of the fifth straight portions 215 extends linearly in the X-direction. Each of the fifth straight portions 215 extends from the fifth connection base 205 toward the sixth front coil 41F (refer to FIG. 17). Each of the fifth straight portion 215 extends to a position adjacent to the second connection base 202 shown in FIG. 17 in the X-direction.

The sixth straight portions 216A are connected to the sixth connection base 206 and are arranged side by side in the Y-direction. Each of the sixth straight portions 216A extends linearly in the X-direction. Each of the sixth straight portions 216A extends from the sixth connection base 206 toward the fifth front coil 41E. Each of the sixth straight portions 216A extends to a position adjacent to the fifth connection base 205 in the X-direction. The fifth straight portions 215 and the sixth straight portions 216A are arranged to overlap each other as viewed in the Y-direction. The fifth straight portions 215 and the sixth straight portions 216A are alternately arranged in the Y-direction.

As shown in FIG. 17, the sixth straight portions 216B are connected to the sixth connection base 206 and are arranged side by side in the Y-direction. The sixth straight portions 216B are separated from the sixth straight portions 216A and are located at a side of the sixth straight portions 216A opposite to the fifth front coil 41E (refer to FIG. 16) in the X-direction. The sixth straight portions 216B extend linearly in the X-direction. Each of the sixth straight portions 216B extends from the sixth connection base 206 in a direction opposite to the fifth front coil 41E. The sixth straight portions 216B and the first straight portions 211B are arranged to overlap each other as viewed in the Y-direction. The sixth straight portions 216B and the first straight portions 211B are alternately arranged in the Y-direction.

As shown in FIGS. 16 and 17, the sixth pad connector 176 of the sixth wiring part 166 includes a seventh connection base 207, an eighth connection base 208, seventh straight portions 217, and eighth straight portions 218A and 218B.

As shown in FIG. 16, the seventh connection base 207 extends to surround at least a side of the fifth front coil 41E located relatively close to the sixth pad 81F (outer end wire 52C). In an example, the seventh connection base 207 is formed to surround a portion of the fifth front coil 41E located relatively close to the sixth wiring part 166 in plan view. In an example, the seventh connection base 207 extends to a side of the fifth front coil 41E opposite to the sixth pad 81F in the X-direction.

The seventh connection base 207 is integrated with one of the sixth wiring layers 186A of the sixth sub-wiring part 166A that is located closest to the fifth front coil 41E. Therefore, the sixth wiring layers 186A are electrically connected to the seventh connection base 207.

A distal end 207A of the seventh connection base 207 is located at a position adjacent to a distal end 205A of the fifth connection base 205 in the Y-direction. In other words, the distal end 207A of the seventh connection base 207 and the distal end 205A of the fifth connection base 205 are adjacent to each other in the Y-direction.

As shown in FIG. 17, the eighth connection base 208 extends to surround at least a side of the sixth front coil 41F located relatively close to the sixth pad 81F (outer end wire 52C). In an example, the eighth connection base 208 is formed to surround a portion of the sixth front coil 41F located relatively close to the sixth wiring part 166 in plan view. In an example, the eighth connection base 208 extends to a side of the sixth front coil 41F opposite to the sixth pad 81F in the X-direction. In an example, the eighth connection base 208 and the seventh connection base 207 shown in FIG. 16 are symmetric with respect to the imaginary line VL7 (refer to FIG. 9).

The eighth connection base 208 is integrated with one of the sixth wiring layers 186B of the sixth sub-wiring part 166B that is located closest to the sixth front coil 41F. Therefore, the sixth wiring layers 186B are electrically connected to the eighth connection base 208. Also, an end of the eighth connection base 208 that is located closest to the sixth pad 81F in the Y-direction is integrated with the seventh connection base 207. The integrated seventh connection base 207 and eighth connection base 208 are connected to the sixth pad 81F (outer end wire 52C) by a sixth interconnect 226 (refer to FIG. 15). The sixth interconnect 226 extends in the Y-direction. The sixth interconnect 226 is shorter than the fifth interconnect 225 in the Y-direction.

A distal end 208A of the eighth connection base 208 is located at a position adjacent to a distal end 206A of the sixth connection base 206 in the Y-direction. In other words, the distal end 206A of the sixth connection base 206 and the distal end 208A of the eighth connection base 208 are adjacent to each other in the Y-direction.

As shown in FIG. 16, the seventh straight portions 217 are connected to the seventh connection base 207 and are arranged side by side in the Y-direction. Each of the seventh straight portions 217 extends linearly in the X-direction. Each of the seventh straight portions 217 extends from the seventh connection base 207 toward the sixth front coil 41F. Each of the seventh straight portions 217 extends to a position adjacent to the eighth connection base 208 in the X-direction.

As shown in FIG. 17, the eighth straight portions 218A are connected to the eighth connection base 208 and are arranged side by side in the Y-direction. Each of the eighth straight portions 218A extends linearly in the X-direction. Each of the eighth straight portions 218A extends from the eighth connection base 208 toward the fifth front coil 41E. Each of the eighth straight portions 218A extends to a position adjacent to the seventh connection base 207 (refer to FIG. 16) in the X-direction. The seventh straight portions 217 and the eighth straight portions 218A are arranged to overlap with each other as viewed in the Y-direction. The seventh straight portions 217 and the eighth straight portions 218A are alternately arranged in the Y-direction.

The eighth straight portions 218B are connected to the eighth connection base 208 and are arranged side by side in the Y-direction. The eighth straight portions 218B are separated from the seventh straight portions 217 and are located at a side of the seventh straight portions 217 opposite to the sixth pad 81F (outer end wire 52C) in the X-direction. The eighth straight portions 218B extend linearly in the X-direction. Each of the eighth straight portions 218B extends from the eighth connection base 208 in a direction opposite to the sixth pad 81F. The eighth straight portions 218B and the sixth straight portions 216B are arranged to overlap each other as viewed in the Y-direction. The eighth straight portions 218B are located closer to the sixth sub-wiring part 166B than the sixth straight portions 216B are in the Y-direction. The eighth straight portions 218B and the third straight portions 213B are arranged to overlap each other as viewed in the Y-direction. The eighth straight portions 218B and the third straight portions 213B are alternately arranged in the Y-direction.

### Fourth Dummy Wiring

Since the fourth dummy wiring 45D has the same configuration as the third dummy wiring 45C, the two seventh sub-wiring parts 167A and 167B have the same configuration as the two fifth sub-wiring parts 165A and 165B. Therefore, although not shown in the drawings, the seventh sub-wiring parts 167A and 167B each include seventh wiring layers layered in the Y-direction, and a seventh wiring connection layer connecting the seventh wiring layers. The two seventh wiring connection layers are adjacent to each other in the X-direction. The two seventh sub-wiring parts 167A and 167B extend in opposite directions from the two seventh wiring connection layers that are adjacent to each other.

Further, the two eighth sub-wiring parts 168A and 168B have the same configuration as the two sixth sub-wiring parts 166A and 166B. Therefore, although not shown in the drawings, the eighth sub-wiring parts 168A and 168B each include eighth wiring layers layered in the Y-direction, and an eighth wiring connection layer connecting the eighth wiring layers. The two eighth wiring connection layers are adjacent to each other in the X-direction. The two eighth sub-wiring parts 168A and 168B extend in opposite directions from the two eighth wiring connection layers that are adjacent to each other.

Furthermore, the seventh pad connector 177 has the same configuration as the fifth pad connector 175. Therefore, although not shown in the drawings, the seventh pad connector 177 includes a thirteenth connection base extending to surround at least a side of the seventh front coil 41G located relatively close to the eighth pad 81H, and a fourteenth connection base extending to surround at least a side of the eighth front coil 41H located relatively close to the eighth pad 81H. The thirteenth connection base is formed to surround a portion of the seventh front coil 41G located relatively close to the seventh wiring part 167 in plan view. The fourteenth connection base is formed to surround a portion of the seventh front coil 41G located relatively close to the seventh wiring part 167 in plan view.

The seventh pad connector 177 includes thirteenth straight portions connected to the thirteenth connection base, and fourteenth straight portions connected to the fourteenth connection base. The thirteenth straight portions are arranged side by side in the Y-direction. Each of the thirteenth straight portions extends linearly in the X-direction. The fourteenth straight portions are arranged side by side in the Y-direction. Each of the fourteenth straight portions extends linearly in the X-direction. The thirteenth straight portions and the fourteenth straight portions are alternately arranged in the Y-direction.

The eighth pad connector 178 has the same configuration as the sixth pad connector 176. Therefore, although not shown in the drawings, the eighth pad connector 178 includes a fifteenth connection base extending to surround at least a side of the seventh front coil 41G located relatively close to the eighth pad 81H, and a sixteenth connection base extending to surround at least a side of the eighth front coil 41H located relatively close to the eighth pad 81H. The fifteenth connection base is formed to surround a portion of the seventh front coil 41G located relatively close to the eighth wiring part 168 in plan view. The sixteenth connection base is formed to surround a portion of the eighth front coil 41H located relatively close to the eighth wiring part 168 in plan view. A distal end of the thirteenth connection base and a distal end of the fifteenth connection base are adjacent to each other in the Y-direction. A distal end of the fourteenth connection base and a distal end of the sixteenth connection base are adjacent to each other in the Y-direction.

The eighth pad connector 178 includes fifteenth straight portions connected to the fifteenth connection base, and sixteenth straight portions connected to the sixteenth connection base. The fifteenth straight portions are arranged side by side in the Y-direction. Each of the fifteenth straight portions extends linearly in the X-direction. The sixteenth straight portions are arranged side by side in the Y-direction. Each of the sixteenth straight portions extends linearly in the X-direction. The fifteenth straight portions and the sixteenth straight portions are alternately arranged in the Y-direction.

### Operation

The operation of the transformer chip 80 in accordance with the present embodiment will now be described.

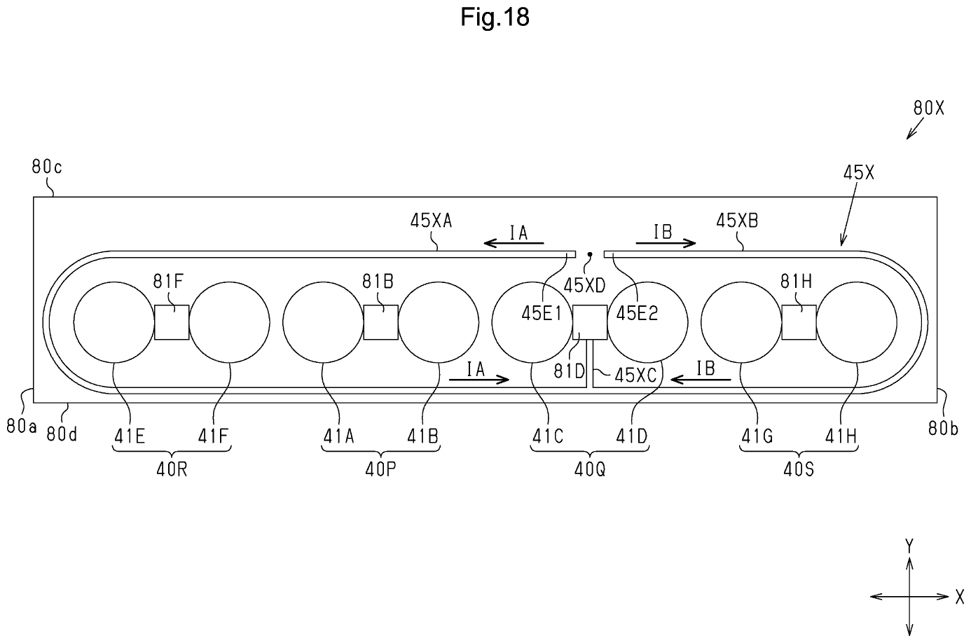

FIG. 18 shows a schematic planar structure of a transformer chip 80X of a comparative example. As shown in FIG. 18, the transformer chip 80X of the comparative example includes dummy wiring 45X. The dummy wiring 45X surrounds the first to eighth front coils 41A to 41H in plan view, so as to restrict the electric field from reaching the first to eighth front coils 41A to 41H. The dummy wiring 45X has a shape of an open loop in plan view. The dummy wiring 45X is connected to, for example, the fourth pad 81D. More specifically, the dummy wiring 45X includes a first wiring part 45XA, a second wiring part 45XB, and a pad connector 45XC. The first wiring part 45XA extends from an opening 45XD and surrounds the first to third front coils 41A to 41C, the fifth front coil 41E, and the sixth front coil 41F. The second wiring part 45XB extends from the opening 45XD and surrounds the fourth front coil 41D, the seventh front coil 41G, and the eighth front coil 41H. The first wiring part 45XA and the second wiring part 45XB are both connected to the pad connector 45XC. The pad connector 45XC is connected to the fourth pad 81D. Thus, the dummy wiring 45X has the same potential as the fourth pad 81D. The pads 81B, 81D, 81F, and 81H are electrically connected to the second circuit chip 70 shown in FIG. 1 and have the same potential (ground GND2). In this manner, when the dummy wiring 45X has the same potential as the first to eighth front coils 41A to 41H, the electric field will not concentrate in the first to eighth front coils 41A to 41H.

In the dummy wiring 45X having such a configuration as described above, in plan view, the length of the first wiring part 45XA in a direction in which the first wiring part 45XA extends is greater than the length of the second wiring part 45XB in a direction in which the second wiring part 45XB extends.

In the transformer chip 80X of the comparative example, when noise is introduced to a distal part 45E1 of the first wiring part 45XA and a distal part 45E2 of the second wiring part 45XB, first current IA resulting from the noise flows through the first wiring part 45XA and the pad connector 45XC into the fourth pad 81D, and second current IB resulting from the noise flows through the second wiring part 45XB and the pad connector 45XC into the fourth pad 81D. As shown in FIG. 18, a direction in which the first current IA flows in the vicinity of the distal part 45E1 of the first wiring part 45XA is opposite to a direction in which the first current IA flows in the vicinity of the pad connector 45XC of the first wiring part 45XA. Accordingly, the magnetic field produced by the first current IA is strengthened, for example, in the third front coil 41C. Further, a direction in which the second current IB flows in the vicinity of the distal part 45E2 of the second wiring part 45XB is opposite to a direction in which the second current IB flows in the vicinity of the pad connector 45XC of the second wiring part 45XB. Accordingly, the magnetic field produced by the second current IB is strengthened, for example, in the fourth front coil 41D. As a result, the currents caused by these magnetic fields may flow into the third front coil 41C and the fourth front coil 41D, such that noise may be contained in a pulse signal transmitted to the third front coil 41C and the fourth front coil 41D.

The third front coil 41C and the fourth front coil 41D are wound in opposite directions, so that even when currents resulting from noise flow into the third front coil 41C and the fourth front coil 41D, the magnetic fields produced by these currents would cancel each other. Nonetheless, the length of the first wiring part 45XA in the direction in which the first wiring part 45XA extends is greater than the length of the second wiring part 45XB in the direction in which the second wiring part 45XB extends in plan view, such that the magnitude of the currents flowing through the third front coil 41C and the fourth front coil 41D may vary. When there is a difference in strength of the magnetic field between the third front coil 41C and the fourth front coil 41D, the cancellation of the magnetic fields may be limited.

In this respect, as shown in FIGS. 9 to 11, in the transformer chip 80 of the present embodiment, the dummy wiring 45 includes the first to fourth dummy wiring 45A to 45D that are insulated from each other. The first to fourth dummy wiring 45A to 45D are respectively provided for the first to fourth isolation transformers 40P, 40Q, 40R, and 40S. In an example, as shown in FIG. 11, when noise is introduced to two opposite ends of the third wiring part 163 of the dummy wiring 45B in the X-direction and two opposite ends of the fourth wiring part 164 in the X-direction, first current I1 flows through the third sub-wiring part 163A in a direction opposite to a direction in which third current I3 flows through the fourth sub-wiring part 164A of the fourth wiring part 164, and second current I2 flows through the third sub-wiring part 163B in a direction opposite to a direction in which fourth current I4 flows through the fourth sub-wiring part 164B of the fourth wiring part 164. Thus, the magnetic fields produced by the first current I1 and the third current I3 cancel each other in the third front coil 41C, and the magnetic fields produced by the second current I2 and the fourth current I4 cancel each other in the fourth front coil 41D.

In addition, the length LA3 of the third sub-wiring part 163A is equal to the length LA4 of the fourth sub-wiring part 164A, and the length LB3 of the third sub-wiring part 163B is equal to the length LB4 of the fourth sub-wiring part 164B. This may reduce a variation in the magnitude between the current flowing through the third front coil 41C and the current flowing through the fourth front coil 41D. When there is a relatively small variation in the strength of the magnetic field between the third front coil 41C and the fourth front coil 41D, the cancellation of the magnetic fields may be facilitated.

### Advantages

The present embodiment has the following advantages.

(1) The transformer chip 80 includes the insulating layer 84, the first isolation transformer 40P, the second isolation transformer 40Q, the second pad 81B, the fourth pad 81D, the first dummy wiring 45A, and the second dummy wiring 45B. The insulating layer 84 includes the upper surface 84s and the lower surface 84r facing away from each other in the Z-direction. The first isolation transformer 40P includes the first front coil 41A, the second front coil 41B, the first back coil 42A and the second back coil 42B. The first front coil 41A and the second front coil 41B are located relatively close to the upper surface 84s in the insulating layer 84 and are spaced apart from each other in the X-direction. The first back coil 42A and the second back coil 42B are located relatively close to the lower surface 84r in the insulating layer 84 and are spaced apart from each other in the X-direction. The first back coil 42A and the second back coil 42B face the first front coil 41A and the second front coil 41B. The second isolation transformer 40Q includes the third front coil 41C, the fourth front coil 41D, the third back coil 42C, and the fourth back coil 42D. The third front coil 41C and the fourth front coil 41D are located relatively close to the upper surface 84s in the insulating layer 84 and are spaced apart from each other in the X-direction. The third back coil 42C and the fourth back coil 42D are located relatively close to the lower surface 84r in the insulating layer 84 and are spaced apart from each other in the X-direction. The third back coil 42C and the fourth back coil 42D face the third front coil 41C and the fourth front coil 41D. The second isolation transformer 40Q is spaced apart from the first isolation transformer 40P in the X-direction. The second pad 81B is disposed between the first front coil 41A and the second front coil 41B in the X-direction in plan view. The second pad 81B is electrically connected to both the first front coil 41A and the second front coil 41B. The fourth pad 81D is disposed between the third front coil 41C and the fourth front coil 41D in the X-direction in plan view. The fourth pad 81D is electrically connected to both the third front coil 41C and the fourth front coil 41D. The first dummy wiring 45A is arranged at opposite sides of the first isolation transformer 40P in the Y-direction in plan view. The first dummy wiring 45A is electrically connected to the second pad 82B. The second dummy wiring 45B is arranged at opposite sides of the second isolation transformer 40Q in the Y-direction. The second dummy wiring 45B is electrically connected to the fourth pad 81D and is electrically insulated from the first dummy wiring 45A. The first dummy wiring 45A and the second dummy wiring 45B are aligned in the X-direction.

With this configuration, even when noise is introduced to the first dummy wiring 45A and the second dummy wiring 45B, the coil pairs in the first to fourth front coils 41A to 41D have a relatively small variation in the intensity of the magnetic field, thereby facilitating cancellation of the magnetic fields between the paired coils. This reduces noise generated in a pulse signal transmitted to the first to fourth front coil 41A to 41D. As a result, the transformer chip 80 and the signal transmission device 10 have superior signal transmission characteristics.

(2) The first dummy wiring 45A includes a portion symmetric with respect to the imaginary line VL1 that connects the center C1 of the first front coil 41A and the center C2 of the second front coil 41B. The second dummy wiring 45B includes a portion symmetric with respect to the imaginary line VL2 that connects the center C3 of the third front coil 41C and the center C4 of the fourth front coil 41D.

With this configuration, when noise is introduced to the first dummy wiring 45A, magnetic fields generated by currents flowing through the portions of the first dummy wiring 45A located at opposite sides of the first front coil 41A and the second front coil 41B in the Y-direction effectively cancel each other at the first front coil 41A and the second front coil 41B. When noise is introduced to the second dummy wiring 45B, magnetic fields generated by currents flowing through the portions of the second dummy wiring 45B located at opposite sides of the third front coil 41C and the fourth front coil 41D in the Y-direction effectively cancel each other at the third front coil 41C and the fourth front coil 41D.

(3) The first dummy wiring 45A includes the first wiring part 161 and the second wiring part 162. The first wiring part 161 is located at a side of the first front coil 41A and the second front coil 41B in the Y-direction. The first wiring part 161 extends linearly in the X-direction. The second wiring part 162 is located at another side of the first front coil 41A and the second front coil 41B in the Y-direction. The second wiring part 162 extends linearly in the X-direction. The second dummy wiring 45B includes the third wiring part 163 and the fourth wiring part 164. The third wiring part 163 is located at a side of the third front coil 41C and the fourth front coil 41D in the Y-direction. The third wiring part 163 extends linearly in the X-direction. The fourth wiring part 164 is located at another side of the third front coil 41C and the fourth front coil 41D in the Y-direction. The fourth wiring part 164 extends linearly in the X-direction.

With this configuration, the first wiring part 161 and the second wiring part 162 are parallel to each other, and are separately disposed at opposite sides of the first front coil 41A and the second front coil 41B in the Y-direction. Therefore, when noise is introduced to the first wiring part 161 and the second wiring part 162 in the same direction, magnetic fields generated in the first wiring part 161 and the second wiring part 162 readily cancel each other at the first front coil 41A and the second front coil 41B. In addition, the third wiring part 163 and the fourth wiring part 164 are parallel to each other, and are separately disposed at opposite sides of the third front coil 41C and the fourth front coil 41D in the Y-direction. Therefore, when noise is introduced to the third wiring part 163 and the fourth wiring part 164 in the same direction, magnetic fields generated in the third wiring part 163 and the fourth wiring part 164 readily cancel each other at the third front coil 41C and the fourth front coil 41D.

(4) The first wiring part 161 includes the two first sub-wiring parts 161A and 161B that are aligned in the X-direction. The second wiring part 162 includes the two second sub-wiring parts 162A and 162B that are aligned in the X-direction.

With this configuration, the first sub-wiring parts 161A and 161B are each shorter than the first wiring part 161 in the X-direction, and the second sub-wiring parts 162A and 162B are each shorter than the second wiring part 162 in the X-direction. Therefore, when noise is introduced to the first sub-wiring parts 161A and 161B and the second sub-wiring parts 162A and 162B, a noise-induced variation in the magnitude of the currents is limited.

(5) The lengths LA1 and LB1 of the two first sub-wiring parts 161A and 161B are equal in the X-direction. The lengths LA2 and LB2 of the two second sub-wiring parts 162A and 162B are equal in the X-direction.

With this configuration, when noise is introduced to the first sub-wiring parts 161A and 161B and the second sub-wiring parts 162A and 162B, a noise-induced variation in the magnitude of the currents is further limited.

(6) The lengths LA1 and LB1 of the first sub-wiring parts 161A and 161B in the X-direction are equal to the lengths LA2 and LB2 of the second sub-wiring parts 162A and 162B in the X-direction.

With this configuration, when noise is introduced to the first sub-wiring parts 161A and 161B and the second sub-wiring parts 162A and 162B, the magnetic fields in the first sub-wiring parts 161A and 161B and the second sub-wiring parts 162A and 162B effectively cancel each other at the first front coil 41A and the second front coil 41B.

(7) The two first sub-wiring parts 161A and 161B include the first wiring layers 181A and 181B layered in the Y-direction, and the first wiring connection layers 191A and 191B respectively connecting the first wiring layers 181A. The two second sub-wiring parts 162A and 162B include the second wiring layers 182A and 182B layered in the Y-direction, and the second wiring connection layers 192A and 192B respectively connecting the second wiring layers 182A and 182B. The first wiring connection layers 191A and 191B respectively connect the first wiring layers 181A and 181B in a central portion of the first wiring part 161 in the X-direction. The second wiring connection layers 192A and 192B respectively connect the second wiring layers 182A and 182B in a central portion of the second wiring part 162 in the X-direction.

With this configuration, when noise is introduced to the first sub-wiring parts 161A and 161B, the direction in which current flows through the first sub-wiring part 161A is opposite to the direction in which current flows through the first sub-wiring part 161B. When noise is introduced to the second sub-wiring parts 162A and 162B, the direction in which current flows through the second sub-wiring part 162A is opposite to the direction in which current flows through the second sub-wiring part 162B. Thus, when noise is introduced to the first sub-wiring parts 161A and 161B and the second sub-wiring parts 162A and 162B, the magnetic fields in the first sub-wiring parts 161A and 161B and the second sub-wiring parts 162A and 162B effectively cancel each other at the first front coil 41A and the second front coil 41B.

(8) The first dummy wiring 45A includes the first pad connector 171 electrically connecting the two first sub-wiring parts 161A and 161B to the second pad 81B, and the second pad connector 172 electrically connecting the two second sub-wiring parts 162A and 162B to the second pad 81B. The first pad connector 171 includes the first connection base 201, the second connection base 202, the first straight portions 211A, and the second straight portions 212A. The first connection base 201 extends to surround at least a portion of the first front coil 41A located toward the second pad 81B. The second connection base 202 extends to surround at least a portion of the second front coil 41B located toward the second pad 81B. The first straight portions 211A are connected to the first connection base 201 and are arranged side by side in the Y-direction. The first straight portions 211A extend linearly in the X-direction. The second straight portions 212A are connected to the second connection base 202 and are arranged side by side in the Y-direction. The second straight portions 212A extend linearly in the X-direction. The second pad connector 172 includes the third connection base 203, the fourth connection base 204, the third straight portions 213A, and the fourth straight portions 214A. The third connection base 203 extends to surround at least a portion of the first front coil 41A located toward the second pad 81B. The fourth connection base 204 extends to surround at least a portion of the second front coil 41B located toward the second pad 81B. The third straight portions 213A are connected to the third connection base 203 and are arranged side by side in the Y-direction. The third straight portions 213A extend linearly in the X-direction. The fourth straight portions 214A are connected to the fourth connection base 204 and are arranged side by side in the Y-direction. The fourth straight portions 214A extend linearly in the X-direction. The first straight portions 211A and the second straight portions 212A are alternately arranged in the Y-direction. The third straight portions 213A and the fourth straight portions 214A are alternately arranged in the Y-direction.

With this configuration, the first straight portions 211A and the second straight portion 212A are alternately arranged in the Y-direction, and extend in opposite directions. Therefore, when noise is introduced to the first straight portions 211A and the second straight portions 212A, the magnetic fields of the first straight portions 211A and the second straight portions 212A are oriented in opposite directions. Accordingly, the magnetic fields of the first straight portions 211A and the second straight portions 212A have limited effects on each other. Further, the third straight portions 213A and the fourth straight portion 214A are alternately arranged in the Y-direction, and extend in opposite directions. Therefore, when noise is introduced to the third straight portions 213A and the fourth straight portions 214A, the magnetic fields of the third straight portions 213A and the fourth straight portions 214A are oriented in opposite directions. Accordingly, the magnetic fields of the third straight portions 213A and the fourth straight portions 214A have limited effects on each other.

(9) The first connection base 201 is formed to surround a portion of the first front coil 41A located relatively close to the first wiring part 161 in plan view. The second connection base 202 is formed to surround a portion of the second front coil 41B located relatively close to the first wiring part 161 in plan view. The third connection base 203 is formed to surround a portion of the first front coil 41A located relatively close to the second wiring part 162 in plan view. The fourth connection base 204 is formed to surround a portion of the second front coil 41B located relatively close to the second wiring part 162 in plan view. The distal end 201A of the first connection base 201 and the distal end 203A of the third connection base 203 are adjacent to each other in the Y-direction. The distal end 202A of the second connection base 202 and the distal end 204A of the fourth connection base 204 are adjacent to each other in the Y-direction.

With this configuration, the first connection base 201 and the third connection base 203 surround most of the first front coil 41A. The second connection base 202 and the fourth connection base 204 surround most of the second front coil 41B. Thus, the electric field will not concentrate in the first front coil 41A and the second front coil 41B.

(10) The third dummy wiring 45C includes the fifth wiring part 165 and the sixth wiring part 166. The fifth wiring part 165 is located at a side of the fifth front coil 41E and the sixth front coil 41F in the Y-direction. The sixth wiring part 166 is located at another side of the fifth front coil 41E and the sixth front coil 41F in the Y-direction. The fourth dummy wiring 45D includes the seventh wiring part 167 and the eighth wiring part 168. The seventh wiring part 167 is located at a side of the seventh front coil 41G and the eighth front coil 41H in the Y-direction. The eighth wiring part 168 is located at another side of the seventh front coil 41G and the eighth front coil 41H in the Y-direction.

With this configuration, the fifth wiring part 165 and the sixth wiring part 166 include parallel portions, and are separately disposed at opposite sides of the fifth front coil 41E and the sixth front coil 41F in the Y-direction. Therefore, when noise is introduced to the fifth wiring part 165 and the sixth wiring part 166 in the same direction, magnetic fields generated in the fifth wiring part 165 and the sixth wiring part 166 have limited effects on each other at the fifth front coil 41E and the sixth front coil 41F. Further, the seventh wiring part 167 and the eighth wiring part 168 include parallel portions, and are separately disposed at opposite sides of the seventh front coil 41G and the eighth front coil 41H in the Y-direction. Therefore, when noise is introduced to the seventh wiring part 167 and the eighth wiring part 168 in the same direction, magnetic fields generated in the seventh wiring part 167 and the eighth wiring part 168 have limited effects on each other at the seventh front coil 41G and the eighth front coil 41H.

(11) The fifth wiring part 165 and the sixth wiring part 166 each include a curved section surrounding part of the fifth front coil 41E. The seventh wiring part 167 and the eighth wiring part 168 each include a curved section surrounding part of the eighth front coil 41H.

With this configuration, the fifth wiring part 165 and the sixth wiring part 166 surround most of the fifth front coil 41E, thereby avoiding concentration of the electric field in the fifth front coil 41E. The seventh wiring part 167 and the eighth wiring part 168 surround most of the eighth front coil 41H, thereby avoiding concentration of the electric field in the eighth front coil 41H.

(12) The transformer chip 80 includes the floating dummy wiring 140 that surrounds the first to eighth front coils 41A to 41H and the first to fourth dummy wiring 45A to 45D.

With this configuration, the electric field will not concentrate in the first to eighth front coils 41A to 41H.

### Modified Examples

The above embodiment may be modified as described below. The modified examples described below may be combined with one another as long as there is no technical inconsistency.

### Modified Examples of Transformer Chip

The configuration of the first to fourth dummy wiring 45A to 45D may be changed.

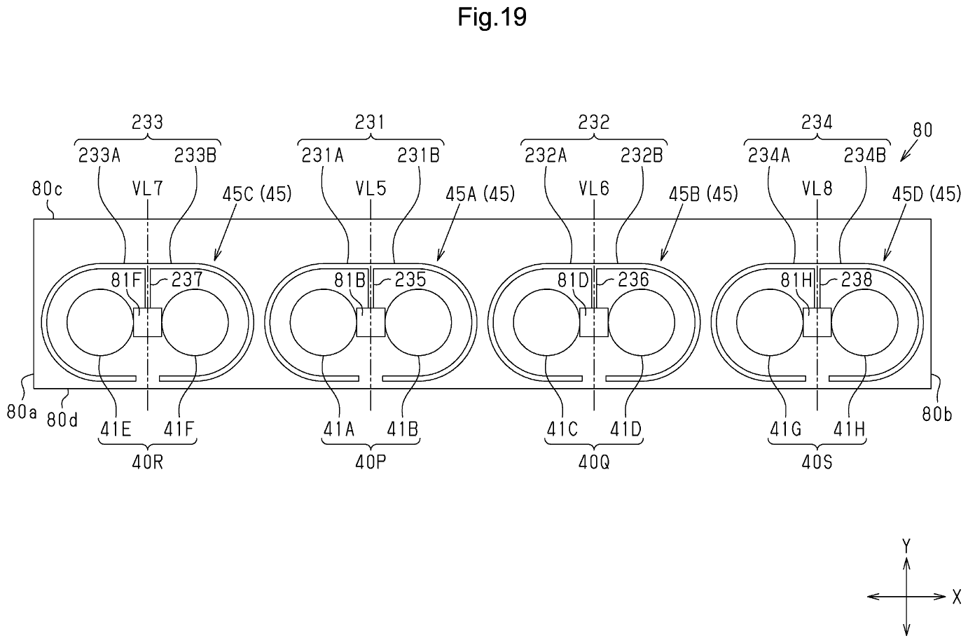

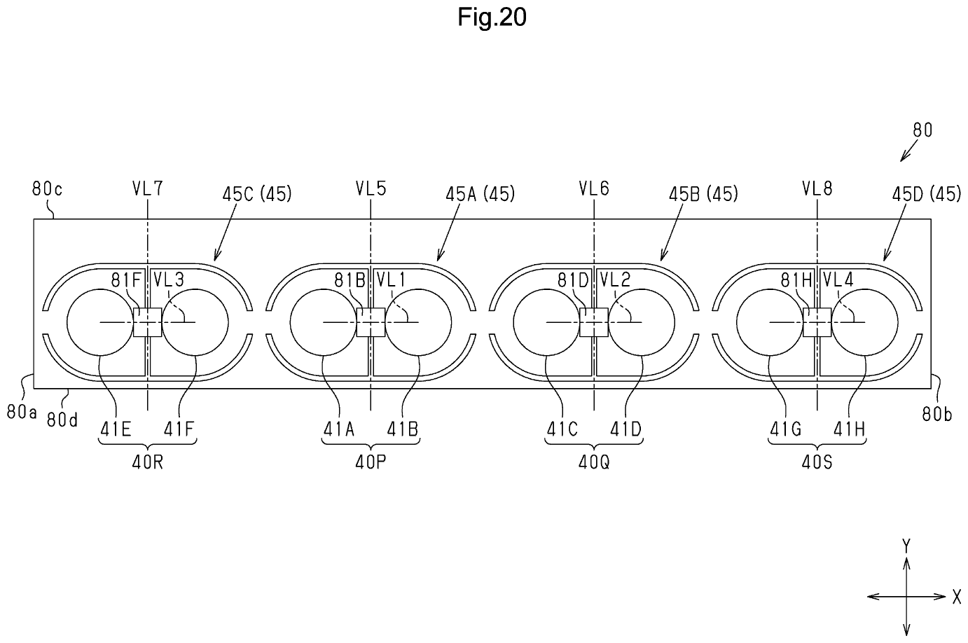

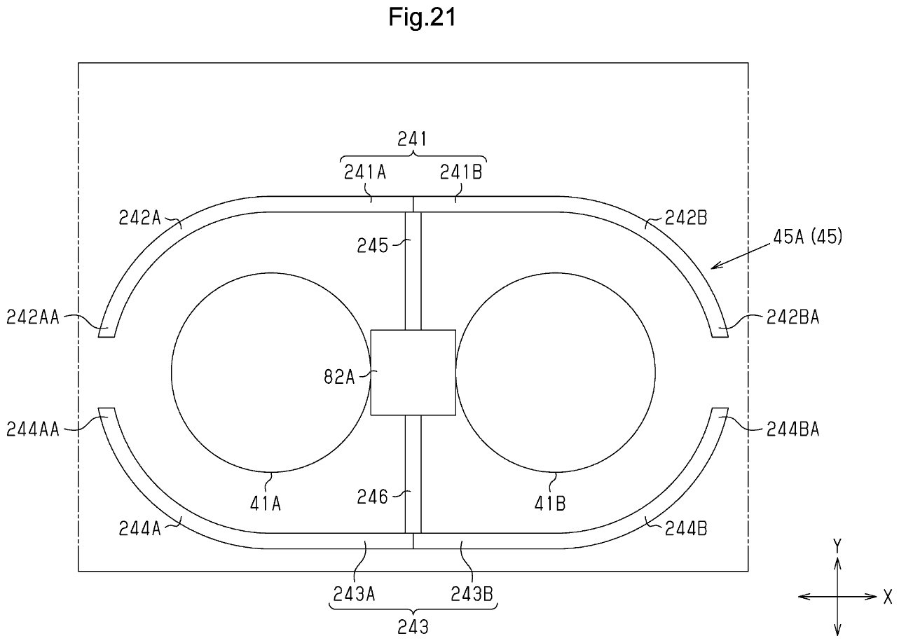

The first to fourth dummy wiring 45A to 45D may be changed to, for example, either a first example shown in FIG. 19 or a second example shown in FIGS. 20 and 21.

### First Example

As shown in FIG. 19, in the first example, the first to fourth dummy wiring 45A to 45D have the same configuration.

The first dummy wiring 45A includes a first wiring part 231 having a shape of an open loop that surrounds both the first front coil 41A and the second front coil 41B of the first isolation transformer 40P. The first wiring part 231 has a single opening. The first wiring part 231 includes two first sub-wiring parts 231A and 231B that are aligned in the X-direction. The two first sub-wiring parts 231A and 231B are equal in length. That is, the first dummy wiring 45A includes a portion that is symmetric with respect to the imaginary line VL5. In other words, the first wiring part 231 is divided into the first sub-wiring parts 231A and 231B by the imaginary line VL5.

The first sub-wiring part 231A includes a first straight section extending linearly in the X-direction, a curved section extending to surround the first front coil 41A, and a second straight section extending linearly from the curved section in the X-direction. The straight section extends from the central position of the first sub-wiring part 231A in the X-direction toward a side of the first sub-wiring part 231A opposite to the first sub-wiring part 231B in the X-direction. The curved section is substantially semi-annular and surrounds the first front coil 41A from a side of the first sub-wiring part 231A opposite to the second pad 81B. The second straight section extends from the curved section toward the first sub-wiring part 231B in the X-direction.

The first sub-wiring part 231B includes a first straight section extending linearly in the X-direction, a curved section extending to surround the second front coil 41B, and a second straight section extending linearly from the curved section in the X-direction. The straight section extends from the central position of the first sub-wiring part 231B in the X-direction toward a side of the first sub-wiring part 231B opposite to the first sub-wiring part 231A in the X-direction. The curved section is substantially semi-annular and surrounds the second front coil 41B from a side of the first sub-wiring part 231B opposite to the first pad 81A. The second straight section extends from the curved section toward the first sub-wiring part 231A in the X-direction. The second straight section of the first sub-wiring part 231A and the second straight section of the first sub-wiring part 231B are spaced apart from each other in the X-direction and face each other in the X-direction. The first dummy wiring 45A is an open loop having a gap between the second straight section of the first sub-wiring part 231A and the second straight section of the first sub-wiring part 231B in the X-direction.

The first dummy wiring 45A includes a first pad connector 235 connecting the first wiring part 231 to the second pad 81B. The first pad connector 235 is connected to both the first sub-wiring part 231A and the first sub-wiring part 231B.

The second dummy wiring 45B includes a second wiring part 232 having a shape of an open loop that surrounds both the third front coil 41C and the fourth front coil 41D of the second isolation transformer 40Q. The second wiring part 232 has a single opening. The second wiring part 232 includes two second sub-wiring parts 232A and 232B that are aligned in the X-direction. The two second sub-wiring parts 232A and 232B are equal in length. That is, the second dummy wiring 45B includes a portion that is symmetric with respect to the imaginary line VL6. In other words, the second wiring part 232 is divided into the second sub-wiring parts 232A and 232B by the imaginary line VL6.

The second sub-wiring part 232A includes a first straight section extending linearly in the X-direction, a curved section extending to surround the third front coil 41C, and a second straight section extending linearly from the curved section in the X-direction. The straight section extends from the central position of the second sub-wiring part 232A in the X-direction toward a side of the second sub-wiring part 232A opposite to the second sub-wiring part 232B in the X-direction. The curved section is substantially semi-annular and surrounds the third front coil 41C from a side of the second sub-wiring part 232A opposite to the fourth pad 81D. The second straight section extends from the curved section toward the second sub-wiring part 232B in the X-direction.

The second sub-wiring part 232B includes a first straight section extending linearly in the X-direction, a curved section extending to surround the fourth front coil 41D, and a second straight section extending linearly from the curved section in the X-direction. The straight section extends from the central position of the second sub-wiring part 232B in the X-direction toward a side of the second sub-wiring part 232B opposite to the second sub-wiring part 232A in the X-direction. The curved section is substantially semi-annular and surrounds the fourth front coil 41D from a side of the second sub-wiring part 232B opposite to the fourth pad 81D. The second straight section extends from the curved section toward the second sub-wiring part 232A in the X-direction. The second straight section of the second sub-wiring part 232A and the second straight section of the second sub-wiring part 232B are spaced apart from each other in the X-direction and face each other in the X-direction. The second dummy wiring 45B is an open loop having a gap between the second straight section of the second sub-wiring part 232A and the second straight section of the second sub-wiring part 232B in the X-direction.

The second dummy wiring 45B includes a second pad connector 236 connecting the second wiring part 232 to the fourth pad 81D. The second pad connector 236 is connected to both the second sub-wiring part 232A and the second sub-wiring part 232B.

The third dummy wiring 45C includes a third wiring part 233 having a shape of an open loop that surrounds both the fifth front coil 41E and the sixth front coil 41F of the third isolation transformer 40R. The third wiring part 233 has a single opening. The third wiring part 233 includes two third sub-wiring parts 233A and 233B that are aligned in the X-direction. The third sub-wiring parts 233A and 233B are equal in length. That is, the third dummy wiring 45C includes a portion that is symmetric with respect to the imaginary line VL7. In other words, the third wiring part 233 is divided into the third sub-wiring parts 233A and 233B by the imaginary line VL7.

The third sub-wiring part 233A includes a first straight section extending linearly in the X-direction, a curved section extending to surround the fifth front coil 41E, and a second straight section extending linearly from the curved section in the X-direction. The straight section extends from the central position of the third sub-wiring part 233A in the X-direction toward a side of the third sub-wiring part 233A opposite to the third sub-wiring part 233B in the X-direction. The curved section is substantially semi-annular and surrounds the fifth front coil 41E from a side of the third sub-wiring part 233A opposite to the sixth pad 81F. The second straight section extends from the curved section toward the third sub-wiring part 233B in the X-direction.

The third sub-wiring part 233B includes a first straight section extending linearly in the X-direction, a curved section extending to surround the sixth front coil 41F, and a second straight section extending linearly from the curved section in the X-direction. The straight section extends from the central position of the third sub-wiring part 233B in the X-direction toward a side of the third sub-wiring part 233B opposite to the third sub-wiring part 233A in the X-direction. The curved section is substantially semi-annular and surrounds the sixth front coil 41F from a side of the third sub-wiring part 233B opposite to the sixth pad 81F. The second straight section extends from the curved section toward the third sub-wiring part 233A in the X-direction. The second straight section of the third sub-wiring part 233A and the second straight section of the third sub-wiring part 233B are spaced apart from each other in the X-direction and face to each other in the X-direction. The third dummy wiring 45C is an open loop with a gap between the second straight section of the third sub-wiring part 233A and the second straight section of the third sub-wiring part 233B in the X-direction.

The third dummy wiring 45C includes a third pad connector 237 connecting the third wiring part 233 to the sixth pad 81F. The third pad connector 237 is connected to both the third sub-wiring part 233A and the third sub-wiring part 233B.

The fourth dummy wiring 45D includes a fourth wiring part 234 having a shape of an open loop that surrounds the seventh front coil 41G and the eighth front coil 41H of the fourth isolation transformer 40S. The fourth wiring part 234 has a single opening. The fourth wiring part 234 includes two fourth sub-wiring parts 234A and 234B that are aligned in the X-direction. The fourth sub-wiring parts 234A and 234B are equal in length. That is, the fourth dummy wiring 45D includes a portion that is symmetric with respect to the imaginary line VL8. In other words, the fourth wiring part 234 is divided into the fourth sub-wiring parts 234A and 234B by the imaginary line VL8.

The fourth sub-wiring part 234A includes a first straight section extending linearly in the X-direction, a curved section extending to surround the seventh front coil 41G, and a second straight section extending linearly from the curved section in the X-direction. The straight section extends from the central position of the fourth sub-wiring part 234A in the X-direction toward a side of the fourth sub-wiring part 234A opposite to the fourth sub-wiring part 234B in the X-direction. The curved section is substantially semi-annular and surrounds the seventh front coil 41G from a side of the fourth sub-wiring part 234A opposite to the eighth pad 81H. The second straight section extends from the curved section toward the fourth sub-wiring part 234B in the X-direction.

The fourth sub-wiring part 234B includes a first straight section extending linearly in the X-direction, a curved section extending to surround the eighth front coil 41H, and a second straight section extending linearly from the curved section in the X-direction. The straight section extends from the central position of the fourth sub-wiring part 234B in the X-direction toward a side of the fourth sub-wiring part 234B opposite to the fourth sub-wiring part 234A in the X-direction. The curved section is substantially semi-annular and surrounds the eighth front coil 41H from a side of the fourth sub-wiring part 234B opposite to the eighth pad 81H. The second straight section extends from the curved section toward the fourth sub-wiring part 234A in the X-direction. The second straight section of the fourth sub-wiring part 234A and the second straight section of the fourth sub-wiring part 234B are spaced apart from each other in the X-direction and face each other in the X-direction. The fourth dummy wiring 45D is an open loop having a gap between the second straight section of the fourth sub-wiring part 234A and the second straight section of the fourth sub-wiring part 234B in the X-direction.

The fourth dummy wiring 45D includes a fourth pad connector 238 connecting the fourth wiring part 234 to the eighth pad 81H. The fourth pad connector 238 is connected to both the fourth sub-wiring part 234A and the fourth sub-wiring part 234B.

### Second Example

As shown in FIG. 20, in the second example, the first to fourth dummy wiring 45A to 45D are each an open loop having openings in two opposite ends in the X-direction. The first to fourth dummy wiring 45A to 45D each include two openings formed in separated positions in the X-direction. The first dummy wiring 45A is symmetric with respect to the imaginary line VL1 and is symmetric with respect to the imaginary line VL5. The second dummy wiring 45B is symmetric with respect to the imaginary line VL2 and is symmetric with respect to the imaginary line VL6. The third dummy wiring 45C is symmetric with respect to the imaginary line VL3 and is symmetric with respect to the imaginary line VL7. The fourth dummy wiring 45D is symmetric with respect to the imaginary line VL4 and is symmetric with respect to the imaginary line VL8. In the example shown in FIG. 20, the first to fourth dummy wiring 45A to 45D have the same configuration. Hence, the configuration of the first dummy wiring 45A will be described in detail, and detailed description of the configurations of the second to fourth dummy wiring 45B to 45D will be omitted.

As shown in FIG. 21, the first dummy wiring 45A includes a first wiring part 241, first curved parts 242A and 242B, a second wiring part 243, and second curved parts 244A and 244B. The first dummy wiring 45A includes a first pad connector 245 and a second pad connector 246. In an example, the first wiring part 241, the first curved parts 242A and 242B, and the first pad connector 245 are integrated with one another. The second wiring part 243, the second curved parts 244A and 244B, and the second pad connector 246 are integrated with one another.

The first wiring part 241 is located at a side of the first front coil 41A and the second front coil 41B in the Y-direction. The first wiring part 241 extends linearly in the X-direction. As viewed in the Y-direction, the first wiring part 241 extends to overlap the first front coil 41A, the second front coil 41B, and the second pad 81B.

The first wiring part 241 includes two first sub-wiring parts 241A and 241B that are aligned in the X-direction. The first sub-wiring part 241A is located at a position that overlaps the first coil 41 of the transformer 40A as viewed in the Y-direction. The first sub-wiring part 241B is located at a position that overlaps the first coil 41 of the transformer 40B as viewed in the Y-direction. The two first sub-wiring parts 241A and 241B are equal in length in the X-direction. That is, the first sub-wiring parts 241A and 241B are separated at the central position of the first wiring part 241 in the X-direction.

The first curved parts 242A and 242B respectively surround part of the first front coil 41A and part of the second front coil 41B at two opposite ends of the first wiring part 241 in the X-direction. The first curved part 242A is connected to one of two opposite ends of the first sub-wiring part 241A in the X-direction that is located at a side of the first sub-wiring part 241A opposite to the first sub-wiring part 241B. The first curved part 242A surrounds part of the first front coil 41A. The first curved part 242B is connected to one of two opposite ends of the first sub-wiring part 241B in the X-direction that is located at a side of the first sub-wiring part 241B opposite to the first sub-wiring part 241A. The first curved part 242B surrounds part of the second front coil 41B. The length of the first curved part 242A in a direction in which the first curved part 242A extends is equal to the length of the first curved part 242B in a direction in which the first curved part 242B extends.

The first pad connector 245 connects the first wiring part 241 to the second pad 81B. The first pad connector 245 is separately connected to the first sub-wiring parts 241A and 241B. Therefore, the first sub-wiring parts 241A and 241B are electrically connected to the second pad 81B.

The second wiring part 243 is located at another side of the first front coil 41A and the second front coil 41B in the Y-direction. The second wiring part 243 extends linearly in the X-direction. As viewed in the Y-direction, the second wiring part 243 extends to overlap the first front coil 41A, the second front coil 41B, and the second pad 81B. The second wiring part 243 is located at a position that overlaps the first wiring part 241 as viewed in the Y-direction.

The second wiring part 243 includes two second sub-wiring parts 243A and 243B that are aligned in the X-direction. The second sub-wiring part 243A is located at a position that overlaps the first front coil 41A as viewed in the Y-direction. The second sub-wiring part 243A is located at a position that overlaps the first sub-wiring part 241A as viewed in the Y-direction. The second sub-wiring part 243B is located at a position that overlaps the second front coil 41B as viewed in the Y-direction. The second sub-wiring part 243B is located at a position that overlaps the first sub-wiring part 241B as viewed in the Y-direction. The two second sub-wiring parts 243A and 243B are equal in length in the X-direction. That is, the second sub-wiring parts 243A and 243B are separated at the central position of the second wiring part 243 in the X-direction. The length of the first sub-wiring part 241A in the X-direction is equal to the length of the second sub-wiring part 243A in the X-direction. The length of the first sub-wiring part 241B in the X-direction is equal to the length of the second sub-wiring part 243B in the X-direction.

The second curved parts 244A and 244B respectively surround part of the first front coil 41A and part of the second front coil 41B at two opposite ends of the second wiring part 243 in the X-direction. The second curved part 244A is connected to one of two opposite ends of the second sub-wiring part 243A in the X-direction that is located at a side of the second sub-wiring part 243A opposite to the second sub-wiring part 243B. The second curved part 244A surrounds part of the first front coil 41A. The second curved part 244B is connected to one of two opposite ends of the second sub-wiring part 243B in the X-direction that is located at a side of the second sub-wiring part 243B opposite to the second sub-wiring part 243A. The second curved part 244B surrounds part of the second front coil 41B. The length of the second curved part 244A in a direction in which the second curved part 244A extends is equal to the length of the second curved part 244B in a direction in which the second curved part 244B extends. Also, the length of the first curved part 242A in a direction in which the first curved part 242A extends is equal to the length of the second curved part 244A in a direction in which the second curved part 244A extends. The length of the first curved part 242B in a direction in which the first curved part 242B extends is equal to the length of the second curved part 244B in a direction in which the second curved part 244B extends.

A distal end 244AA of the second curved part 244A and a distal end 242AA of the first curved part 242A are adjacent to each other in the Y-direction. The distal end 244AA of the second curved part 244A and the distal end 242AA of the first curved part 242A face each other in the Y-direction. A distal end 244BA of the second curved part 244B and a distal end 242BA of the first curved part 242B are adjacent to each other in the Y-direction. The distal end 244BA of the second curved part 244B and the distal end 242BA of the first curved part 242B face each other in the Y-direction.

The second pad connector 246 connects the second wiring part 243 to the second pad 81B. The second pad connector 246 is separately connected to the second sub-wiring parts 243A and 243B. Therefore, the second sub-wiring parts 243A and 243B are electrically connected to the second pad 81B.

As shown in FIG. 20, the second to fourth dummy wiring 45B to 45D have the same configuration as the first dummy wiring 45A. Hence, only the overall configurations of the second to fourth dummy wiring 45B to 45D will be described.

The second dummy wiring 45B includes a third wiring part, two third curved parts, a fourth wiring part, two fourth curved parts, a third pad connector, and a fourth pad connector.

The third wiring part is located at a side of the third front coil 41C and the fourth front coil 41D in the Y-direction. The third wiring part extends linearly in the X-direction. The third wiring part includes two third sub-wiring parts that are aligned in the X-direction. The two third sub-wiring parts are equal in length in the X-direction. In plan view, the two third curved parts respectively surround part of the third front coil 41C and part of the fourth front coil 41D at two opposite ends of the third wiring part in the X-direction. The two third curved parts are equal in length. The third pad connector connects the third wiring part (two third sub-wiring parts) to the fourth pad 81D.

The fourth wiring part is located at another side of the third front coil 41C and the fourth front coil 41D in the Y-direction. The fourth wiring part extends linearly in the X-direction. The fourth wiring part includes two fourth sub-wiring parts that are aligned in the X-direction. The two fourth sub-wiring parts are equal in length in the X-direction. The length of the third sub-wiring part in the X-direction is equal to the length of the fourth sub-wiring part in the X-direction. In plan view, the two fourth curved parts respectively surround part of the third front coil 41C and part of the fourth front coil 41D at two opposite ends of the fourth wiring part in the X-direction. The two fourth curved parts are equal in length. Also, the third curved part and the fourth curved part are equal in length. The fourth pad connector connects the fourth wiring part (two fourth sub-wiring parts) to the fourth pad 81D. A distal end of the third curved part and a distal end of the fourth curved part are adjacent to each other in the Y-direction. The distal end of the third curved part and the distal end of the fourth curved part face each other in the Y-direction.

The third dummy wiring 45C includes a fifth wiring part, two fifth curved parts, a sixth wiring part, two sixth curved parts, a fifth pad connector, and a sixth pad connector.

The fifth wiring part is located at a side of the fifth front coil 41E and the sixth front coil 41F in the Y-direction. The fifth wiring part extends linearly in the X-direction. The fifth wiring part includes two fifth sub-wiring parts that are aligned in the X-direction. The two fifth sub-wiring parts are equal in length in the X-direction. In plan view, the two fifth curved parts respectively surround part of the fifth front coil 41E and part of the sixth front coil 41F at two opposite ends of the fifth wiring part in the X-direction. The two fifth curved parts are equal in length. The fifth pad connector connects the fifth wiring part (two fifth sub-wiring parts) to the sixth pad 81F.

The sixth wiring part is located at another side of the fifth front coil 41E and the sixth front coil 41F in the Y-direction. The sixth wiring part extends linearly in the X-direction. The sixth wiring part includes two sixth sub-wiring parts that are aligned in the X-direction. The two sixth sub-wiring parts are equal in length in the X-direction. The length of the fifth sub-wiring part in the X-direction is equal to the length of the sixth sub-wiring part in the X-direction. In plan view, the two sixth curved parts respectively surround part of the fifth front coil 41E and part of the sixth front coil 41F at two opposite ends of the sixth wiring part in the X-direction. The two sixth curved parts are equal in length. The fifth curved part and the sixth curved part are equal in length. The sixth pad connector connects the sixth wiring part (two sixth sub-wiring parts) to the sixth pad 81F. A distal end of the fifth curved part and a distal end of the sixth curved part are adjacent to each other in the Y-direction. The distal end of the fifth curved part and the distal end of the sixth curved part face each other in the Y-direction.

The fourth dummy wiring 45D includes a seventh wiring part, two seventh curved parts, an eighth wiring part, two eighth curved parts, a seventh pad connector, and an eighth pad connector.

The seventh wiring part is located at a side of the seventh front coil 41G and the eighth front coil 41H in the Y-direction. The seventh wiring part extends linearly in the X-direction. The seventh wiring part includes two seventh sub-wiring parts that are aligned in the X-direction. The two seventh sub-wiring parts are equal in length in the X-direction. In plan view, the two seventh curved parts respectively surround part of the seventh front coil 41G and part of the eighth front coil 41H at two opposite ends of the seventh wiring part in the X-direction. The two seventh curved parts are equal in length. The seventh pad connector connects the seventh wiring part (two seventh sub-wiring parts) to the eighth pad 81H.

The eighth wiring part is located at another side of the seventh front coil 41G and the eighth front coil 41H in the Y-direction. The eighth wiring part extends linearly in the X-direction. The eighth wiring part includes two eighth sub-wiring parts that are aligned in the X-direction. The eighth sub-wiring parts are equal in length in the X-direction. The length of the seventh sub-wiring part in the X-direction is equal to the length of the eighth sub-wiring part in the X-direction. The length of the seventh sub-wiring part in the X-direction is equal to the length of the eighth sub-wiring part in the X-direction. In plan view, the two eighth curved parts respectively surround part of the seventh front coil 41G and part of the eighth front coil 41H at two opposite ends of the eighth wiring part in the X-direction. The eight curved parts are equal in length. The seventh curved part and the eighth curved part are equal in length. The eighth pad connector connects the eighth wiring part (two eighth sub-wiring parts) to the eighth pad 81H. A distal end of the seventh curved part and a distal end of the eighth curved part are adjacent to each other in the Y-direction. The distal end of the seventh curved part and the distal end of the eighth curved part face each other in the Y-direction.

The first to eighth front coils 41A to 41H do not have to be ring-shaped in plan view, and may have any planar shape. In an example, the planar shape of the first to eighth front coils 41A to 41H may be elliptical, oval, rectangular, or polygonal with five or more sides.

The first to eighth back coils 42A to 42H do not have to be ring-shaped in plan view, and may have any planar shape. In an example, the planar shape of the first to eighth back coils 42A to 42H may be elliptical, oval, rectangular, or polygonal with five or more sides.

The planar shape of the first to fourth dummy wiring 45A to 45D may be changed. In an example, the first dummy wiring 45A does not have to be symmetric with respect to the imaginary line VL5. In an example, the first dummy wiring 45A does not have to be symmetric with respect to the imaginary line VL1. In an example, the second dummy wiring 45B does not have to be symmetric with respect to the imaginary line VL6. In an example, the second dummy wiring 45B does not have to be symmetric with respect to the imaginary line VL2. In an example, the third dummy wiring 45C does not have to be symmetric with respect to the imaginary line VL7. In an example, the third dummy wiring 45C does not have to be symmetric with respect to the imaginary line VL3. In an example, the fourth dummy wiring 45D does not have to be symmetric with respect to the imaginary line VL8. In an example, the fourth dummy wiring 45D does not have to be symmetric with respect to the imaginary line VL4.

The first wiring part 161 and the second wiring part 162 of the first dummy wiring 45A do not have to extend straight, and may be curved to surround the first front coil 41A and the second front coil 41B. The third wiring part 163 and the fourth wiring part 164 of the second dummy wiring 45B do not have to extend straight, and may be curved to surround the third front coil 41C and the fourth front coil 41D.

The straight section of the fifth sub-wiring part 165A of the fifth wiring part 165 of the third dummy wiring 45C may be changed to a curved section that surrounds the fifth front coil 41E. The fifth sub-wiring part 165B of the fifth wiring part 165 may be formed by a curved section that surrounds the sixth front coil 41F.

The straight section of the sixth sub-wiring part 166A of the sixth wiring part 166 of the fourth dummy wiring 45D may be changed to a curved section that surrounds the fifth front coil 41E. The sixth sub-wiring part 166B of the sixth wiring part 166 may be formed by a curved section that surrounds the sixth front coil 41F.

The lengths LA1 and LB1 of the two first sub-wiring parts 161A and 161B of the first wiring part 161 of the first dummy wiring 45A may differ from each other. The lengths LA2 and LB2 of the two first sub-wiring parts 161A and 161B of the second wiring part 162 may differ from each other.

The length LA1 of the first sub-wiring part 161A of the first wiring part 161 may differ from the length LA2 of the second sub-wiring part 162A of the second wiring part 162. The length LB1 of the first sub-wiring part 161B may differ from the length LB2 of the second sub-wiring part 162B.

The lengths LA3 and LB3 of the two third sub-wiring parts 163A and 163B of the third wiring part 163 of the second dummy wiring 45B may be different from each other. The lengths LA4 and LB4 of the two fourth sub-wiring parts 164A and 164B of the fourth wiring part 164 may differ from each other.

The length LA3 of the third sub-wiring part 163A of the third wiring part 163 may differ from the length LA4 of the fourth sub-wiring part 164A of the fourth wiring part 164. The length LB3 of the third sub-wiring part 163B may differ from the length LB4 of the fourth sub-wiring part 164B.

The length LA5 of the fifth sub-wiring part 165A and the length LA6 of the sixth sub-wiring part 166A of the third dummy wiring 45C may differ from each other. The length LB5 of the fifth sub-wiring part 165B and the length LB6 of the sixth sub-wiring part 166B may differ from each other.

The length LA7 of the seventh sub-wiring part 167A and the length LA8 of the eighth sub-wiring part 168A of the fourth dummy wiring 45D may differ from each other. The length LB7 of the seventh sub-wiring part 167B and the length LB8 of the eighth sub-wiring part 168B may differ from each other.

The position of the first wiring connection layers 191A and 191B of the first dummy wiring 45A in the X-direction may be changed. The position of the fifth wiring connection layers 195A and 195B of the third dummy wiring 45C in the X-direction may be changed. The same applies to the second dummy wiring 45B and the fourth dummy wiring 45D.

The quantity of first wiring layers 181A and 181B of the first sub-wiring parts 161A and 161B of the first dummy wiring 45A and the quantity of second wiring layers 182A and 182B of the second sub-wiring parts 162A and 162B of the first dummy wiring 45A may be changed. In an example, the quantity of first wiring layers 181A and 181B and the quantity of second wiring layers 182A and 182B may be one. In this case, the first wiring connection layers 191A and 191B and the second wiring connection layers 192A and 192B are omitted. The second dummy wiring 45B may be changed in the same manner.

The quantity of fifth wiring layers 185A and 185B of the fifth sub-wiring parts 165A and 165B of the third dummy wiring 45C and the quantity of sixth wiring layers 186A and 186B of the sixth sub-wiring parts 166A and 166B of the third dummy wiring 45C may be changed. In an example, the quantity of fifth wiring layers 185A and 185B and the quantity of sixth wiring layers 186A and 186B may be one. In this case, the fifth wiring connection layers 195A and 195B and the sixth wiring connection layers 196A and 196B are omitted. The fourth dummy wiring 45D may be changed in the same manner.

The configurations of the first pad connector 171 and the second pad connector 172 of the first dummy wiring 45A may be changed from those shown in FIGS. 13 and 14. In an example, at least one of the first connection base 201 of the first pad connector 171 and the third connection base 203 of the second pad connector 172 does not have to cover a side of the first front coil 41A opposite to the second pad 81B in the X-direction. In other words, the first connection base 201 and the third connection base 203 may cover only a portion of the first front coil 41A located toward the second pad 81B. In an example, at least one of the second connection base 202 of the first pad connector 171 and the fourth connection base 204 of the second pad connector 172 does not have to cover a side of the second front coil 41B opposite to the second pad 81B in the X-direction. In other words, the second connection base 202 and the fourth connection base 204 may cover only a portion of the second front coil 41B located toward the second pad 81B. In an example, groups of first straight portions 211A and groups of second straight portions 212A may be alternately arranged in the Y-direction. In an example, groups of third straight portions 213A and groups of fourth straight portions 214A may be alternately arranged in the Y-direction.

The configurations of the fifth pad connector 175 and the sixth pad connector 176 of the third dummy wiring 45C may be changed from those shown in FIGS. 16 and 17. The same applies to the third pad connector 173 and the fourth pad connector 174 of the second dummy wiring 45B and the seventh pad connector 177 and the eighth pad connector 178 of the fourth dummy wiring 45D.

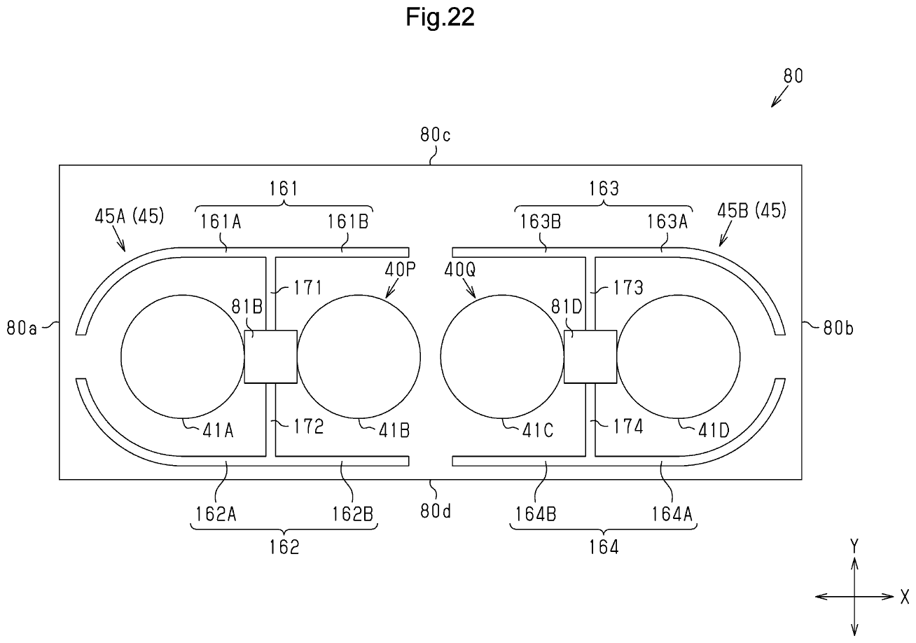

The configuration of the transformer chip 80 may be changed. As shown in FIG. 22, in an example, the transformer chip 80 may include two isolation transformers, namely, the first isolation transformer 40P and the second isolation transformer 40Q. The transformer chip 80 includes the first dummy wiring 45A corresponding to the first isolation transformer 40P, and the second dummy wiring 45B corresponding to the second isolation transformer 40Q. The first dummy wiring 45A has the same configuration as the third dummy wiring 45C of the above embodiment. The second dummy wiring 45B has the same configuration as the fourth dummy wiring 45D of the above embodiment.

### Modified Examples of Signal Transmission Device

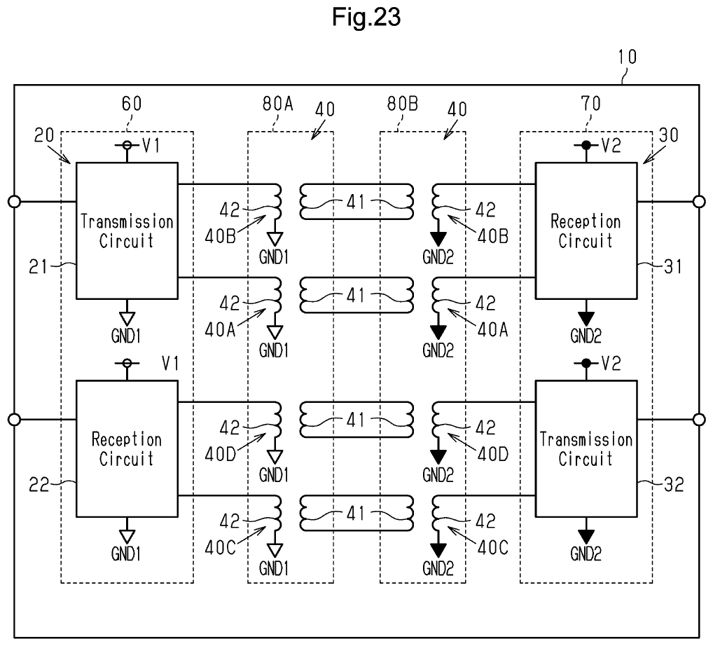

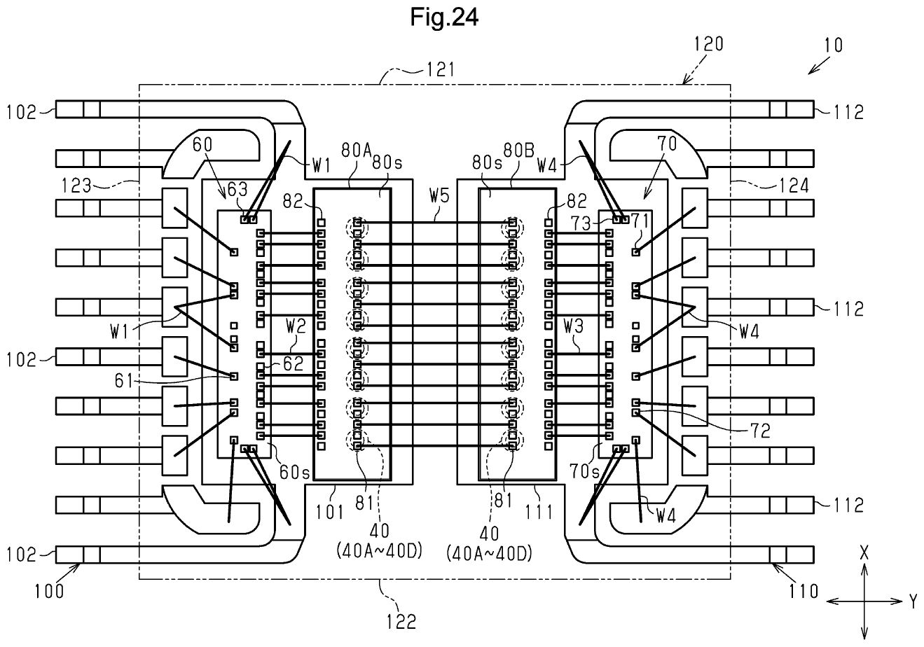

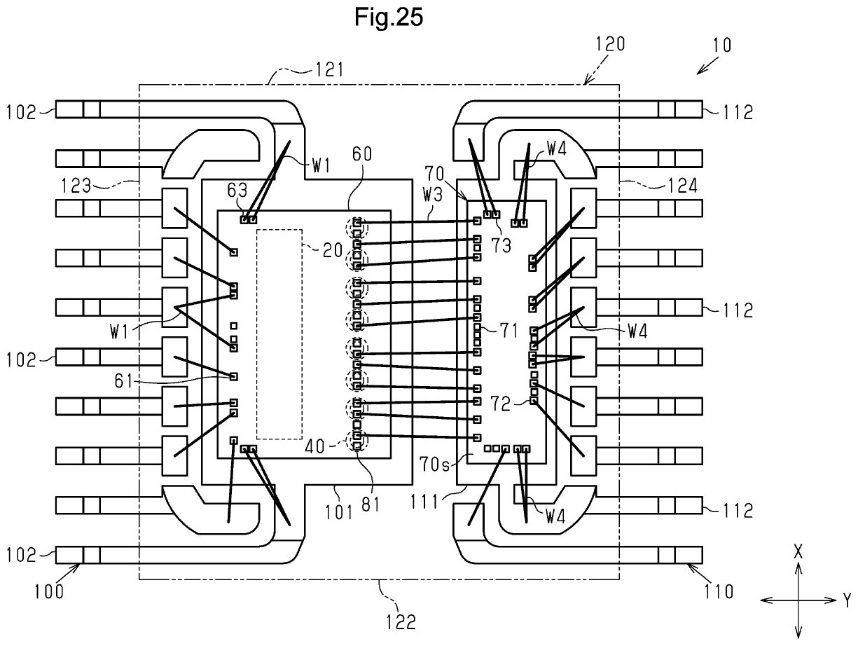

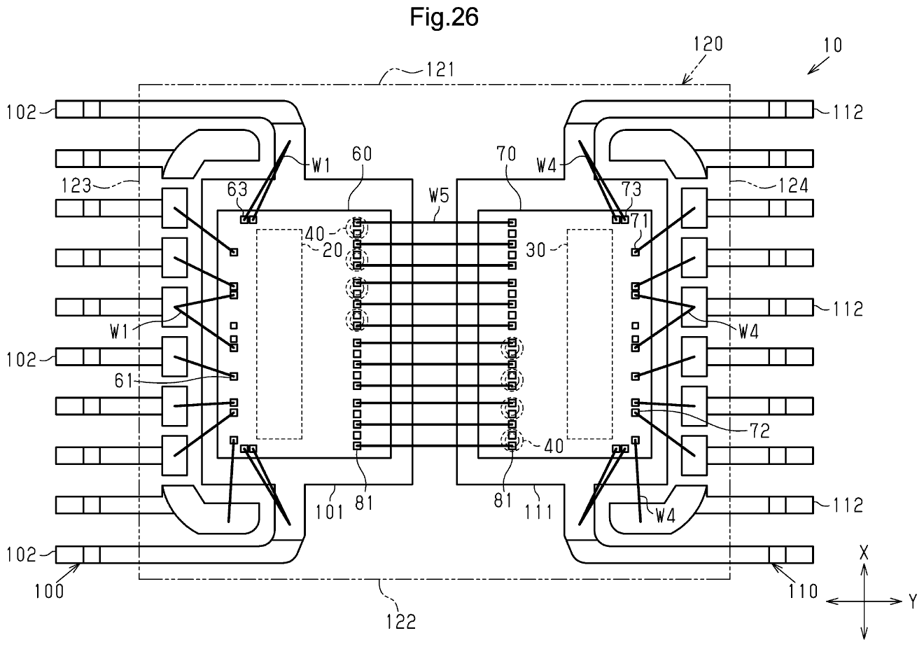

The configuration of the signal transmission device 10 may be changed. The signal transmission device 10 may be changed to, for example, any one of a first modified example shown in FIGS. 23 and 24, a second modified example shown in FIG. 25, and a third modified example shown in FIG. 26.

### First Modified Example

In the first modified example, the signal transmission device 10 may include a plurality of transformer chips 80. FIG. 23 illustrates a schematic planar view of the structure inside the signal transmission device 10 including two transformer chips 80. FIG. 24 shows a schematic cross-sectional structure of the signal transmission device 10 including the two transformer chips 80.

As shown in FIG. 23, the signal transmission device 10 includes the first circuit chip 60, the second circuit chip 70, and two transformer chips 80A and 80B. The transformer chips 80A and 80B each include multiple transformers 40 (in the example shown in FIG. 23, first to fourth transformers 40A to 40D). The second coils 42 of the first to fourth transformers 40A to 40D of the transformer chip 80A are each electrically connected to the first circuit 20 of the first circuit chip 60. The first coils 41 of the first to fourth transformers 40A to 40D of the transformer chip 80A are electrically connected to the first coils 41 of the first to fourth transformers 40A to 40D of the transformer chip 80B. In this manner, the first coils 41 of the first to fourth transformers 40A to 40D of the transformer chip 80A and the first coils 41 of the first to fourth transformers 40A to 40D of the transformer chip 80B are in an electrically floating state. The second coils 42 of the first to fourth transformers 40A to 40D of the transformer chip 80B are each electrically connected to the second circuit 30 of the second circuit chip 70. In such a signal transmission device 10, a pulse signal output from the first circuit 20 is transmitted through the transformer chips 80A and 80B to the second circuit 30 of the second circuit chip 70. Also, a pulse signal output from the second circuit 30 is transmitted through the transformer chips 80A and 80B to the first circuit 20.

As shown in FIG. 24, the first circuit chip 60, the transformer chips 80A and 80B, and the second circuit chip 70 are spaced apart from each other in the Y-direction. The first circuit chip 60, the transformer chip 80A, the transformer chip 80B, and the second circuit chip 70 are aligned in the Y-direction in which the first die pad 101 and the second die pad 111 are arranged next to each other. In the modified example shown in FIG. 24, the first circuit chip 60, the transformer chip 80A, the transformer chip 80B, and the second circuit chip 70 are arranged in this order from the first leads 102 toward the second leads 112. The first die pad 101 is an example of “die pad”.

The first circuit chip 60 and the transformer chip 80A are both arranged on the first die pad 101. The second circuit chip 70 and the transformer chip 80B are both arranged on the second die pad 111.

The second electrode pads 82 of the transformer chip 80B are electrically connected to the second circuit chip 70 by the wires W3. The first electrode pads 81 of the transformer chip 80B are electrically connected to the first electrode pads 81 of the transformer chip 80B by wires W5. That is, the transformer chip 80A and the transformer chip 80B are connected in series between the first circuit chip 60 and the second circuit chip 70.

The transformer chip 80B has the same configuration as the transformer chip 80A. Accordingly, the transformer chip 80B has the same dielectric strength as the transformer chip 80A. As a result, the signal transmission device 10 has a dielectric strength that corresponds to the dielectric breakdown voltage of each of the transformer chip 80A and the transformer chip 80B, which are connected in series.

### Second Modified Example

In the second modified example shown in FIG. 25, instead of a transformer-dedicated semiconductor chip such as the transformer chip 80, the signal transmission device 10 has a configuration in which the first circuit chip 60 includes a plurality of transformers 40. The signal transmission device 10 includes two semiconductor chips, namely, the first circuit chip 60 and the second circuit chip 70.

The first circuit chip 60 includes the first circuit 20 and the transformers 40. The first circuit chip 60 includes the first electrode pads 61 and the third electrode pads 63 of the first circuit chip 60 and the first electrode pads 81 of the transformer chip 80 that are shown in FIG. 2. The first circuit chip 60 is arranged on the first die pad 101, and the second circuit chip 70 is arranged on the second die pad 111. Since the first circuit chip 60 includes the transformers 40, the wires W2 shown in FIG. 2 are not used.

### Third Modified Example

In the second modified example shown in FIG. 26, instead of a transformer-dedicated semiconductor chip such as the transformer chip 80, the signal transmission device 10 has a configuration in which the first circuit chip 60 and the second circuit chip 70 each include a plurality of transformers 40. The signal transmission device 10 includes two semiconductor chips, namely, the first circuit chip 60 and the second circuit chip 70.

The first circuit chip 60 includes the first circuit 20 and multiple transformers 40. The first circuit chip 60 includes the first electrode pads 61 and the third electrode pads 63 of the first circuit chip 60 and the first electrode pads 81 of the transformer chip 80 that are shown in FIG. 2. A pulse signal output from the first circuit 20 is transmitted through the transformers 40 included in the first circuit chip 60 to the second circuit 30.

The second circuit chip 70 includes the second circuit 30 and multiple transformers 40. The second circuit chip 70 includes the second electrode pads 72 and the third electrode pads 73 of the second circuit chip 70 and the first electrode pads 81 of the transformer chip 80 that are shown in FIG. 2.

The first circuit chip 60 is arranged on the first die pad 101, and the second circuit chip 70 is arranged on the second die pad 111. The first electrode pads 81 of the first circuit chip 60 are electrically connected to the first electrode pads 81 of the second circuit chip 70 by the wires W5. Since the first circuit chip 60 and the second circuit chip 70 each include multiple transformers 40, the wires W3 shown in FIG. 2 are not used.

At least one of the first circuit chip 60 and the second circuit chip 70 may be omitted from the signal transmission device 10. When the first circuit chip 60 is omitted from the signal transmission device 10, the signal transmission device 10 includes the transformer chip 80, the second circuit chip 70, and the encapsulation resin 120 that encapsulates the transformer chip 80 and the second circuit chip 70. When the second circuit chip 70 is omitted from the signal transmission device 10, the signal transmission device 10 includes the transformer chip 80, the first circuit chip 60, and the encapsulation resin 120 that encapsulates the transformer chip 80 and the first circuit chip 60. When both the first circuit chip 60 and the second circuit chip 70 are omitted from the signal transmission device 10, the signal transmission device 10 includes the transformer chip 80 and the encapsulation resin 120 that encapsulates the transformer chip 80.

Various examples described in this specification may be combined as long as there is no technical contradiction.

In this specification, “at least one of A and B” should be understood to mean “only A, only B, or both A and B.”

In the present disclosure, the term “on” includes the meaning of “above” in addition to the meaning of “on” unless otherwise clearly described in the context. Accordingly, for example, a phrase such as “first element arranged on second element” may mean that the first element is directly located on the second element in one embodiment and that the first element is located above the second element without contacting the second element in another embodiment. Thus, the term “on” does not exclude a structure in which another component is formed between the first element and the second element.

The Z-direction as referred to in this disclosure does not necessarily have to be the vertical direction, and does not necessarily have to exactly coincide with the vertical direction. Accordingly, in the structures of the present disclosure, “up” and “down” in the Z-direction as referred to in this specification are not limited to “up” and “down” in the vertical direction. For example, the X-direction may be the vertical direction. Alternatively, the Y-direction may be the vertical direction.

### Clauses

Technical concepts that can be understood from the above embodiment and modified examples will now be described. The reference characters of elements in the embodiment are shown in parenthesis for the corresponding elements in the clauses described below. The reference characters are used as examples to aid understanding, and are not intended to limit elements to the elements denoted by the reference characters.

### Clause 1

A transformer chip (80), including:
an insulating layer (84) including a front surface (84s) and a back surface (84r) facing away from each other in a thickness-wise direction (Z-direction);
a first isolation transformer (40P) including a first front coil (41A), a second front coil (41B), a first back coil (42A) and a second back coil (42B), the first front coil (41A) and the second front coil (41B) being located relatively close to the front surface (84s) in the insulating layer (84) and spaced apart from each other in a first direction (X-direction) orthogonal to the thickness-wise direction (Z-direction), the first back coil (42A) and the second back coil (42B) being located relatively close to the back surface (84r) in the insulating layer (84) and spaced apart from each other in the first direction (X-direction), the first back coil (42A) and the second back coil (42B) facing the first front coil (41A) and the second front coil (41B);
a second isolation transformer (40Q) including a third front coil (41C), a fourth front coil (41D), a third back coil (42C), and a fourth back coil (42D), the third front coil (41C) and the fourth front coil (41D) being located relatively close to the front surface (84s) in the insulating layer (84) and spaced apart from each other in the first direction (X-direction), the third back coil (42C) and the fourth back coil (42D) being located relatively close to the back surface (84r) in the insulating layer (84) and spaced apart from each other in the first direction (X-direction), the third back coil (42C) and the fourth back coil (42D) facing the third front coil (41C) and the fourth front coil (41D), the second isolation transformer (40Q) being spaced apart from the first isolation transformer (40P) in the first direction (X-direction);
a first outer pad (81B) disposed between the first front coil (41A) and the second front coil (41B) in the first direction (X-direction) as viewed in the thickness-wise direction (Z-direction), the first outer pad (81B) being electrically connected to both the first front coil (41A) and the second front coil (41B);
a second outer pad (81D) disposed between the third front coil (41C) and the fourth front coil (41D) in the first direction (X-direction) as viewed in the thickness-wise direction (Z-direction), the second outer pad (81D) being electrically connected to both the third front coil (41C) and the fourth front coil (41D);
first dummy wiring (45A) arranged at opposite sides of the first isolation transformer (40P) in a second direction (Y-direction) orthogonal to the first direction (X-direction) as viewed in the thickness-wise direction (Z-direction), the first dummy wiring (45A) being electrically connected to the first outer pad (81B); and
second dummy wiring (45B) arranged at opposite sides of the second isolation transformer (40Q) in the second direction (Y-direction), the second dummy wiring (45B) being electrically connected to the second outer pad (81D) and electrically insulated from the first dummy wiring (45A),
in which the first dummy wiring (45A) and the second dummy wiring (45B) are aligned in the first direction (X-direction).

### Clause 2

The transformer chip according to clause 1, in which
the first dummy wiring (45A) includes a portion symmetric with respect to an imaginary line (VL1) that connects a center (C1) of the first front coil (41A) and a center (C2) of the second front coil (41B), and
the second dummy wiring (45B) includes a portion symmetric with respect to an imaginary line (VL2) that connects a center (C3) of the third front coil (41C) and a center (C4) of the fourth front coil (41D).

### Clause 3

The transformer chip according to clause 1 or 2, in which
the first dummy wiring (45A) includes a portion symmetric with respect to an imaginary line (VL5) that extends in the second direction (Y-direction) through a midpoint between a center (C1) of the first front coil (41A) and a center (C2) of the second front coil (41B), and
the second dummy wiring (45B) includes a portion symmetric with respect to an imaginary line (VL6) that extends in the second direction (Y-direction) through a midpoint between a center (C3) of the third front coil (41C) and a center (C4) of the fourth front coil (41D).

### Clause 4

The transformer chip according to any one of clauses 1 to 3, in which
the first dummy wiring (45A) includes:
   a first wiring part (161) located at a side of the first front coil (41A) and the second front coil (41B) in the second direction (Y-direction), the first wiring part (161) extending linearly in the first direction (X-direction); and
   a second wiring part (162) located at another side of the first front coil (41A) and the second front coil (41B) in the second direction (Y-direction), the second wiring part (162) extending linearly in the first direction (X-direction), and the second dummy wiring (45B) includes:
   a third wiring part (163) located at a side of the third front coil (41C) and the fourth front coil (41D) in the second direction (Y-direction), the third wiring part (163) extending linearly in the first direction (X-direction); and
   fourth wiring part (164) located at another side of the third front coil (41C) and the fourth front coil (41D) in the second direction (Y-direction), the fourth wiring part (164) extending linearly in the first direction (X-direction).

### Clause 5

The transformer chip according to clause 4, in which
the first wiring part (161) includes two first sub-wiring parts (161A, 161B) aligned in the first direction (X-direction), and
the second wiring part (162) includes two second sub-wiring parts (162A, 162B) aligned in the first direction (X-direction).

### Clause 6

The transformer chip according to clause 5, in which
lengths (LA1, LB1) of the two first sub-wiring parts (161A, 161B) are equal in the first direction (X-direction), and
lengths (LA2, LB3) of the two second sub-wiring parts (162A, 162B) are equal in the first direction (X-direction).

### Clause 7

The transformer chip according to clause 6, in which the lengths (LA1, LB1) of the two first sub-wiring parts (161A, 161B) in the first direction (X-direction) are equal to the lengths (LA2, LB2) of the two second sub-wiring parts (162A, 162B) in the first direction (X-direction).

### Clause 8

The transformer chip according to any one of clauses 5 to 7, in which
the two first sub-wiring parts (161A, 161B) each include:
   first wiring layers (181A, 181B) layered in the second direction (Y-direction); and
   a first wiring connection layer (191A, 191B) connecting the first wiring layers (181A, 181B), and
the two second sub-wiring parts (162A, 162B) each include:
   second wiring layers (182A, 182B) layered in the second direction (Y-direction); and
   a second wiring connection layer (192A, 192B) connecting the second wiring layers (182A, 182B).

### Clause 9

The transformer chip according to clause 8, in which
the first wiring connection layer (191A, 191B) connects the first wiring layers (181A, 181B) in a central portion of the first wiring part (161) in the first direction (X-direction), and
the second wiring connection layer (192A, 192B) connects the second wiring layers (182A, 182B) in a central portion of the second wiring part (162) in the first direction (X-direction).

### Clause 10

The transformer chip according to clause 8 or 9, in which
the two first wiring connection layers (191A, 191B) are adjacent to each other in the first direction (X-direction),
the two first sub-wiring parts (161A, 161B) extend in opposite directions from the two first wiring connection layers (191A, 191B) that are adjacent to each other,
the two second wiring connection layers (192A, 192B) are adjacent to each other in the first direction (X-direction), and
the two second sub-wiring parts (162A, 162B) extend in opposite directions from the two second wiring connection layers (192A, 192B) that are adjacent to each other.

### Clause 11

The transformer chip according to any one of clauses 5 to 10, in which the first dummy wiring (45A) includes:
a first pad connector (171) electrically connecting the two first sub-wiring parts (161A, 161B) to the first outer pad (81B); and
a second pad connector (172) electrically connecting the two second sub-wiring parts (162A, 162B) to the first outer pad (81B).

### Clause 12

The transformer chip according to clause 11, in which
the first pad connector (171) includes:
   a first connection base (201) extending to surround at least a portion of the first front coil (41A) located toward the first outer pad (81B);
   a second connection base (202) extending to surround at least a portion of the second front coil (41B) located toward the first outer pad (81B);
   first straight portions (211A) connected to the first connection base (201) and arranged side by side in the second direction (Y-direction), the first straight portions (211A) extending linearly in the first direction (X-direction); and
   second straight portions (212A) connected to the second connection base (202) and arranged side by side in the second direction (Y-direction), the second straight portions (212A) extending linearly in the first direction (X-direction), and the second pad connector (172) includes:
   a third connection base (203) extending to surround at least a portion of the first front coil (41A) located toward the first outer pad (81B);
   a fourth connection base (204) extending to surround at least a portion of the second front coil (41B) located toward the first outer pad (81B);
   third straight portions (213A) connected to the third connection base (203) and arranged side by side in the second direction (Y-direction), the third straight portions (213A) extending linearly in the first direction (X-direction); and
   fourth straight portions (214A) connected to the fourth connection base (204) and arranged side by side in the second direction (Y-direction), the fourth straight portions (214A) extending linearly in the first direction (X-direction),
the first straight portions (211A) and the second straight portions (212A) are alternately arranged in the second direction (Y-direction), and
the third straight portions (213A) and the fourth straight portions (214A) are alternately arranged in the second direction (Y-direction).

### Clause 13

The transformer chip according to clause 12, in which
the first connection base (201) is formed to surround a portion of the first front coil (41A) located relatively close to the first wiring part (161) as viewed in the thickness-wise direction (Z-direction),
the second connection base (202) is formed to surround a portion of the second front coil (41B) located relatively close to the first wiring part (161) as viewed in the thickness-wise direction (Z-direction),
the third connection base (203) is formed to surround a portion of the first front coil (41A) located relatively close to the second wiring part (162) as viewed in the thickness-wise direction (Z-direction),
the fourth connection base (204) is formed to surround a portion of the second front coil (41B) located relatively close to the second wiring part (162) as viewed in the thickness-wise direction (Z-direction),
a distal end (201A) of the first connection base (201) and a distal end (203A) of the third connection base (203) are adjacent to each other in the second direction (Y-direction), and
a distal end (202A) of the second connection base (202) and a distal end (204A) of the fourth connection base (204) are adjacent to each other in the second direction (Y-direction).

### Clause 14

The transformer chip according to any one of clauses 1 to 3, in which
the first dummy wiring (45A) includes:
   a first wiring part (241) located at a side of the first front coil (41A) and the second front coil (41B) in the second direction (Y-direction), the first wiring part (241) extending linearly in the first direction (X-direction);
   two first curved parts (242A, 242B) respectively surrounding part of the first front coil (41A) and part of the second front coil (41B) at two opposite ends of the first wiring part (241) in the first direction (X-direction) as viewed in the thickness-wise direction (Z-direction);
   a second wiring part (243) located at another side of the first front coil (41A) and the second front coil (41B) in the second direction (Y-direction), the second wiring part (243) extending linearly in the first direction (X-direction); and
   two second curved parts (244A, 244B) respectively surrounding part of the first front coil (41A) and part of the second front coil (41B) at two opposite ends of the second wiring part (243) in the first direction (X-direction) as viewed in the thickness-wise direction (Z-direction), and the second dummy wiring (45B) includes:
   a third wiring part located at a side of the third front coil (41C) and the fourth front coil (41D) in the second direction (Y-direction), the third wiring part extending linearly in the first direction;
   two third curved parts respectively surrounding part of the third front coil (41C) and part of the fourth front coil (41D) at two opposite ends of the third wiring part in the first direction (X-direction) as viewed in the thickness-wise direction (Z-direction);
   a fourth wiring part located at another side of the third front coil (41C) and the fourth front coil (41D) in the second direction (Y-direction), the fourth wiring part extending linearly in the first direction (X-direction); and
   two fourth curved parts respectively surrounding part of the third front coil (41C) and part of the fourth front coil (41D) at two opposite ends of the fourth wiring part in the first direction (X-direction) as viewed in the thickness-wise direction (Z-direction).

### Clause 15

The transformer chip according to clause 14, in which
the first wiring part (241) includes two first sub-wiring parts (241A, 241B) aligned in the first direction (X-direction),
the second wiring part (243) includes two second sub-wiring parts (243A, 243B) aligned in the first direction (X-direction),
lengths of the two first sub-wiring parts (241A, 241B) are equal in the first direction (X-direction),
lengths of the two second sub-wiring parts (243A, 243B) are equal in the first direction (X-direction),
lengths of the two first curved parts (242A, 242B) are equal in a direction in which the two first curved parts (242A, 242B) extend, and
lengths of the two second curved parts (244A, 244B) are equal in a direction in which the two second curved parts (244A, 244B) extend.

### Clause 16

The transformer chip according to clause 15, in which
the lengths of the two first sub-wiring parts (241A, 241B) in the first direction (X-direction) are equal to the lengths of the two second sub-wiring parts (243A, 243B) in the first direction (X-direction), and
the lengths of the two first curved parts (242A, 242B) in the direction in which the two first curved parts (242A, 242B) extend are equal to the lengths of the two second curved parts (244A, 244B) in the direction in which the two second curved parts (244A, 244B) extend.

### Clause 17

The transformer chip according to any one of clauses 14 to 16, in which distal ends (242AA, 242BA) of the two first curved parts (242A, 242B) are respectively adjacent to distal ends (244AA, 244BA) of the two second curved parts (244A, 244B) in the second direction (Y-direction).

### Clause 18

The transformer chip according to clause 1 or 3, in which
the first dummy wiring (45A) includes a first wiring part (231) having a shape of an open loop and surrounding the first front coil (41A) and the second front coil (41B), the first wiring part (231) being electrically connected to the first outer pad (81B), and
the second dummy wiring (45B) includes a second wiring part (232) having a shape of an open loop and surrounding the third front coil (41C) and the fourth front coil (41D), the second wiring part (232) being electrically connected to the second outer pad (81D).

### Clause 19

The transformer chip according to clause 18, in which
the first wiring part (231) includes two first sub-wiring parts (231A, 231B) aligned in the first direction (X-direction),
the second wiring part (232) includes two second sub-wiring parts (232A, 232B) aligned in the first direction (X-direction),
lengths of the two first sub-wiring parts (231A, 231B) are equal, and
lengths of the two second sub-wiring parts (232A, 232B) are equal.

### Clause 20

A signal transmission device (10), including:
a die pad (101);
a transformer chip (80) arranged on the die pad (101); and
an encapsulation resin (120) encapsulating the die pad (101) and the transformer chip (80),
in which the transformer chip (80) includes:
   an insulating layer (84) including a front surface (84s) and a back surface (84r) facing away from each other in a thickness-wise direction (Z-direction);
   a first isolation transformer (40P) including a first front coil (41A), a second front coil (41B), a first back coil (42A) and a second back coil (42B), the first front coil (41A) and the second front coil (41B) being located relatively close to the front surface (84s) in the insulating layer (84) and spaced apart from each other in a first direction (X-direction) orthogonal to the thickness-wise direction (Z-direction), the first back coil (42A) and the second back coil (42B) being located relatively close to the back surface (84r) in the insulating layer (84) and spaced apart from each other in the first direction (X-direction), the first back coil (42A) and the second back coil (42B) facing the first front coil (41A) and the second front coil (41B);
   a second isolation transformer (40Q) including a third front coil (41C), a fourth front coil (41D), a third back coil (42C), and a fourth back coil (42D), the third front coil (41C) and the fourth front coil (41D) being located relatively close to the front surface (84s) in the insulating layer (84) and spaced apart from each other in the first direction (X-direction), the third back coil (42C) and the fourth back coil (42D) being located relatively close to the back surface (84r) in the insulating layer (84) and spaced apart from each other in the first direction (X-direction), the third back coil (42C) and the fourth back coil (42D) facing the third front coil (41C) and the fourth front coil (41D), the second isolation transformer (40Q) being spaced apart from the first isolation transformer (40P) in the first direction (X-direction);
   a first outer pad (81B) disposed between the first front coil (41A) and the second front coil (41B) in the first direction (X-direction) as viewed in the thickness-wise direction (Z-direction), the first outer pad (81B) being electrically connected to both the first front coil (41A) and the second front coil (41B);
   a second outer pad (81D) disposed between the third front coil (41C) and the fourth front coil (41D) in the first direction (X-direction) as viewed in the thickness-wise direction (Z-direction), the second outer pad (81D) being electrically connected to both the third front coil (41C) and the fourth front coil (41D);
   first dummy wiring (45A) arranged at opposite sides of the first isolation transformer (40P) in a second direction (Y-direction) orthogonal to the first direction (X-direction) as viewed in the thickness-wise direction (Z-direction), the first dummy wiring (45A) being electrically connected to the first outer pad (81B); and
   second dummy wiring (45B) arranged at opposite sides of the second isolation transformer (40Q) in the second direction (Y-direction), the second dummy wiring (45B) being electrically connected to the second outer pad (81D) and electrically insulated from the first dummy wiring (45A), and
the first dummy wiring (45A) and the second dummy wiring (45B) are aligned in the first direction (X-direction).

### Clause 21

The transformer chip according to any one of clauses 1 to 19, further includes floating dummy wiring (140) surrounding the first to fourth front coils (41A to 41D), the first dummy wiring (45A), and the second dummy wiring (45B) as viewed in the thickness-wise direction (Z-direction), the floating dummy wiring (140) being insulated from the first dummy wiring (45A) and the second dummy wiring (45B).

### Clause 22

The transformer chip according to clause 21, in which the floating dummy wiring (140) has a shape of an open loop.

### Clause 23

The transformer chip according to any one of clauses 4 to 13, in which
the third wiring part (163) includes two third sub-wiring parts (163A, 163B) aligned in the first direction (X-direction), and
the fourth wiring part (164) includes two fourth sub-wiring parts (164A, 164B) aligned in the first direction (X-direction).

### Clause 24

The transformer chip according to clause 23, in which
lengths (LA3, LB3) of the two third sub-wiring parts (163A, 163B) are equal in the first direction (X-direction), and
lengths (LA4, LB4) of the two fourth sub-wiring parts (164A, 164B) are equal in the first direction (X-direction).

### Clause 25

The transformer chip according to clause 24, in which the lengths (LA3, LB3) of the two third sub-wiring parts (163A, 163B) in the first direction (X-direction) are equal to the lengths (LA4, LB4) of the fourth sub-wiring parts (164A, 164B) in the first direction (X-direction).

### Clause 26

The transformer chip according to any one of clauses 23 to 25, in which
the two third sub-wiring parts (163A, 163B) each include:
   third wiring layers layered in the second direction (Y-direction); and
   a third wiring connection layer connecting the third wiring layers, and
the two fourth sub-wiring parts (164A, 164B) each include:
   fourth wiring layers layered in the second direction (Y-direction); and
   a fourth wiring connection layer connecting the fourth wiring layers.

### Clause 27

The transformer chip according to clause 26, in which
the third wiring connection layer connects the third wiring layers in a central portion of the third wiring part (163) in the first direction (X-direction), and
the fourth wiring connection layer connects the fourth wiring layers in a central portion of the fourth wiring part (164) in the first direction (X-direction).

### Clause 28

The transformer chip according to clause 27, in which
the two third wiring connection layers are adjacent to each other in the first direction (X-direction),
the two third sub-wiring parts (163A, 163B) extend in opposite directions from the two third wiring connection layers that are adjacent to each other,
the two fourth wiring connection layers are adjacent to each other in the first direction (X-direction), and
the two fourth sub-wiring parts (164A, 164B) extend in opposite directions from the two fourth wiring connection layers that are adjacent to each other.

### Clause 29

The transformer chip according to clause 28, in which the second dummy wiring (45B) includes:
a third pad connector (173) connecting the two third sub-wiring parts (163A, 163B) to the second outer pad (81D); and
a fourth pad connector (174) connecting the two fourth sub-wiring parts (164A, 164B) to the second outer pad (81D).

### Clause 30

The transformer chip according to clause 29, in which
the third pad connector (173) includes:
   a ninth connection base extending to surround at least a side of the third front coil (41C) located relatively close to the second outer pad (81D);
   a tenth connection base extending to surround at least a side of the fourth front coil (41D) located relatively close to the second outer pad (81D);
   ninth straight portions connected to the ninth connection base and arranged side by side in the second direction (Y-direction), the ninth straight portions extending linearly in the first direction (X-direction); and
   tenth straight portions connected to the tenth connection base and arranged side by side in the second direction (Y-direction), the tenth straight portions extending linearly in the first direction (X-direction), and
the fourth pad connector (174) includes:
   an eleventh connection base extending to surround at least a side of the third front coil (41C) located relatively close to the second outer pad (81D);
   a twelfth connection base extending to surround at least a side of the fourth front coil (41D) located relatively close to the second outer pad (81D);
   eleventh straight portions connected to the eleventh connection base and arranged side by side in the second direction (Y-direction), the eleventh straight portions extending linearly in the first direction (X-direction); and
   twelfth straight portions connected to the twelfth connection base and arranged side by side in the second direction (Y-direction), the twelfth straight portions extending linearly in the first direction (X-direction),
the ninth straight portions and the tenth straight portions are alternately arranged in the second direction (Y-direction), and
the eleventh straight portions and the twelfth straight portions are alternately arranged in the second direction (Y-direction).

### Clause 31

The transformer chip according to clause 30, in which
the ninth connection base is formed to surround a portion of the third front coil (41C) located relatively close to the third wiring part (163) as viewed in the thickness-wise direction (Z-direction),
the tenth connection base is formed to surround a portion of the fourth front coil (41D) located relatively close to the third wiring part (163) as viewed in the thickness-wise direction (Z-direction),
the eleventh connection base is formed to surround a portion of the third front coil (41C) located relatively close to the fourth wiring part (164) as viewed in the thickness-wise direction (Z-direction),
the twelfth connection base is formed to surround a portion of the fourth front coil (41D) located relatively close to the fourth wiring part (164) as viewed in the thickness-wise direction (Z-direction),
a distal end of the ninth connection base and a distal end of the eleventh connection base are adjacent to each other in the second direction (Y-direction), and
a distal end of the tenth connection base and a distal end of the twelfth connection base are adjacent to each other in the second direction (Y-direction).

### Clause 32

The transformer chip according to any one of clauses 14 to 16, in which
the third wiring part includes two third sub-wiring parts aligned in the first direction (X-direction),
the fourth wiring part includes two fourth sub-wiring parts aligned with in the first direction (X-direction),
lengths of the two third sub-wiring parts are equal in the first direction (X-direction),
lengths of the two fourth sub-wiring parts are equal in the first direction (X-direction),
lengths of the two third curved parts are equal in a direction in which the two third curved parts extend, and
lengths of the two fourth curved parts are equal in a direction in which the two fourth curved parts extend.

### Clause 33

The transformer chip according to clause 32, in which
the lengths of the two third sub-wiring parts in the first direction (X-direction) are equal to the lengths of the two fourth sub-wiring parts in the first direction (X-direction), and
the lengths of the two third curved parts in the direction in which the two third curved parts extend are equal to the lengths of the two fourth curved parts in the direction in which the two fourth curved parts extend.

### Clause 34

The transformer chip according to clause 33, in which distal ends of the two third curved parts are respectively adjacent to distal ends of the two fourth curved parts in the second direction.

The above descriptions are merely exemplary. One skilled in the art would recognize the potential for a wide variety of combinations and substitutions of the elements and methods (manufacturing processes) in addition to those illustrated to describe the techniques of this disclosure. Any substitutions, modifications, and variations within the scope of the claims are intended to be encompassed in the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A transformer chip, comprising:
an insulating layer including a front surface and a back surface facing away from each other in a thickness-wise direction;
a first isolation transformer including a first front coil, a second front coil, a first back coil and a second back coil, the first front coil and the second front coil being located relatively close to the front surface in the insulating layer and spaced apart from each other in a first direction orthogonal to the thickness-wise direction, the first back coil and the second back coil being located relatively close to the back surface in the insulating layer and spaced apart from each other in the first direction, the first back coil and the second back coil facing the first front coil and the second front coil;
a second isolation transformer including a third front coil, a fourth front coil, a third back coil, and a fourth back coil, the third front coil and the fourth front coil being located relatively close to the front surface in the insulating layer and spaced apart from each other in the first direction, the third back coil and the fourth back coil being located relatively close to the back surface in the insulating layer and spaced apart from each other in the first direction, the third back coil and the fourth back coil facing the third front coil and the fourth front coil, the second isolation transformer being spaced apart from the first isolation transformer in the first direction;
a first outer pad disposed between the first front coil and the second front coil in the first direction as viewed in the thickness-wise direction, the first outer pad being electrically connected to both the first front coil and the second front coil;
a second outer pad disposed between the third front coil and the fourth front coil in the first direction as viewed in the thickness-wise direction, the second outer pad being electrically connected to both the third front coil and the fourth front coil;
first dummy wiring arranged at opposite sides of the first isolation transformer in a second direction orthogonal to the first direction as viewed in the thickness-wise direction, the first dummy wiring being electrically connected to the first outer pad; and
second dummy wiring arranged at opposite sides of the second isolation transformer in the second direction, the second dummy wiring being electrically connected to the second outer pad and electrically insulated from the first dummy wiring,
wherein the first dummy wiring and the second dummy wiring are aligned in the first direction.

2. The transformer chip according to claim 1, wherein
the first dummy wiring includes a portion symmetric with respect to an imaginary line that connects a center of the first front coil and a center of the second front coil, and
the second dummy wiring includes a portion symmetric with respect to an imaginary line that connects a center of the third front coil and a center of the fourth front coil.

3. The transformer chip according to claim 1, wherein
the first dummy wiring includes a portion symmetric with respect to an imaginary line that extends in the second direction through a midpoint between a center of the first front coil and a center of the second front coil, and
the second dummy wiring includes a portion symmetric with respect to an imaginary line that extends in the second direction through a midpoint between a center of the third front coil and a center of the fourth front coil.

4. The transformer chip according to claim 1, wherein
the first dummy wiring includes:
a first wiring part located at a side of the first front coil and the second front coil in the second direction, the first wiring part extending linearly in the first direction; and a second wiring part located at another side of the first front coil and the second front coil in the second direction, the second wiring part extending linearly in the first direction, and
the second dummy wiring includes:
a third wiring part located at a side of the third front coil and the fourth front coil in the second direction, the third wiring part extending linearly in the first direction; and
a fourth wiring part located at another side of the third front coil and the fourth front coil in the second direction, the fourth wiring part extending linearly in the first direction.

5. The transformer chip according to claim 4, wherein
the first wiring part includes two first sub-wiring parts aligned in the first direction, and
the second wiring part includes two second sub-wiring parts aligned in the first direction.

6. The transformer chip according to claim 5, wherein
lengths of the two first sub-wiring parts are equal in the first direction, and
lengths of the two second sub-wiring parts are equal in the first direction.

7. The transformer chip according to claim 6, wherein the lengths of the two first sub-wiring parts in the first direction are equal to the lengths of the two second sub-wiring parts in the first direction.

8. The transformer chip according to claim 5, wherein
the two first sub-wiring parts each include:
first wiring layers layered in the second direction; and
a first wiring connection layer connecting the first wiring layers, and
the two second sub-wiring parts each include:
second wiring layers layered in the second direction; and
a second wiring connection layer connecting the second wiring layers.

9. The transformer chip according to claim 8, wherein
the first wiring connection layer connects the first wiring layers in a central portion of the first wiring part in the first direction, and
the second wiring connection layer connects the second wiring layers in a central portion of the second wiring part in the first direction.

10. The transformer chip according to claim 8, wherein
the two first wiring connection layers are adjacent to each other in the first direction,
the two first sub-wiring parts extend in opposite directions from the two first wiring connection layers that are adjacent to each other,
the two second wiring connection layers are adjacent to each other in the first direction, and
the two second sub-wiring parts extend in opposite directions from the two second wiring connection layers that are adjacent to each other.

11. The transformer chip according to claim 5, wherein the first dummy wiring includes:
a first pad connector electrically connecting the two first sub-wiring parts to the first outer pad; and
a second pad connector electrically connecting the two second sub-wiring parts to the first outer pad.

12. The transformer chip according to claim 11, wherein
the first pad connector includes:
a first connection base extending to surround at least a portion of the first front coil located toward the first outer pad;
a second connection base extending to surround at least a portion of the second front coil located toward the first outer pad;
first straight portions connected to the first connection base and arranged side by side in the second direction, the first straight portions extending linearly in the first direction; and
second straight portions connected to the second connection base and arranged side by side in the second direction, the second straight portions extending linearly in the first direction, and
the second pad connector includes:
a third connection base extending to surround at least a portion of the first front coil located toward the first outer pad;
a fourth connection base extending to surround at least a portion of the second front coil located toward the first outer pad;
third straight portions connected to the third connection base and arranged side by side in the second direction, the third straight portions extending linearly in the first direction; and
fourth straight portions connected to the fourth connection base and arranged side by side in the second direction, the fourth straight portions extending linearly in the first direction,
the first straight portions and the second straight portions are alternately arranged in the second direction, and
the third straight portions and the fourth straight portions are alternately arranged in the second direction.

13. The transformer chip according to claim 12, wherein
the first connection base is formed to surround a portion of the first front coil located relatively close to the first wiring part as viewed in the thickness-wise direction,
the second connection base is formed to surround a portion of the second front coil located relatively close to the first wiring part as viewed in the thickness-wise direction,
the third connection base is formed to surround a portion of the first front coil located relatively close to the second wiring part as viewed in the thickness-wise direction,
the fourth connection base is formed to surround a portion of the second front coil located relatively close to the second wiring part as viewed in the thickness-wise direction,
a distal end of the first connection base and a distal end of the third connection base are adjacent to each other in the second direction, and
a distal end of the second connection base and a distal end of the fourth connection base are adjacent to each other in the second direction.

14. The transformer chip according to claim 1, wherein
the first dummy wiring includes:
a first wiring part located at a side of the first front coil and the second front coil in the second direction, the first wiring part extending linearly in the first direction;
two first curved parts respectively surrounding part of the first front coil and part of the second front coil at two opposite ends of the first wiring part in the first direction as viewed in the thickness-wise direction;
a second wiring part located at another side of the first front coil and the second front coil in the second direction, the second wiring part extending linearly in the first direction; and
two second curved parts respectively surrounding part of the first front coil and part of the second front coil at two opposite ends of the second wiring part in the first direction as viewed in the thickness-wise direction, and
the second dummy wiring includes:
a third wiring part located at a side of the third front coil and the fourth front coil in the second direction, the third wiring part extending linearly in the first direction;
two third curved parts respectively surrounding part of the third front coil and part of the fourth front coil at two opposite ends of the third wiring part in the first direction as viewed in the thickness-wise direction;
a fourth wiring part located at another side of the third front coil and the fourth front coil in the second direction, the fourth wiring part extending linearly in the first direction; and
two fourth curved parts respectively surrounding part of the third front coil and part of the fourth front coil at two opposite ends of the fourth wiring part in the first direction as viewed in the thickness-wise direction.

15. The transformer chip according to claim 14, wherein
the first wiring part includes two first sub-wiring parts aligned in the first direction,
the second wiring part includes two second sub-wiring parts aligned in the first direction,
lengths of the two first sub-wiring parts are equal in the first direction,
lengths of the two second sub-wiring parts are equal in the first direction,
lengths of the two first curved parts are equal in a direction in which the two first curved parts extend, and
lengths of the two second curved parts are equal in a direction in which the two second curved parts extend.

16. The transformer chip according to claim 15, wherein
the lengths of the two first sub-wiring parts in the first direction are equal to the lengths of the two second sub-wiring parts in the first direction, and
the lengths of the two first curved parts in the direction in which the two first curved parts extend are equal to the lengths of the two second curved parts in the direction in which the two second curved parts extend.

17. The transformer chip according to claim 14, wherein distal ends of the two first curved parts are respectively adjacent to distal ends of the two second curved parts in the second direction.

18. The transformer chip according to claim 1, wherein
the first dummy wiring includes a first wiring part having a shape of an open loop and surrounding the first front coil and the second front coil, the first wiring part being electrically connected to the first outer pad, and
the second dummy wiring includes a second wiring part having a shape of an open loop and surrounding the third front coil and the fourth front coil, the second wiring part being electrically connected to the second outer pad.

19. The transformer chip according to claim 18, wherein
the first wiring part includes two first sub-wiring parts aligned in the first direction,
the second wiring part includes two second sub-wiring parts aligned in the first direction,
lengths of the two first sub-wiring parts are equal, and
lengths of the two second sub-wiring parts are equal.

20. A signal transmission device, comprising:
a die pad;
a transformer chip arranged on the die pad; and
an encapsulation resin encapsulating the die pad and the transformer chip,
wherein the transformer chip includes:
an insulating layer including a front surface and a back surface facing away from each other in a thickness-wise direction;
a first isolation transformer including a first front coil, a second front coil, a first back coil and a second back coil, the first front coil and the second front coil being located relatively close to the front surface in the insulating layer and spaced apart from each other in a first direction orthogonal to the thickness-wise direction, the first back coil and the second back coil being located relatively close to the back surface in the insulating layer and spaced apart from each other in the first direction, the first back coil and the second back coil facing the first front coil and the second front coil;
a second isolation transformer including a third front coil, a fourth front coil, a third back coil, and a fourth back coil, the third front coil and the fourth front coil being located relatively close to the front surface in the insulating layer and spaced apart from each other in the first direction, the third back coil and the fourth back coil being located relatively close to the back surface in the insulating layer and spaced apart from each other in the first direction, the third back coil and the fourth back coil facing the third front coil and the fourth front coil, the second isolation transformer being spaced apart from the first isolation transformer in the first direction;
a first outer pad disposed between the first front coil and the second front coil in the first direction as viewed in the thickness-wise direction, the first outer pad being electrically connected to both the first front coil and the second front coil;
a second outer pad disposed between the third front coil and the fourth front coil in the first direction as viewed in the thickness-wise direction, the second outer pad being electrically connected to both the third front coil and the fourth front coil;
first dummy wiring arranged at opposite sides of the first isolation transformer in a second direction orthogonal to the first direction as viewed in the thickness-wise direction, the first dummy wiring being electrically connected to the first outer pad; and
second dummy wiring arranged at opposite sides of the second isolation transformer in the second direction, the second dummy wiring being electrically connected to the second outer pad and electrically insulated from the first dummy wiring, and
the first dummy wiring and the second dummy wiring are aligned in the first direction.
